(19) United States
(12) Patent Application Publication
(10) Pub. No.: US 2018/0329024 A1
(43) Pub. Date: Nov. 15, 2018

(54) DETECTOR FOR OPTICALLY DETECTING AT LEAST ONE OBJECT

(71) Applicant: trinamiX GmbH, Ludwigshafen am Rhein (DE)

(72) Inventors: Robert SEND, Karlsruhe (DE); Ingmar BRUDER, Neuleiningen (DE); Christoph LUNGENSCHMIED, Mannheim (DE)

(73) Assignee: trinamiX GmbH, Ludwigshafen am Rhein (DE)

(21) Appl. No.: 15/775,424

(22) PCT Filed: Nov. 25, 2016
(86) PCT No.: PCT/EP2016/078812

§ 371 Date: May 11, 2018

(30) Foreign Application Priority Data
Nov. 25, 2015 (EP) 15196238.8

(51) Int. Cl. G01S 5/16; G06F 3/03; G01S 7/481; G01S 17/46; G01S 17/66

(52) U.S. Cl. CPC G01S 5/16; G06F 3/0304; G01S 17/66; G01S 17/46; G01S 7/4816

(57) ABSTRACT

A detector, for determining a position of at least one object, includes: at least one longitudinal optical sensor for determining a longitudinal position of at least one light beam traveling from the object to the detector, at least one transversal optical sensor determining at least one transversal position of the at least one light beam, including at least one fluorescent waveguiding sheet forming a transversal sensitive area, at least two photosensitive elements located at at least two edges of the fluorescent waveguiding sheet capable of detecting fluorescence light guided from the light spot towards the photosensitive elements by the fluorescent waveguiding sheet and capable of generating transversal sensor signals; and at least one evaluation device configured to determine at least one longitudinal coordinate of the object by evaluating the longitudinal sensor signals, and to determine at least one transversal coordinate of the object by evaluating the transversal sensor signals.

### FIELD OF THE INVENTION

The invention relates to a detector, a detector system and a method for determining a position of at least one object. The invention further relates to a human-machine interface for exchanging at least one item of information between a user and a machine, an entertainment device, a tracking system, a camera, a scanning system and various uses of the detector device. The devices, systems, methods and uses according to the present invention specifically may be employed for example in various areas of daily life, gaming, traffic technology, production technology, security technology, photography such as digital photography or video photography for arts, documentation or technical purposes, medical technology or in the sciences. However, other applications are also possible.

### PRIOR ART

A large number of optical sensors and photovoltaic devices are known from the prior art. While photovoltaic devices are generally used to convert electromagnetic radiation, for example, ultra-violet, visible or infrared light, into electrical signals or electrical energy, optical detectors are generally used for picking up image information and/or for detecting at least one optical parameter, for example, a brightness.

A large number of optical sensors which can be based generally on the use of inorganic and/or organic sensor materials are known from the prior art. Examples of such sensors are disclosed in US 2007/0176165 A1, U.S. Pat. No. 6,995,445 B2, DE 2501124 A1, DE 3225372 A1 or else in numerous other prior art documents. To an increasing extent, in particular for cost reasons and for reasons of large-area processing, sensors comprising at least one organic sensor material are being used, as described for example in US 2007/0176165 A1. In particular, so-called dye solar cells are increasingly of importance here, which are described generally, for example in WO 2009/013282 A1. The present invention, however, is not restricted to the use of organic devices. Thus, specifically, also inorganic devices such as CCD sensors and/or CMOS sensors, specifically pixelated sensors, may be employed.

A large number of detectors for detecting at least one object are known on the basis of such optical sensors. Such detectors can be embodied in diverse ways, depending on the respective purpose of use. Examples of such detectors are imaging devices, for example, cameras and/or microscopes. High-resolution confocal microscopes are known, for example, which can be used in particular in the field of medical technology and biology in order to examine biological samples with high optical resolution. Further examples of detectors for optically detecting at least one object are distance measuring devices based, for example, on propagation time methods of corresponding optical signals, for example laser pulses. Further examples of detectors for optically detecting objects are triangulation systems, by means of which distance measurements can likewise be carried out.

In WO 2012/110924 A1, the content of which is herewith included by reference, a detector for optically detecting at least one object is proposed. The detector comprises at least one longitudinal optical sensor. The longitudinal optical sensor has at least one sensor region. The longitudinal optical sensor is designed to generate at least one longitudinal sensor signal in a manner dependent on an illumination of the sensor region. The longitudinal sensor signal, given the same total power of the illumination, is dependent on a geometry of the illumination, in particular on a beam cross section of the illumination on the longitudinal sensitive area. The detector furthermore has at least one evaluation device. The evaluation device is designed to generate at least one item of geometrical information from the longitudinal sensor signal, in particular at least one item of geometrical information about the illumination and/or the object.

WO 2014/097181 A1, the full content of which is herewith included by reference, discloses a method and a detector for determining a position of at least one object, by using at least one longitudinal optical sensor and at least one transversal optical sensor. Specifically, the use of sensor stacks is disclosed, in order to determine both a longitudinal position and at least one transversal position of the object with a high degree of accuracy and without ambiguity.

WO 2015/024871 A1, the full content of which is herewith included by reference, discloses an optical detector, comprising:
at least one spatial light modulator being adapted to modify at least one property of a light beam in a spatially resolved fashion, having a matrix of pixels, each pixel being controllable to individually modify the at least one optical property of a portion of the light beam passing the pixel;
at least one optical sensor adapted to detect the light beam after passing the matrix of pixels of the spatial light modulator and to generate at least one sensor signal;
at least one modulator device adapted for periodically controlling at least two of the pixels with different modulation frequencies; and
at least one evaluation device adapted for performing a frequency analysis in order to determine signal components of the sensor signal for the modulation frequencies.

WO 2014/198629 A1, the full content of which is herewith included by reference, discloses a detector for determining a position of at least one object, comprising:
at least one optical sensor, the optical sensor being adapted to detect a light beam propagating from the object towards the detector, the optical sensor having at least one matrix (152) of pixels; and
at least one evaluation device, the evaluation device being adapted to determine a number N of pixels of the optical sensor which are illuminated by the light beam, the evaluation device further being adapted to determine at least one longitudinal coordinate of the object by using the number N of pixels which are illuminated by the light beam.

Further, generally, for various other detector concepts, reference may be made to WO 2014/198626 A1, WO 2014/198629 A1 and WO 2014/198625 A1, the full content of which is herewith included by reference. Further, referring to potential materials and optical sensors which may also be employed in the context of the present invention, reference may be made to European patent applications EP 15 153 215.7, filed on Jan. 30, 2015, EP 15 157 363.1, filed on Mar. 3, 2015, EP 15 164 653.6, filed on Apr. 22, 2015, EP 15177275.3, filed on Jul. 17, 2015, EP 15180354.1 and EP 15180353.3, both filed on Aug. 10, 2015, and EP 15 185 005.4, filed on Sep. 14, 2015, the full content of all of which is herewith also included by reference.

Despite the advantages implied by the above-mentioned devices and detectors, several technical challenges remain. Thus, generally, a need exists for detectors for detecting a position of an object in space which is both reliable and may be manufactured at low cost. Specifically, a need exists for 3D-sensing concepts. Various known concepts are at least partially based on using so-called FiP sensors, such as several of the above-mentioned concepts. Therein, as an example, large area sensors may be used, in which the individual sensor pixels are significantly larger than the light spot and which are fixed to a specific size. Still, large area sensors in many cases are inherently limited in the use of the FiP measurement principle, specifically in case more than one light spot is to be investigated simultaneously.

Further, 3D-sensing concepts for tracking, using FiP sensors, typically require combining one or more FiP sensors and, optionally, a position-sensitive detector (PSD or PIF). FiP sensors and PSD devices are typically either combined electrically, such as in a dye-sensitized solar cell, or are separated into a FiP-detector and a PSD. For optical systems, it is typically desirable to design at least one of the detectors in a semitransparent fashion. Semitransparency, however, restricts the options of choice for both FiP-detector and PSD-detector materials. Thus, transparency of FiP and/or PSD detectors remains a technical challenge. A further challenge using FiP or PSD detectors is the detector area or active area. Typically, for distance measurements, a large active area of the detector is used or even is required. This area, however, may cause noise problems, specifically when the tetralateral conductivity concept is employed to build a PSD. This often results in poor signal-to-noise-ratios and slow detector response times due to the large capacitance in conjunction with the series resistance of the detector.

Alternatively, pixelated optical sensors may be used, such as in the pixel counting concepts disclosed in WO 2014/198629 A1. Even though these concepts allow for an efficient determination of 3D coordinates and even though these concepts are significantly superior to known 3D sensing concepts such as triangulation, some challenges remain, specifically regarding the need for calculating power and resources, as well as increasing the efficiency. Generally, it might also be desirable to employ commonly available transversal optical sensors, such as CCD and/or CMOS sensors and/or photodiodes such as inorganic photodiodes or organic photodiodes.

Further, P. Bartu, R. Koeppe, N. Arnold, A. Neulinger, L. Fallon, and S. Bauer, Conformable large-area position-sensitive photodetectors based on luminescence collecting silicone wave-guides, J. Appl. Phys. 107, 123101 (2010), describe a kind of position sensitive detector (PSD) which might be suitable for large areas and on curved surfaces. This kind of PSD device is based on a planar silicone waveguide with embedded fluorescent dyes used in conjunction with small silicon photodiodes, which may be arranged in a regular pattern, such as at the edges of the device or distributed over the device. Impinging laser light may be absorbed by the dye in the PSD device and re-emitted as fluorescence light at a larger wavelength. Due to a predominantly isotropic emission from the fluorescent dye molecules, the re-emitted light may at least partially coupled into the planar silicone waveguide and directed to the silicon photodiodes, wherein the light signals may be detected via the silicon photodiodes. By using algorithms as known from global positioning systems (GPS), the position of light spots may be determined. For further details and for information about later developments which are related to of this kind of PSD device reference may be made to WO 2009/105801 A1, WO 2010/118409 A2, WO 2010/118450 A1, WO 2013/090960 A1, WO 2013/116883 A1, and WO2015/081362 A1. However, this kind of PSD device is not adapted for 3D-sensing such that further development is required to provide an optical detector well-suited for this purpose.

This discussion of known concepts, such as the concepts of several of the above-mentioned prior art documents, clearly shows that some technical challenges remain. Specifically, there is further room for improvement in terms of increased accuracy of position detectors for distance measurements, two-dimensional sensing or even three-dimensional sensing. Further, complexity of the optical systems still remains an issue which may be addressed.

### Problem Addressed by the Invention

It is therefore an object of the present invention to provide devices and methods facing the above-mentioned technical challenges of known devices and methods. Specifically, it is an object of the present invention to provide devices and methods which reliably may determine a position of an object in space, preferably with a low technical effort and with low requirements in terms of technical resources and cost.

### SUMMARY OF THE INVENTION

This problem is solved by the invention with the features of the independent patent claims. Advantageous developments of the invention, which can be realized individually or in combination, are presented in the dependent claims and/or in the following specification and detailed embodiments. As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such a way with other optional or non-optional features of the invention.

In a first aspect of the present invention, a detector for determining a position of at least one object is disclosed. As used herein, the term “position” refers to at least one item of information regarding a location and/or orientation of the object and/or at least one part of the object in space. Thus, the at least one item of information may imply at least one distance between at least one point of the object and the at least one detector. As will be outlined in further detail below, the distance may be a longitudinal coordinate or may contribute to determining a longitudinal coordinate of the point of the object. Additionally or alternatively, one or more other items of information regarding the location and/or orientation of the object and/or at least one part of the object may be determined. As an example, at least one transversal coordinate of the object and/or at least one part of the object may be determined. Thus, the position of the object may imply at least one longitudinal coordinate of the object and/or at least one part of the object. Additionally or alternatively, the position of the object may imply at least one transversal coordinate of the object and/or at least one part of the object. Additionally or alternatively, the position of the object may imply at least one orientation information of the object, indicating an orientation of the object in space.

The detector comprises:
at least one longitudinal optical sensor for determining a longitudinal position of at least one light beam traveling from the object to the detector, wherein the longitudinal optical sensor has at least one longitudinal sensor region forming a longitudinal sensitive area, wherein the longitudinal optical sensor is designed to generate at least one longitudinal sensor signal in a manner dependent on an illumination of the longitudinal sensitive area region by the light beam, wherein the longitudinal sensor signal, given the same total power of the illumination, is dependent on a beam cross-section of the light beam in the longitudinal sensitive area;
   at least one transversal optical sensor for determining at least one transversal position of the at least one light beam traveling from the object to the detector, comprising o at least one fluorescent waveguiding sheet forming a transversal sensitive area, wherein the fluorescent waveguiding sheet is oriented towards the object such that the at least one light beam propagating from the object towards the detector generates at least one light spot in the transversal sensitive area, wherein the fluorescent waveguiding sheet contains at least one fluorescent material, wherein the fluorescent material is adapted to generate fluorescence light in response to the illumination by the light beam,
   at least two photosensitive elements located at at least two edges of the fluorescent waveguiding sheet capable of detecting fluorescence light, also referred to as fluorescent light, guided from the light spot towards the photosensitive elements by the fluorescent waveguiding sheet and capable of generating transversal sensor signals; and
at least one evaluation device, the evaluation device being configured to determine at least one longitudinal coordinate of the object by evaluating the longitudinal sensor signal, and wherein the evaluation device is further configured to determine at least one transversal coordinate of the object by evaluating the transversal sensor signals of the photosensitive elements.

Unless explicitly specified, the term “optical sensor” as used herein or any part thereof, such as a sensitive area, or any feature related thereto, such as a sensor signal, may refer to one or to both of a longitudinal optical sensor and a transversal optical sensor. In accordance with the present invention, the longitudinal optical sensor is used for determining a longitudinal position of at least one light beam traveling from the object to the detector and, by employing the evaluation device, for determining at least one longitudinal coordinate z of the object whereas the transversal optical sensor is used for determining a transversal position of the at least one light beam traveling from the object to the detector and, by employing the evaluation device for evaluating the transversal sensor signals of the photosensitive elements, for determining at least one of the transversal coordinates x, y of the object. Herein, the transversal optical sensor may, preferably, be configured in order to function as a “position sensitive detector” (PSD) by being capable of providing both of the two lateral components of the spatial position of the object, in particular, simultaneously. As a result, by combining the at least one longitudinal coordinate of the object with the at least one transversal coordinate of the object a three-dimensional position of the object as defined above may, thus, be determined by using the evaluation device.

As used herein, an optical sensor generally refers to a light-sensitive device for detecting a light beam, such as for detecting an illumination and/or a light spot generated by a light beam. The optical sensor may be adapted, as outlined in further detail below, to determine at least one longitudinal coordinate of the object and/or of at least one part of the object, such as at least one part of the object from which the at least one light beam travels towards the detector.

As further used herein, a fluorescent waveguiding sheet generally refers to an element with both waveguiding properties and fluorescent properties. Therein, waveguiding generally refers to the property or a plurality of an element to guide the light in one or more of the ultraviolet, visible or the infrared spectral range by internal reflection, specifically by internal total reflection. The term “fluorescence” generally refers to the property of an element or a material to emit secondary light, also referred to as fluorescence light, in one or more of the ultraviolet, visible or infrared spectral range, in response to excitation by electromagnetic radiation, also referred to as primary radiation or excitation radiation, such as primary light or excitation light. In most cases, the emitted light, fluorescence light or secondary light has a longer wavelength and a lower energy than the primary radiation. The primary radiation typically induces the presence of excited states within the fluorescent material, such as so-called excitons. Typically, excited state decay times for photon emissions with energies from the UV to near infrared are within the range of 0.5 to 20 nanoseconds. However, within the present invention, electromagnetic radiation is, as described below in more detail, preferably primarily absorbed in a wavelength range of 400 nm to 900 nm, where an absorption maximum preferably occurs in the wavelength range of 500 nm to 850 nm while, preferably the emitted light has a longer wavelength, i.e. preferably in the visible spectral range or in the infrared spectral range, more preferably in the infrared spectral range, in particular, in the range of 780 nm to 3.0 micrometers. Similarly, as used herein, the term “fluorescent material” generally refers to a material having fluorescence properties. The term “fluorescence light” generally refers to the secondary light generated during the above-mentioned fluorescence process.

The fluorescent waveguiding sheet, as will be outlined in further detail below, specifically may be an element or may comprise an element which has a sheet-like shape or which is a sheet. As used herein, a “sheet” generally refers to an element which has a lateral extension, such as a diameter or an equivalent diameter, which significantly exceeds a thickness of the element, such as by at least a factor of 5, more preferably by at least a factor of 10 or even more preferably by at least a factor of 20, a factor of 50 or even a factor of 100. The sheet specifically may be flexible, deformable or rigid.

As will be outlined in further detail below, the fluorescent waveguiding sheet specifically may be or may comprise a transparent material, specifically a transparent sheet. The transparency may be a transparency of at least 50 to 70% in the visible spectral range or in a part thereof, such as in a range of 500 nm to 700 nm. Other embodiments are feasible.

As further used herein, the term “sensitive area” generally refers to a two-dimensional or three-dimensional region of an element which is sensitive to external influences and, e.g., produces at least one reaction in response to an external stimulus. In the present case, specifically of the fluorescent waveguiding sheet of the transversal optical sensor, the transversal sensitive area may be sensitive to an optical excitation. The transversal sensitive area specifically may be a part of a surface or the volume of the fluorescent waveguiding sheet, such as the whole surface of the fluorescent waveguiding sheet or a part thereof.

Generally, the fluorescent material or the fluorescent waveguiding sheet has nonlinear properties, i.e. exhibit fluorescence properties in which the fluorescence is a nonlinear function of the power of the intensity of the illumination by the light beam, i.e. of the excitation light. Nonlinear fluorescence properties are widely known in the field of fluorescent materials. Nonlinear properties in fluorescence generally occur due to various physical processes. Thus, without wishing to be bound by theory, nonlinear fluorescence may occur due to saturation effects which specifically may be due to exciton-exciton-quenching or exciton-exciton-recombination. Other quenching processes are generally known and described in the literature of fluorescence. Most commonly, towards higher intensities of the light beam or excitation light, the total power of the fluorescence sub-proportionally follows the intensity of the light beam. Most often, saturation effects are observed. These nonlinear fluorescence properties may, in the context of the present invention, be used for determining the transversal coordinate of the object.

Further in the present case, the longitudinal sensitive area may be sensitive to a geometry of an illumination, in particular with respect to a beam cross section of the illumination on the longitudinal sensitive area. For this purpose, the longitudinal optical sensor may comprise one or more photo detectors, preferably one or more dye-sensitized organic solar cells (DSC), such as one or more solid dye-sensitized organic solar cells (SDSC). Thus, the longitudinal sensitive area may be formed by at least one photovoltaic material embedded in between a first electrode and a second electrode of a photo detector, wherein the photovoltaic material may be sensitive to an illumination with light, thereby adapted for generating electric charges in response thereof. For more details reference may be made to WO 2012/110924 A1 and WO 2014/097181 A1.

Alternatively, the longitudinal sensitive area may be formed by at least one photoconductive material, wherein the photoconductive material may be sensitive to an illumination with light, thereby alternating the electrical conductivity of the photoconductive material. As a particular example, the longitudinal sensitive area may, thus, be formed by at least one photodiode driven in a photoconductive mode. With regard to suitable photoconductive materials reference may be made to the above-mentioned European patent applications EP 15 153 215.7, filed Jan. 30, 2015, EP 15 157 363.1, filed Mar. 3, 2015, EP 15 164 653.6, filed Apr. 22, 2015, EP 15177275.3, filed Jul. 17, 2015, EP 15180354.1, and EP 15180353.3, both filed Aug. 10, 2015, and EP 15 185 005.4, filed Sep. 14, 2015.

The longitudinal optical sensor and the method proposed in the context of the present invention, specifically, may be considered as implementing the so-called “FiP” effect which is explained in further detail in WO 2012/110924 A1 and/or in WO 2014/097181 A1. Therein, “FiP” alludes to the effect that a signal i may be generated which, given the same total power P of the illumination, depends on the photon density, the photon flux and, thus, on the cross-section ϕ(F) of the incident beam. Consequently, determining the longitudinal coordinate may imply directly determining the longitudinal coordinate z, may imply determining one or more parameters defining the size of the light spot or may imply both, simultaneously or in a stepwise fashion.

Further, the FiP-effect may depend on or may be emphasized by an appropriate modulation of the light beam, as disclosed in WO 2012/110924 A1. Thus, preferably, the detector may furthermore have at least one modulation device for modulating the illumination. Accordingly, the detector may be designed to detect at least two longitudinal sensor signals in case of different modulations, in particular at least two longitudinal sensor signals comprising different modulation frequencies. In this case, the evaluation device may be configured to determine the at least one longitudinal coordinate of the object by evaluating the at least two modulated longitudinal sensor signals. Thus, the longitudinal optical sensor may be designed in such a way that the at least one longitudinal sensor signal, given the same total power of the illumination, may be dependent on a modulation frequency of a modulation of the illumination.

Further, the detector may, alternatively or, preferably, additionally, be designed to detect at least two transversal sensor signals in case of different modulations, in particular at least two transversal sensor signals comprising different modulation frequencies. In this case, the evaluation device may further be configured to determine the at least one transversal coordinate of the object by evaluating the at least two modulated transversal sensor signals. Thus, the transversal optical sensor may be designed in such a way that the at least one transversal sensor signal may also be dependent on a modulation frequency of a modulation of the illumination.

As further used herein, the term “is oriented towards the object” generally refers to the situation that the surface of the fluorescent waveguiding sheet or a part of this surface, specifically the sensitive area, is fully or partially visible from the object. Specifically, at least one interconnecting line between at least one point of the object and at least one point of the sensitive area may form an angle with a surface element of the sensitive area or of the fluorescent waveguiding sheet which is different from 0°, such as an angle in the range of 20°-90°. Other embodiments, however, are feasible.

Most preferably, however, the at least one fluorescent waveguiding sheet, the transversal sensitive area or a part thereof is oriented essentially perpendicular to an optical axis of the transversal optical sensor and/or of the detector. Preferably, the longitudinal sensitive area or a part thereof is oriented essentially in the same manner, in particular, in a parallel arrangement with respect to the transversal sensitive area. As a result, it may particularly be possible to minimize any deviation in the determination of both the longitudinal coordinate and the transversal coordinate of the object. Thus, when the object is located on the optical axis or close to the optical axis, the light beam propagating from the object towards the detector may be essentially parallel to the optical axis. As used herein, the term “essentially perpendicular” refers to the condition of a perpendicular orientation, with a tolerance of e.g. ±20° or less, preferably a tolerance of ±10° or less, more preferably a tolerance of ±5° or less. Similarly, the term “essentially parallel” refers to the condition of a parallel orientation, with a tolerance of e.g. ±20° or less, preferably a tolerance of ±10° or less, more preferably a tolerance of ±5° or less.

Since at least two optical sensors, i.e. a transversal optical sensor and at least one longitudinal optical sensor, are used according to the present invention, the optical sensors may be located in one and the same beam path, specifically in a preferred case in which one or more of the optical sensors are transparent or semitransparent. In particular, the transversal optical sensor comprising the at least one fluorescent waveguiding sheet which forms the transversal sensitive area may, preferably, exhibit transparent or semitransparent properties. In accordance with the present invention it may, thus, be feasible to locate the transversal optical sensor within the same beam path as the at least one longitudinal optical sensor in front of at least one of the longitudinal optical sensors in a manner that an incident light beam may first impinge on the transversal optical sensor before impinging one of the longitudinal optical sensors. In this case, all but the last longitudinal optical sensor may, equally, exhibit transparent or semitransparent properties. Within this respect, it may be emphasized that the possibility of locating the transversal optical sensor within the same beam path in front of at least one of the longitudinal optical sensors constitutes a specific advantage of the present arrangement as this feature can, generally, not be realized with commonly available transversal optical sensors, particularly not with position sensitive devices which are usually based on intransparent inorganic materials, such as known CCD sensors and/or CMOS sensors.

Alternatively or in addition, at least two of the optical sensors may be positioned in different partial beam paths of the detector. Thus, the beam path of the detector may be split into two or more partial beam paths, such as by using one or more beam splitting elements, specifically one or more semitransparent mirrors and/or beam splitting cubes. Other embodiments are feasible.

As further used herein, a light spot generally refers to a visible or detectable round or non-round illumination of an object by a light beam. In the light spot, the light may fully or partially be scattered or may simply be transmitted.

The light beam propagates from the object towards the detector. As will be outlined in further detail below, the light beam may originate from the object, such as by the object and/or at least one illumination source integrated or attached to the object emitting the light beam, or may originate from a different illumination source, such as from an illumination source directly or indirectly illuminating the object, wherein the light beam is reflected or scattered by the object and, thereby, is at least partially directed towards the detector. Herein, the at least one illumination source may, preferably, emit light in a wavelength range covering the range of 400 nm to 900 nm, more preferred the range of 550 nm to 850 nm, in particular, the range of 600 nm to 800 nm, where the fluorescent material, such as a fluorescent colorant, in particular a dye, as described below in more detail, may exhibit an absorption maximum.

As further used herein, the term “light beam” generally refers to an amount of light, specifically an amount of light traveling essentially in the same direction, including the possibility of the light beam having a spreading angle or widening angle. The light beam specifically may be a Gaussian light beam, as will be outlined in further detail below. Other embodiments are feasible, however.

As further used herein, the term “photosensitive element” generally refers to an element which is sensitive against illumination in one or more of the ultraviolet, the visible or the infrared spectral range. Specifically, the photosensitive element may be or may comprise at least one element selected from the group consisting of a photodiode, a photocell, a photoconductor, a phototransistor or any combination thereof. Any other type of photosensitive element may be used. As will be outlined in further detail below, the photosensitive element generally may fully or partially be made of inorganic materials and/or may fully or partially be made of organic materials. Most commonly, as will be outlined in further detail below, one or more photodiodes may be used, such as commercially available photodiodes, e.g. inorganic semiconductor photodiodes.

As further used herein, the term “edge” generally refers to a boundary of the at least one fluorescent waveguiding sheet, such as a side boundary or side edge or a front or back face of the fluorescent waveguiding sheet. Thus, as the skilled person will recognize, the term “edge” may generally refer to an interface or boundary between the fluorescent waveguiding sheet and a surrounding atmosphere, such as air. Specifically, the edge may be a border of a light-sensitive area formed by the fluorescent waveguiding sheet. The term “located at” generally refers to the fact that the photosensitive elements are either located directly on the edge or in close proximity to the edge. As an example, at least 50% of the light emerging from the edge into the direction of the photosensitive element is collected by the respective photosensitive element, without being lost by scattering, beam widening or other losses. As an example, the photosensitive element may be located at a position spaced apart from the edge of no more than 10 mm, more preferably of no more than 5 mm. It shall be noted, however, that other embodiments are feasible for connecting the fluorescence light. Most preferably, all photosensitive elements are located relative to their respective edges of the fluorescent waveguiding sheet in the same way, in order to provide similar measurement conditions for all photosensitive elements.

The photosensitive elements located at the at least two edges of the fluorescent waveguiding sheet may, as an example, be fully or partially located in the same plane as the fluorescent waveguiding sheet and/or may fully or partially be located in a different plane. In the latter case, as will be outlined in further detail below, as an example, an optical coupling between the respective edge of the fluorescent waveguiding sheet and the respective photosensitive element may take place, by using at least one optical coupling element. Further, at least one of the photosensitive elements may be located in the same plane as the fluorescent waveguiding sheet and at least one of the photosensitive elements may be located outside the plane of the fluorescent waveguiding sheet. Further, a direction of view of at least one or even all of the photosensitive elements may be parallel to the plane of the fluorescent waveguiding sheet or may be directed otherwise, such as perpendicular to the plane. Therein, when talking about a “plane” of the fluorescent waveguiding sheet, this term does not necessarily imply that the fluorescent waveguiding sheet is fully planar. Thus, as an example, the fluorescent waveguiding sheet may also be curved or bent, and the plane of the fluorescent waveguiding sheet at the location of the respective photosensitive element may be a local tangential plane.

The term “edge”, as used herein, may refer to a straight line or straight border area of the fluorescent waveguiding sheet, in the following also referred to as a “straight edge”, or may also refer to a non-straight line or non-straight border area of the fluorescent waveguiding sheet, such as a corner of the fluorescent waveguiding sheet. Thus, at least one of the photosensitive elements, a plurality of the photosensitive elements or even all of the photosensitive elements may also be located at at least one corner of the fluorescent waveguiding sheet, such as at at least one corner of the second light-sensitive area formed by the fluorescent waveguiding sheet. Thus, specifically, the edge may comprise a rim or a portion of a rim of the fluorescent waveguiding sheet, such as a corner and/or a straight rim portion. Additionally or alternatively, however, the edge may also comprise a flat surface of the fluorescent waveguiding sheet, such as a front side or back side.

As already outlined above, in order to improve feeding fluorescence light guided from the light spot towards the at least one photosensitive element into the at least one respective photosensitive element, at least one optical coupling may take place, by using at least one optical coupling element in between the fluorescent waveguiding sheet and the respective photosensitive element. Thus, at least one of the photosensitive elements, a plurality of the photosensitive elements or even all of the photosensitive elements may be optically coupled to the fluorescent waveguiding sheet by at least one optical coupling element configured for at least partially coupling the fluorescence light guided by the fluorescent waveguiding sheet out of the fluorescent waveguiding sheet and, preferably, at least partially into the photosensitive element. As used herein, the term “optical coupling element” generally refers to an arbitrary element which is configured for one or more of disturbing, diminishing or interrupting an internal total reflection within the fluorescent waveguiding sheet which takes place during waveguiding within the fluorescent waveguiding sheet. Thus, as an example, the optical coupling element may be an arbitrary transparent element having an index of refraction in between an index of refraction of the fluorescent waveguiding sheet and the photosensitive element and/or the ambient atmosphere, such as air. Thus, as an example, in case an index of refraction of the fluorescent waveguiding sheet is denoted by n1, and an index of refraction of the photosensitive element is denoted by n2, an index of refraction n3 of the optical coupling element may be n1<n3<n2or n1>n3>n2.

The optical coupling element may be in direct contact with the fluorescent waveguiding sheet, such as with at least one surface, such as a surface facing the object and/or a surface facing away from the object, of the fluorescent waveguiding sheet. Further, the optical coupling element may also be in direct contact with the respective photosensitive element. Further, for each photosensitive element, an independent optical coupling element may be provided, or alternatively, a plurality of photosensitive elements may share a common optical coupling element, or, alternatively, a plurality of optical coupling elements may be coupled to one photosensitive element.

Various ways of optical coupling are generally known to the skilled person and may also be used for coupling fluorescence light from the fluorescent waveguiding sheet into the respective photosensitive element. Thus, as an example, the at least one optical coupling element may comprise at least one element selected from the group consisting of: a portion of transparent adhesive attaching the photosensitive element to the fluorescent waveguiding sheet; an etched portion within the fluorescent waveguiding sheet, such as within a surface of the fluorescent waveguiding sheet, such as a surface facing the object and/or facing away from the object; a scratch in the fluorescent waveguiding sheet, such as a scratch in the surface of the fluorescent waveguiding sheet, such as a surface facing the object and/or facing away from the object; a prism. Additionally or alternatively, other optical coupling elements are generally known and may also be used in the present invention. In a most simple case, the at least one photosensitive element may simply be adhered or glued to a surface of the fluorescent waveguiding sheet, such as by at least one transparent glue or adhesive, e.g. a transparent epoxy. Other ways of optical coupling are feasible.

Regarding the placement of the at least two photosensitive elements, a plurality of possibilities exists. Thus, as an example, the at least two photosensitive elements may be located at one or more of: at least two straight edges of the fluorescent waveguiding sheet, such as at least two opposing edges, e.g. opposing straight rim portions; at least two corners of the fluorescent waveguiding sheet, such as at least two opposing corners; at least one corner of the fluorescent waveguiding sheet and at least one straight edge, e.g. a straight rim portion, of the fluorescent waveguiding sheet. Other possibilities are generally given.

As used herein, a sensor signal generally refers to an arbitrary memorable and transferable signal which is generated by at least one the optical sensors, in particular, simultaneously by the longitudinal sensitive area and the photosensitive elements, in response to the illumination. Thus, as an example, the sensor signal may be or may comprise at least one electronic signal, which may be or may comprise a digital electronic signal and/or an analogue electronic signal. The sensor signal may be or may comprise at least one voltage signal and/or at least one current signal. Further, either raw sensor signals may be used, or the detector, the optical sensor or any other element may be adapted to process or preprocess the sensor signal, thereby generating secondary sensor signals, which may also be used as sensor signals, such as preprocessing by filtering or the like.

As further used herein, the term evaluation device generally refers to an arbitrary device adapted to perform the named operations, preferably by using at least one data processing device and, more preferably, by using at least one processor and/or at least one application-specific integrated circuit. Thus, as an example, the at least one evaluation device may comprise at least one data processing device having a software code stored thereon comprising a number of computer commands.

Specifically, as will be outlined in further detail below, the evaluation device may be configured to determine the at least one longitudinal coordinate z of the object by using at least one known, determinable or predetermined relationship between a magnitude of the longitudinal sensor signal and the longitudinal coordinate of the object. Further, the evaluation device may, additionally, be configured to determine at least one of the transversal coordinates x, y of the object by using at least one known, determinable or predetermined relationship between the relative magnitudes of the transversal sensor signals of the least two photosensitive elements and the transversal coordinate of the object.

Hereby, the evaluation device may optionally be configured to take account of a modulation frequency with which the illumination may be modulated. Thus, as outlined in greater detail in WO 2012/110924 A1, a plurality of longitudinal sensor signals may be detected by the same longitudinal optical sensor by using different modulation frequencies of an illumination of the object. Thus, at least two longitudinal sensor signals may be acquired at different frequencies of a modulation of the illumination, wherein, from the at least two sensor signals, for example by comparison with corresponding calibration curves, it may be possible to deduce the total power and/or the geometry of the illumination, and/or therefrom, directly or indirectly, to deduce the at least one longitudinal coordinate of the object, and/or to distinguish between two different objects or parts thereof which may be illuminated by light having different modulation frequencies. Alternatively or, preferably, in addition, a plurality of transversal sensor signals may also be detected by the same transversal optical sensor by using different modulation frequencies of an illumination of the object. Thus, at least two transversal sensor signals may be acquired at different frequencies of a modulation of the illumination, wherein, from the at least two sensor signals, for example by comparison with corresponding calibration curves, it may be possible to deduce the total power and/or the geometry of the illumination, and/or again, to distinguish between two different objects or parts thereof which may be illuminated by light having different modulation frequencies.

Furthermore, it may, thus, be possible to provide a spatial distinction between the two different objects or the parts thereof by combining the at least two longitudinal sensor signals which are acquired at different modulation frequencies with the at least two transversal sensor signals acquired at the same modulation frequencies and, preferably, concurrently with the longitudinal sensor signals. In other words, the detector according to the present invention may exhibit the particular advantage that it may easily allow differentiating between two individual objects and/or between two individual parts of a single object, even objects which may be located within the same direction of view. Using similar methods for detecting the different objects or the parts thereof by the two different kinds of optical sensors may, in addition, allow simplifying the corresponding determination procedures within the evaluation device.

The above-mentioned operations, including determining the at least one longitudinal and the at least one transversal coordinate of the object, are performed by the at least one evaluation device. Thus, as an example, one or more of the above-mentioned relationships may be implemented in software and/or hardware, such as by implementing one or more lookup tables. Thus, as an example, the evaluation device may comprise one or more programmable devices such as one or more computers, application-specific integrated circuits (ASICs) or Field Programmable Gate Arrays (FPGAs) which are configured to perform the above-mentioned evaluation, in order to determine, on one hand, the at least one longitudinal coordinate of the object by evaluating the nonlinear longitudinal sensor signal and, on the other hand, the at least one transversal coordinate of the object by evaluating and combining the transversal sensor signals. Additionally or alternatively, however, the evaluation device may also fully or partially be embodied by hardware.

It shall further be noted that two or more of the above-mentioned devices, including the optical sensors and the evaluation device, may fully or partially be integrated into one or more devices. Generally, the evaluation device may fully or partially be integrated into at least one of the optical sensors. Additionally or alternatively, the evaluation device may fully or partially be integrated into a common device which performs both functions and which, as an example, may comprise one or more hardware components such as one or more ASICs and/or one or more FPGAs. Additionally or alternatively, the evaluation device may also fully or partially be implemented by using one or more software components. The degree of integration may also have an impact on the speed of evaluation and the maximum frequency. Thus, as outlined above, the detector may also fully or partially be embodied as a camera and/or may be used in a camera, suited for acquiring standstill images or suited for acquiring video clips.

The detector according to one or more of the above-mentioned embodiments may be modified and improved or even optimized in various ways, which will be briefly discussed in the following and which may also be implemented in various arbitrary combinations, as the skilled person will recognize.

The detector may comprise a single longitudinal optical sensor or a plurality of longitudinal optical sensors. Thus, as discussed in various of the above-mentioned applications which are included by reference, specifically in WO 2014/097181 A1, an ambiguity exists in the size of the light spot at equal distances before and after the focal point. Thus, specifically for resolving this ambiguity, more than one longitudinal optical sensor may be used, wherein the longitudinal optical sensors are positioned at different positions along one or more beam paths of the light beam. Thus, by comparing the longitudinal sensor signals and/or the results retrieved by the two or more longitudinal optical sensors, it may be determined whether the focal point is located before the longitudinal optical sensors (beam is typically widening), behind the longitudinal optical sensors (beam is typically narrowing) or in between, wherein the latter often requires the use of three or more longitudinal optical sensors. Thus, specifically, the evaluation device may be configured to determine the at least one longitudinal coordinate z of the object by evaluating the longitudinal sensor signals of at least two of the longitudinal optical sensors. At least two of the longitudinal optical sensors may be positioned at different positions along at least one beam path of the light beam, such that an optical path length between the object and the at least two longitudinal optical sensors is non-identical. The evaluation device specifically may be configured to use the longitudinal sensor signals of at least two of the longitudinal optical sensors for resolving ambiguities in a relationship between the longitudinal sensor signals and the longitudinal coordinate z.

The detector can, furthermore, comprise at least one modulation device for modulating the illumination, in particular for periodic modulation, in particular a periodic beam interrupting device. A modulation of the illumination should be understood to mean a process in which a total power of the illumination may be varied, preferably periodically, in particular with one or a plurality of modulation frequencies, by way of example, with a frequency of 0.05 Hz to 1 MHz, such as 0.1 Hz to 10 kHz. In particular, a periodic modulation can be effected between a maximum value and a minimum value of the total power of the illumination. The minimum value can be 0, but can also exceed 0, such that, by way of example, a complete modulation does not have to be effected. The modulation can be effected for example in a beam path between the object and the optical sensor, for example by the at least one modulation device being arranged in said beam path. Alternatively or additionally, however, the modulation can also be effected in a beam path between an optional illumination source, as described in even greater detail below, for illuminating the object and the object, e.g. by the at least one modulation device being arranged in said beam path. A combination of these possibilities is also conceivable.

The at least one modulation device can comprise for example a beam chopper or some other type of periodic beam interrupting device, for example comprising at least one interrupter blade or interrupter wheel, which preferably rotates at constant speed and which can thus periodically interrupt the illumination. Alternatively or additionally, however, it may also be possible to use one or a plurality of different types of modulation devices, for example modulation devices based on an electro-optical effect and/or an acousto-optical effect. Once again alternatively or additionally, the at least one optional illumination source itself can also be designed to generate a modulated illumination, for example by said illumination source itself having a modulated intensity and/or total power, for example a periodically modulated total power, and/or by said illumination source being embodied as a pulsed illumination source, for example as a pulsed laser. Thus, by way of example, the at least one modulation device can also be wholly or partly integrated into the illumination source. Various other possibilities may also be feasible.

As already mentioned above, the detector can, thus, be designed to detect the at least two sensor signals in the case of different modulations, in particular the at least two sensor signals at respectively different modulation frequencies, simultaneously and/or consecutively. The evaluation device can, furthermore, be designed to generate the geometrical coordinates from the at least two sensor signals. In this way, by way of example, it may be possible to resolve ambiguities and/or be possible to take account of the fact that, for example, a total power of the illumination may, generally, be unknown. Further, at least two different light spots as generated by individual light beam having different modulation frequencies may, thus, be distinguishable with respect to each other.

The detector may further comprise one or more additional optical elements. As an example, the detector and/or the optical sensor may comprise one or more lenses and/or one or more flat or curved reflective elements, as will be outlined in further detail below in the context of the transfer device. Specifically, however, the optical sensor and/or the detector may further comprise at least one wavelength selective element, also referred to as at least one optical filter of filter element. The at least one optical filter, as an example, may comprise at least one transmissive filter or absorption filter, at least one grating, at least one dichroitic mirror or any combination thereof. Other types of wavelength selective elements may be used. Preferably, the at least one optical sensor comprises at least one optical filter element having at least one optical short-pass filter. As an example, the optical short-pass filter may be located in a beam path behind the at least one fluorescent waveguiding sheet, such that the light beam, firstly, as is the at least one fluorescent waveguiding sheet and, preferably afterwards, secondly, passes the at least one short-pass filter. In the beam path behind the at least one short-pass filter, preferably, at least one further element may be placed, such as at least one reference photosensitive element.

Thus, generally, as outlined above, the transversal optical sensor may further comprise at least one reference photosensitive element, also referred to as a reference photosensor, a reference detector or a photosensitive reference element. The reference photosensitive element generally may be an arbitrary photosensitive element which is configured and/or arrange to detect the light beam before or after passing the at least one fluorescent waveguiding sheet, or a part of this light beam. As outlined above, the at least one photosensitive element specifically may be used for calibration and/or normalization purposes, such as to render the above-mentioned means and methods more or less independent of the total power of the light beam. The at least one reference photosensitive element generally may be designed in a similar way as the at least one photosensitive element and, as an example, may comprise one or more of a photodiode, a photocell, a photoconductor, a phototransistor or a combination thereof. The at least one reference photosensitive element may specifically be selected from the group consisting of an organic photosensitive element and an inorganic photosensitive element. The reference photosensitive element specifically may be or may comprise a large-area photosensitive element, which, as an example, covers at least 10%, such as 10% to 100%, of the area of the fluorescent waveguiding sheet and/or of the sensitive area of thereof. The at least one reference photosensitive element, specifically, may be designed to detect the light of the light beam after passing the fluorescent waveguiding sheet and to generate at least one reference sensor signal. As outlined above, the at least one reference sensor signal specifically may be used for normalizing the transversal sensor signal of the photosensitive elements. The evaluation device specifically may be adapted to take into account the reference sensor signal for determining the position of the object, preferably for determining at least one transversal coordinate x, y of the object, as will be outlined in further detail below.

As outlined above, the detector is enabled to determine the at least one longitudinal coordinate of the object, including the option of determining the longitudinal coordinate of the whole object or of one or more parts thereof. In addition, however, other coordinates of the object, including one or more transversal coordinates and/or rotational coordinates, are to be determined by the detector, specifically by the evaluation device. Thus, as an example, a transversal position of the light spot generated by the light beam may be evaluated, such as by determining coordinates of a center of the light spot and/or coordinates of a maximum intensity of the light spot, within the transversal sensitive area. Since, typically, the properties of the optical setup of the detector are known, such as by knowing positions and/or properties of one or more lenses or other refractive elements positioned in one or more beam paths of the detector, at least one transversal coordinate of the object may be determined by the evaluation device. Thus, generally, the evaluation device is adapted to determine at least one transversal coordinate x, y of the object by determining a position of the light beam on the transversal sensitive area of the at least one fluorescent waveguiding sheet.

Thus, generally, the evaluation device is configured to determine at least one transversal coordinate x, y of the object by evaluating the sensor signals of the photosensitive elements. For the purpose of determining the at least one transversal coordinate in one or more directions, the transversal sensor signals of the photosensitive elements may be compared. Thus, as is evident to the skilled person, the sensor signal of a respective photosensitive element, which represents the fluorescence light guided to the photosensitive elements by the fluorescent waveguiding sheet from the light spot and, thus, from the location of generation of the fluorescence light, depends on a distance between the light spot and the respective photosensitive element. Generally, with an increasing distance between the light spot and the photosensitive element, the sensor signal of the respective photosensitive element will decrease, such as due to losses during waveguiding and/or due to spreading of the fluorescence light. By comparing the sensor signals of the photosensitive elements located at different, known positions, the lateral or transversal position of the light spot on the fluorescent waveguiding sheet may be determined and, therefrom, by using e.g. a known or determinable relationship between the transversal position of the light spot and the transversal coordinate of the object, the transversal coordinate of the object. Again, empirical relationships and/or semiempirical relationships and/or analytical relationships may be used, such as the lens equation which is generally known to the skilled person.

As an example, at least one difference signal between at least two transversal sensor signals of at least two photosensitive elements may be generated for comparing these sensor signals and, thus, for determining the transversal coordinate. Consequently, the evaluation device may comprise at least one subtracting device configured to form at least one difference signal D between at least two transversal sensor signals generated by at least two of the photosensitive elements. The transversal sensor signals may comprise at least one first sensor signal si and at least one second sensor signal s₂, wherein the at least one difference signal D specifically may be proportional to a·s₁-b·s₂, with a, b being real number coefficients, preferably with a=1 and b=1. In this simple example, the at least one difference signal D specifically may be derived according to the formula

D=(a·s₁−b·s₂)/(a·s₁+b·s₂). (1)

The subtracting device specifically may be configured to form at least one first difference signal Dₓ from which at least one first transversal coordinate x of the object is derived. The subtracting device may further be configured to form at least one second difference signal D_{y} from which at least one second transversal coordinate y of the object is derived. Thus, as an example, Cartesian coordinates of the object may be derived. It shall be noted, however, that other coordinate systems may be used, such as polar coordinate systems, depending on e.g. a geometry of the overall setup.

The first difference signal Dₓ specifically may be generated from at least two transversal sensor signals sₓ₁, sₓ₂ of at least two photosensitive elements located at opposing edges of the wave-guiding sheet in a first dimension, which may also be referred to as an x-direction or x-dimension. Similarly, the second difference signal D_{y} may be generated from at least two transversal sensor signals s_{y1}, s_{y2} of at least two photosensitive elements located at opposing edges of the waveguiding sheet in a second dimension, which may also be referred to as a y-direction or a y-dimension. Thus, the coordinate system may be defined, with an optical axis of the detector being a z-axis, and with two axes x and y in a plane of the fluorescent waveguiding sheet, e.g. in a plane perpendicular to the z-axis. Other coordinate systems, however, are feasible. The at least one first difference signal Dₓ specifically may be generated according to the formula

Dₓ=(a·sₓ₁−b·sₓ₂)/(a·sₓ₁+b·sₓ₂), (2)

and, accordingly, the at least one second difference signal D_{y} may be derived according to the formula

D_{y}=(c·s_{y1}−d·s_{y2})/(c·s_{y1}+d·s_{y2}), (3)

with a, b, c, d being real number coefficients, preferably with a=1, b=1, c=1 and d=1. Other examples, however, are feasible.

Further optional details of the detector may refer to the photosensitive elements, and, optionally, to the at least one reference photosensitive element. Thus, the photosensitive elements may comprise at least two photosensitive elements located at opposing edges of the fluorescent waveguiding sheet, e.g. opposing straight rim portions. As an example, the fluorescent wave-guiding sheet may be or may comprise at least one rectangular fluorescent waveguiding sheet, and at least two photosensitive elements may be located at opposing, parallel edges, e.g. opposing straight rim portions, of the rectangular fluorescent waveguiding sheet. As an example, two parallel edges, e.g. two parallel rim portions, may be located in an opposing fashion in an x-direction, each edge having at least one photosensitive element, and/or two parallel edges, e.g. two parallel rim portions, may be located in an opposing fashion in a y-direction, each edge having at least one photosensitive element. Thus, generally, the edges or rim portions of the rectangular fluorescent waveguiding sheet may be oriented perpendicular to the axes of an x-y-coordinate system. It shall be noted, however, that other geometrical shapes and/or other coordinate systems are feasible. The described Cartesian coordinate system, however, is fairly easy to implement from a technical point of view, and the evaluation of the sensor signals, such as by using one or more of the above-mentioned formulae, is rather simple.

The photosensitive elements specifically may comprise at least one first pair of photosensitive elements located at opposing edges of the fluorescent waveguiding sheet in a first dimension of a coordinate system, such as in an x-dimension, and the photosensitive elements further comprise at least one second pair of photosensitive elements located at other opposing edges of the fluorescent waveguiding sheet in a second dimension of the coordinate system, such as in a y-dimension.

Further optional details may refer to the at least one fluorescent waveguiding sheet and/or to the transversal sensitive area. Thus, as an example, the transversal sensitive area may specifically be a homogeneous sensitive area. Thus, the transversal sensitive area may not be subdivided physically into partial areas, such as pixels. Contrarily, the transversal sensitive area may be one homogeneous area which forms a uniform fluorescence. Preferably, the longitudinal sensitive area or a part thereof may be embodied essentially in the same manner, thus, also comprising a homogeneous sensitive area.

The sensitive areas specifically may be large sensitive areas. Thus, as an example, the sensitive area may have a surface of at least 5 mm², preferably of at least 10 mm², more preferably of at least 100 mm², more preferably of at least 400 mm². As an example, the sensitive area may have a surface of 5 mm² to 10,000 mm², such as 100 mm² to 2500 mm². The large-area design of the sensitive area is advantageous in many ways. Thus, specifically, by increasing the surface of the sensitive area, a resolution of the determination of the transversal coordinates may be increased. Further, the field of view of the detector, e.g. the viewing angle, may be widened by using a large sensitive area.

Furthermore, it may, thus, be possible to adjust the homogeneous sensitive areas of the transversal optical sensor and of the at least one longitudinal optical sensor, such as by using the same magnitude for extensions of the sensitive areas, that the same incident light beam may be recorded by both the transversal optical sensor and of the at least one longitudinal optical sensor which may be located in the vicinity of each other, preferably in a consecutive manner. As used herein, the “same magnitude” refers to an observation that the lateral dimensions of both the longitudinal sensitive areas and the transversal sensitive areas are identical within a factor between 0.1 and 10, preferably within a factor between 0.3 and 3, more preferred within a factor between 0.9 and 1.1. Within this regard it may be mentioned that such an embodiment cannot be realized by using commonly available PSD devices comprising a pixelated sensitive area, such as CCD sensors and/or CMOS sensors, thus, being in clear contrast to the PSD device as employed within the present invention which is, thus, compatible with the FiP technology which, generally, employs large homogeneous sensitive areas up to 10,000 mm² or more.

Alternatively, further commonly available PSD devices comprising large-area diodes, in particular, inorganic semiconducting sensors, such as silicon, germanium, or CdTe sensors, or transparent solar cells, usually, have a resistive interlayer being adapted for receiving different transversal sensor signals for different electrodes. However, generally, the large-area diodes comprise a higher capacity C and thus, a higher value for the product R·C, also denominated as “time constant”, wherein R denotes the corresponding electrical resistance of diode. As a result of the larger value for the time constant of the commonly available PSD devices, their frequency response is, however, rather limited at low frequencies. In order to avoid this disadvantage, small diodes, such as dot-shaped photodiodes or elongated photodiodes, may, thus, be used as the photosensitive elements located at the at least two edges of the fluorescent waveguiding sheet according to the present invention since, particularly due to their small extensions, they, usually, comprise a small time constant. Therefore, higher readout frequencies of the corresponding transversal sensor signals as well as higher modulation frequencies of the illumination may, thus, be feasible. However, higher readout frequencies and/or modulation frequencies can be of particular advantage with regard to the present invention since FiP sensors not or only poorly illuminated, usually, exhibit a small value for the time constant. Thus, knowing a movement of the object with respect to the transversal coordinates x, y by evaluating the transversal sensor signals of the small diodes as comprised by of photosensitive elements, the value of the time constants may easily be corrected. As a consequence, a faster detector may be obtained in this manner, altogether.

The fluorescent waveguiding sheet specifically may comprise at least one planar sheet. Therein, however, slight curvatures still may be tolerated. In other embodiments, however, the fluorescent waveguiding sheet may also be embodied as a curved fluorescent waveguiding sheet, such as in order to provoke specific optical effects which might be desirable in certain applications. Thus, one of the advantages of the present detector may reside in the fact that the fluorescent waveguiding sheet specifically may be curved, flexible or having a specific geometry.

The fluorescent waveguiding sheet has a thickness of 10 μm to 3 mm, preferably a thickness of 100 μm to 1 mm, e.g. a thickness of 50 μm to 2 mm. The thickness of the waveguiding sheet specifically may be a dimensioned of the waveguiding sheet along an optical axis of the detector. The thickness may be adapted to improve our optimize waveguiding properties of the fluorescence light.

As outlined above, the fluorescent waveguiding sheet may fully or partially be rigid or, alternatively, may fully or partially be embodied flexible or deformable.

The fluorescent waveguiding sheet may comprise at least one matrix material. As used herein, the term “matrix material” generally refers to a material which forms the main part of the fluorescent waveguiding sheet and which defines the main body of the fluorescent waveguiding sheet. As an example, the matrix material may be a material which is capable of receiving one or more additional materials that therein, such as by intermixing, chemical bonding, dispersion or solving. Thus, the at least one fluorescent material is preferably embedded within the matrix, i.e. the fluorescent material may be one or more of mixed into the matrix material, dispersed into the matrix material, chemically bound to the matrix material or dissolved in the matrix material.

The matrix material specifically may be or may comprise at least one plastic material. The plastic material specifically may be or may comprise at least one polymer material. The plastic material, as an example, may be or may comprise at least one material selected from

homo- and copolymers which comprise at least one copolymerized monomer selected from C2-C10-monoolefins, 1,3-butadiene, 2-chloro-1,3-butadiene, vinyl alcohol and its C2-C10-alkyl esters, vinyl chloride, vinylidene chloride, glycidyl acrylate, glycidyl methacrylate, acrylates

and methacrylates of C1-C10-alcohols, vinylaromatics, (meth)acrylonitrile, maleic anhydride, and ethylenically unsaturated mono- and dicarboxylic acids,

homo- and copolymers of vinyl acetals,

polyvinyl esters,

polyvinylchlorides

polycarbonates,

polyesters,

polyethers,

polyether ketones,

thermoplastic polyurethanes,

polysulfides,

polysulfones,

polyether sulfones,

cellulose alkyl esters,

polypropylenes

polyethylene terephthalates

and mixtures of two or more thereof.

Mention may be made by way of example of polyacrylates having identical or different alcohol moieties from the group of the C4-C8-alcohols (particularly of butanol, hexanol, octanol, and 2-ethylhexanol), polycarbonate, polymethyl methacrylate (PMMA), methyl methacrylate, butyl acrylate copolymers, acrylonitrile-butadiene-styrene copolymers (ABSs), ethylene-propylene copolymers, ethylene-propylene-diene copolymers (EPDMs), polystyrene (PS), styrene-acrylonitrile copolymers (SANs), acrylonitrile-styrene-acrylate (ASA), styrene-butadiene-methyl methacrylate copolymers (SBMMAs), styrene-maleic anhydride copolymers, styrene-methacrylic acid copolymers (SMAs), polyoxymethylene (POM), polyvinyl alcohol (PVAL), polyvinyl acetate (PVA), polyvinylbutyral (PVB), polycaprolactone (PCL), polyhydroxybutyric acid (PHB), polyhydroxyvaleric acid (PHV), polylactic acid (PLA), ethylcellulose (EC), cellulose acetate (CA), cellulose propionate (CP), and cellulose acetate/butyrate (CAB).

Preferably, plastic material, may be or may comprise at least one material selected from from the group consisting of a polycarbonate, a poly(methyl methacrylate), a polystyrene, a polyurethane, a polypropylene, a polyethylene terephthalate, a polyvinylchloride. Other materials, however, are feasible. Particular preference is given to polycarbonate or poly(methyl-methacrylate).

The matrix material may further comprise suitable stabilizers to stabilize the polymer. Such stabilizers are known to the skilled person and include antioxidants, UV absorbers, light stabilizers, hindered amine light stabilizers, antiozonants and the like, in particular hindered amine light stabilizers. The term “hindered amine light stabilizer” refers to sterically hindered amines of the class of compounds typically represented by 2,2,6,6 tetraalkyl piperidines.

In case the matrix material comprises a stabilizer, the matrix material preferably comprises the stabilizer in an amount of 0.001% by weight to 10% by weight, based on the total weight of the sum of all matrix materials.

According to one preferred embodiment, the matrix material consists of the polymeric material.

The fluorescent material generally may comprise an arbitrary fluorophore. Specifically, the at least one fluorescent material may comprise at least one fluorescent colorant, preferably at least one fluorescent dye. In particular, the at least one fluorescent material is a fluorescent colorant, preferably a fluorescent dye.

A wide variety of fluorescent colorants, preferably dyes, is generally known to the skilled person. Thereof, as outlined above, most of these fluorescent dyes exhibit the above-mentioned saturation effects, thereby rendering the fluorescence being a nonlinear function of the excitation. As an example, the fluorescent dye may be capable of being saturated by the light beam, such that a total power of the fluorescence light generated by the fluorescent dye is a nonlinear function of an intensity of the light beam. Specifically, the total power of the fluorescence light may be sub-proportional to the intensity of the light beam.

The fluorescent dye specifically may comprise at least one organic fluorescent dye. Inorganic dyes, however, may be used additionally or alternatively.

According to a preferred embodiment, the fluorescent colorant, preferably the fluorescent dye, is selected from the group consisting of stilbenes, benzoxazoles, squaraines, bisdiphenylethylenes, coumarins, merocyanines, benzopyrans, naphthalimides, rylenes, phthalocyanines, naphthalocyanines, cyanines, xanthenes, oxazines, oxadiazols, squaraines, oxadiols, anthrachinones, acridines, arylmethanes, boron-dipyrromethenes, Aza-boron-dipyrromethenes, violanthrons, isoviolanthrons and diketopyrrolopyrrols. More preferably, the fluorescent colorant is selected from the group consisting of rylenes, phthalocyanines, naphthalocyanines, cyanines, xanthenes, oxazines, boron-dipyrromethenes, Aza-boron-dipyrromethenes and Diketopyrrolopyrrols, even more preferably from the group consisting of rylenes, xanthenes and phthalocyanines.

According to a further preferred embodiment, the fluorescent dye specifically may be selected from the group consisting of: a xanthene derivative, preferably one or more of fluorescein, rhodamine, oregon green, eosin, texas red, or a derivative of any component thereof; a cyanine derivative, preferably one or more of cyanine, indocarbocyanine, oxacarbocyanine, thiacarbocyanine, merocyanine, or a derivative of any component thereof; a squaraine derivative or a ring-substituted squaraine, preferably one or more of Seta, SeTau, and Square dyes, or a derivative of any component thereof; a naphthalene derivative, preferably one or more of a dansyl or a prodan derivative thereof; a coumarin derivative; a oxadiazole derivative, preferably one or more of pyridyloxazole, nitrobenzoxadiazole, benzoxadiazole, or a derivative of any component thereof; an anthracene derivative, preferably one or more of an anthraquinone, DRAQ5, DRAQ7, CyTRAK orange, or a derivative of any component thereof; a pyrene derivative, preferably cascade blue; an oxazine derivative, preferably one or more of nile red, nile blue, cresyl violet, oxazine 170, or a derivative of any component thereof; an acridine derivative, preferably one or more of proflavin, acridine orange, acridine yellow, or a derivative of any component thereof; an arylmethine derivative, preferably one or more of auramine, crystal violet, malachite green, or a derivative of any component thereof; a tetrapyrrole derivative, preferably one or more of porphin, phthalocyanine, bilirubin; a rylene dye or any derivative thereof, such as a perylene dye; a naphthalene imid or perylene imide; a naphthoilene benzimidazole dye such as published in WO 2012/168395 Al; or a derivative of any component of the listed substances. It shall be noted, however, that other dyes may be used additionally or alternatively. According to a preferred embodiment of the invention, the fluorescent material comprises at least one fluorescent colorant, preferably at least one fluorescent dye, which, in a wavelength range of 400 nm to 900 nm, has an absorption maximum which occurs in the wavelength range of 500 nm to 850 nm.

As generally used, the term “absorption” refers to an optical property of a substance, such as of the fluorescent colorant, which is related to receiving and keeping a partition of an incident radiation, in particular, of a light beam impinging the substance, rather than reflecting or transmitting it. Disregarding reflection, a transmission of the incident radiation through the substance may, thus, be incomplete, which results in an attenuation of the impinging light beam. In general, the absorption of the incident radiation by the substance, however, depends on a wavelength of the incident light beam, whereby the absorption of the substance may vary over an increasing or a decreasing wavelength. In this regard, the term “absorption maximum” may, thus, refer to one or more specific wavelengths or wavelength ranges in which the absorption of the incident radiation by the substance may assume a higher value compared to adjacent wavelengths or wavelength ranges over a course of absorption values with regard to the corresponding wavelength. In a particularly preferred embodiment, the absorption maximum may be an absolute maximum over a predefined wavelength range, in particular, over the whole above-mentioned wavelength range of 400 nm to 900 nm. Consequently, the term “absolute maximum” describes a type of absorption of the substance which assumes the highest value within the predefined wavelength range, thus, exceeding the absorption of the substance at all other wavelengths within the predefined wavelength range. However, a “relative maximum” may also be feasible, i.e. it may not be required that the absorption maximum may assume the highest value of the colorant as such as long as the absorption at the specific wavelength exceeds the absorption at adjacent wavelength ranges.

With regard to this preferred embodiment of the present invention, considering a wavelength range of 400 nm to 900 nm, the fluorescent colorant, preferably the fluorescent dye, has an absorption characteristic exhibiting an absorption maximum which occurs in the wavelength range of 500 nm to 850 nm. This feature is to be understood that the fluorescent colorant may, however, exhibit a further maximum absorption maximum which may occur in the wavelength range below 400 nm. Preferably, the absorption maximum which occurs in the wavelength range of 500 nm to 850 nm is an absolute maximum within the wavelength range of 400 nm to 900 nm, as outlined above. More preferably, the absorption maximum which occurs in the wavelength range of 500 nm to 850 nm is an absolute maximum over the range of from 350 to 900 nm, i.e. any possible additional maximum optionally occurring in the wavelength range below 400 nm is preferably a relative maximum.

Preferably, the fluorescent colorant, in particular the dye, may, in the range of 400 nm to 900 nm, exhibit an absorption maximum in the wavelength range of 550 nm to 850 nm, more preferably in the wavelength range of 600 nm to 800 nm, preferably measured with the colorant being embedded into the matrix material. In principle, any fluorescent colorant, preferably fluorescent dye, known to those skilled in the art may be employed, provided that—according to this preferred embodiment—these colorants display the desired absorption maximum defined above. A particular advantage of using a fluorescent colorant which may exhibit fluorescence within the near infrared spectral range may be that the fluorescence may, thus, occur in a wavelength region for which the human eye is not sensitive.

In general, the course of the absorption of the fluorescent colorant over the predefined wavelength range may be measured by using the fluorescent colorant only. However, in a preferred embodiment, the course of the absorption of the fluorescent colorant over the predefined wavelength range may be measured by using the fluorescent colorant embedded within the matrix material, thereby taking into account the absorption characteristic of the matrix material in which the fluorescent colorant is disposed in.

Preferably, the fluorescent colorant is thus a fluorescent colorant, in particular a dye, which, in a wavelength range of 400 nm to 900 nm, has an absorption maximum which occurs in the wavelength range of 500 nm to 850 nm, and which is selected from the group consisting of stilbenes, benzoxazoles, squaraines, bisdiphenylethylenes, coumarins, merocyanines, benzopyrans, naphthalimides, rylenes, phthalocyanines, naphthalocyanines, cyanines, xanthenes, oxazines, oxadiazols, squaraines, oxadiols, anthrachinones, acridines, arylmethanes, borondipyrromethenes, Aza-boron-dipyrromethenes, violanthrons, isoviolanthrons and diketopyrrolopyrrols, more preferably which is selected from the group consisting of rylenes, phthalocyanines, naphthalocyanines, cyanines, xanthenes, oxazines, boron-dipyrromethenes, Aza-boron-dipyroomethenes and Diketopyrrolopyrrols, even more preferably from the group consisting of rylenes, xanthenes and phthalocyanines.

### Rylene Colorants

The term rylene colorant as used herein refers to colorants comprising a rylene framework of naphtalene units linked in pen-positions. Such rylene frameworks include, but are not limited to perylene, terrylene and quarterrylene. Thus, the rylene colorant according to the invention, comprises a core structure based on a rylene framework, in particular a perylene, terrylene or quaterrylene core structure.

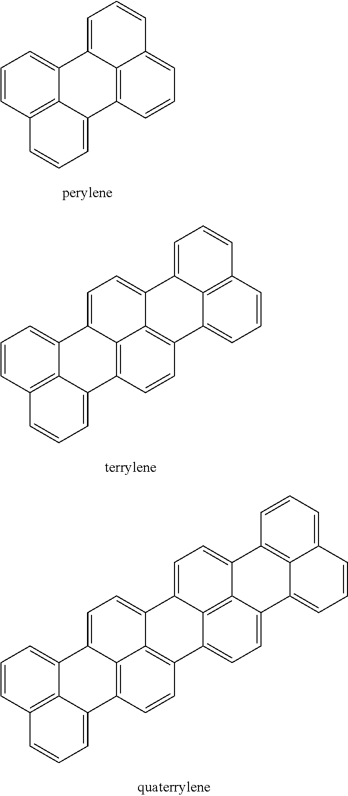

The term “comprising a core structure” as used in the context of the present invention is denoted to mean that the shown structure may be suitably substituted.

Preferably, the rylene colorant comprises a polycyclic group P^{r}, wherein the polycyclic group comprises the rylene framework, in particular a perylene, terrylene or quaterrylene core structure being substituted with at least one group (radical) R^{r}, with R^{r} being selected from the group consisting of alkyl, heteroalkyl, cycloalkyl, aryl, heteroaryl, cycloheteroalkyl, —O-alkyl, —O-aryl, —O-heteroaryl, —O-cycloalkyl and —O-cycloheteroalkyl. It is to be understood that, each residue R^{r} may be the same or may differ from each other. If, more than one group R^{r} is present, preferably all groups R^{r} are the same.

Within the meaning of the present invention, the term “alkyl” relates to non-branched alkyl residues and branched alkyl residues. The term also encompasses alkyl groups which are further substituted by one or more suitable substituents. The term “substituted alkyl” as used in this context of the present invention preferably refers to alkyl groups being substituted in any position by one or more substituents, preferably by 1, 2, 3, 4, 5 or 6 substituents, more preferably by 1, 2, or 3 substituents. If two or more substituents are present, each substituent may be the same or may be different from the at least one other substituent. There are in general no limitations as to the substituent. The substituents may be, for example, selected from the group consisting of aryl, heteroaryl, cycloalkyl, heterocycloalkyl, alkenyl, alkynyl, halogen, hydroxyl, alkyl-carbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxy, phosphate, phosphonato, phosphinato, amino, acylamino, including alkylcarbonylamino, arylcarbonylamino, carbamoyl, ureido, amidino, nitro, imino, sulfhydryl, alkylthio, arylthio, thiocarboxylate, sulfates, alkylsulfinyl, sulfonate, sulfamoyl, sulfonamido, trifluoromethyl, cyano and azido. Preferred substituents of such organic residues are, for example, halogens, such as fluorine, chlorine, bromine or iodine, amino groups, hydroxyl groups, carbonyl groups, thiol groups and carboxyl groups.

The term “heteroalkyl” refers to alkyl residues comprising one or more heteroatoms or functional groups, such as, by way of example, —O—, —S—, —NH—, —NH—C(═O)—, —C(═O)—NH— and the like.

The term “cycloalkyl” refers to alkyl groups which form a ring, such as a 5-membered, 6-membered or 7-membered ring, e.g. cyclopentyl or cyclohexyl.

The term “heterocycloalkyl” refers to cycloalkyl groups comprising one or more heteroatoms or functional groups, such as, by way of example, —O—, —S—, —NH—, —NH—C(═O)—, —C(═O)—NH—, and the like, such as, e.g., morpholino, piperazinyl or piperidinyl, alkylaryl, arylalkyl and heteroaryl.

Within the meaning of the present invention, the term “aryl” refers to, but is not limited to, optionally suitably substituted 5- and 6-membered single-ring aromatic groups as well as optionally suitably substituted multicyclic groups, for example bicyclic or tricyclic aryl groups. The term “ aryl” thus includes, for example, optionally substituted phenyl groups or optionally suitably substituted naphthyl groups. Aryl groups can also be fused or bridged with alicyclic or heterocycloalkyl rings which are not aromatic so as to form a polycycle, e.g. benzodioxolyl or tetraline.

The term “heteroaryl” as used within the meaning of the present invention includes optionally suitably substituted 5- and 6-membered single-ring aromatic groups as well as substituted of unsubstituted multicyclic aryl groups, for example tricyclic or bicyclic aryl groups, comprising one or more, preferably from 1 to 4, such as 1, 2, 3 or 4, heteroatoms, wherein in case the aryl residue comprises more than 1 heteroatom, the heteroatoms may be the same or different. Such heteroaryl groups including from 1 to 4 heteroatoms are, for example, benzodioxolyl, pyrrolyl, furanyl, thiophenyl, thiazolyl, isothiazolyl, imidazolyl, triazolyl, tetrazolyl, pyrazolyl, oxazolyl, isoxazolyl, pyridinyl, pyrazinyl, pyridazinyl, benzoxazolyl, benzodioxazolyl, benzothiazolyl, benzoimidazolyl, benzothiophenyl, methylenedioxyphenylyl, napthyridinyl, quinolinyl, isoquinolinyl, indolyl, benzofuranyl, purinyl, deazapurinyl, or indolizinyl.

The term “optionally substituted aryl” and the term “optionally substituted heteroaryl” as used in the context of the present invention describes moieties having substituents replacing a hydrogen on one or more atoms, e.g. C or N, of an aryl or heteroaryl moiety. Again, there are in general no limitations as to the substituent. The substituents may be, for example, selected from the group consisting of alkyl, alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxy, phosphate, phosphonato, phosphinato, amino, acylamino, including alkylcarbonylamino, arylcarbonylamino, carbamoyl and ureido, amidino, nitro, imino, sulfhydryl, alkylthio, arylthio, thiocarboxylate, sulfates, alkylsulfinyl, sulfonate, sulfamoyl, sulfonamido, trifluoromethyl, cyano, azido, cycloalkyl, such as, e.g., cyclopentyl or cyclohexyl, heterocycloalkyl, such as, e.g., morpholino, piperazinyl or piperidinyl, alkylaryl, arylalkyl and heteroaryl. Preferred substituents of such organic residues are, for example, halogens, such as fluorine, chlorine, bromine or iodine, amino groups, hydroxyl groups, carbonyl groups, thiol groups and carboxyl groups. Preferably the at least one group R^{r} is —O-aryl or —O-heteroaryl, more preferably —O-alkyl, most preferably, the group has the following structure:

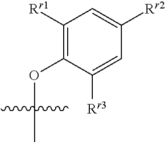

with R^{r1}, R^{r2} and R^{r3}, preferably being, independently of each other selected from the group consisting of, H, alkyl, heteroalkyl, aryl, heteroaryl, O-alkyl, O-aryl and O-heteroaryl, more preferably, wherein, R^{r1}, R^{r2} and R^{r3}, are, independently of each other selected from H and alkyl, more preferably H and C1-08 alkyl.

Preferably, R^{r1}, R^{r2} and R^{r3}, are, independently of each other selected from the group consisting of, H, iso-propyl and —C(CH₃)₂—CH₂—C(CH₃)₃. Most preferably, R^{r} is selected from the following radicals

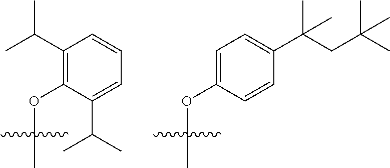 [SMILES: *Oc1c(C(C)C)cccc1C(C)C ; *Oc1ccc(C(C)(C)CC(C)(C)C)cc1]

The polycyclic group P^{r} preferably comprises one of the following core structures

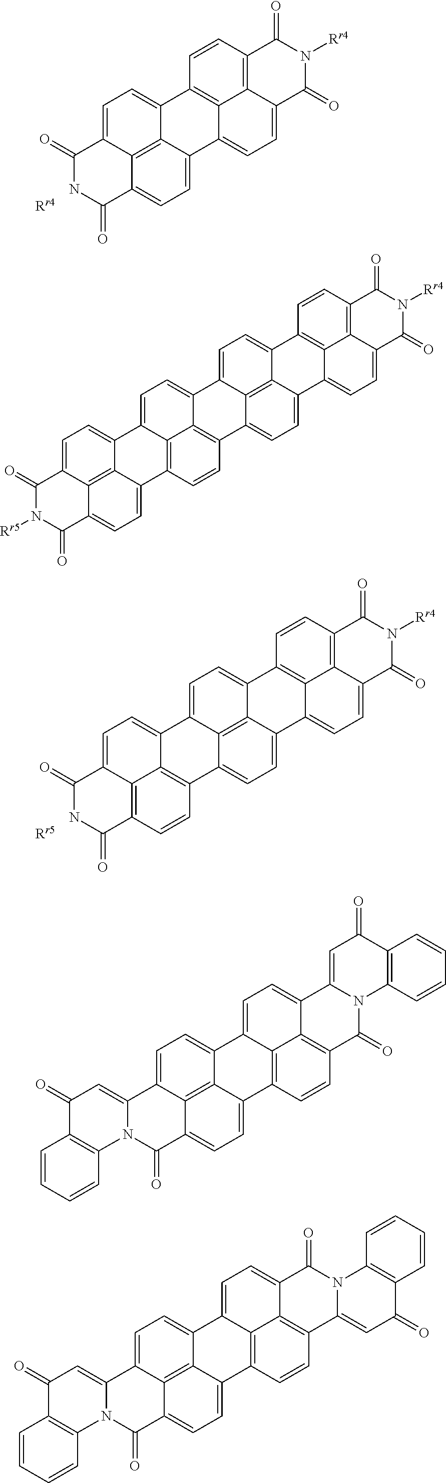

more preferably one of the following core structures

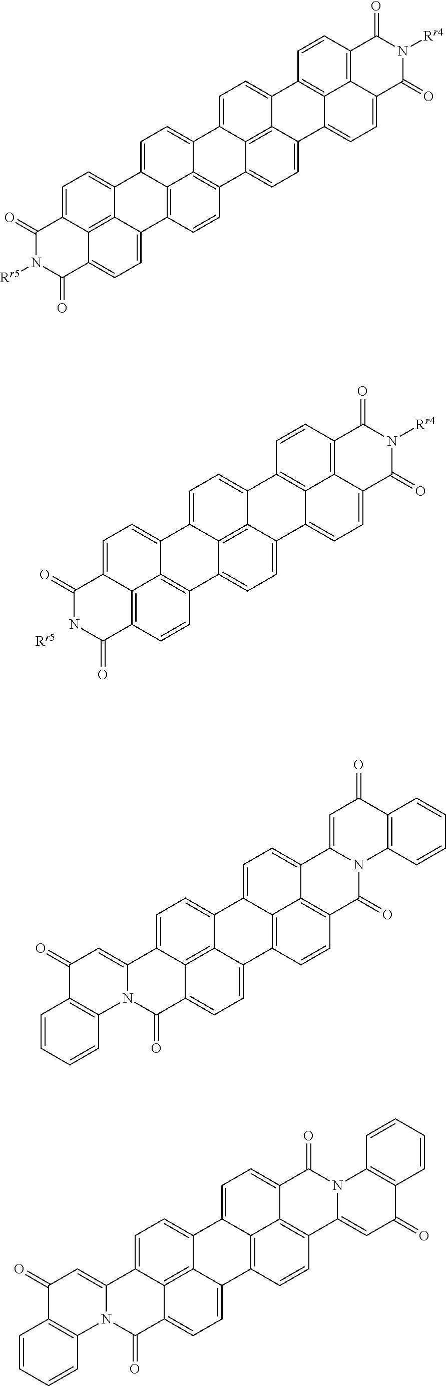

wherein R^{r4} and R^{r5}, are, independently of each other, alkyl or aryl, preferably aryl, more preferably an alkyl substituted aryl, more preferably an alkyl substituted phenyl, more preferably an C1-C6 alkyl substituted phenyl, even more preferably an in ortho and meta position with an C1-C6 alkyl group substituted phenyl, most at least one of, preferably both of, R^{r4} and R^{r5}, are

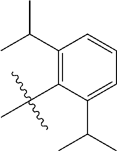 [SMILES: *c1c(C(C)C)cccc1C(C)C]

and wherein the core structures are preferably substituted with at least one radical R^{r}, with R^{r} being as described above, preferably with R^{r} being selected from the following radicals

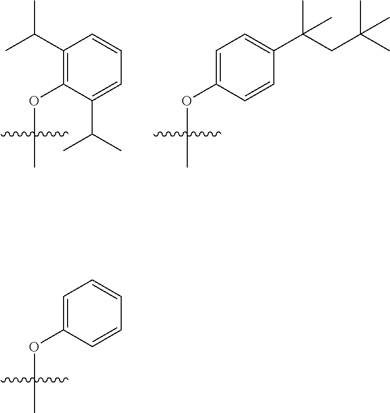 [SMILES: *Oc1c(C(C)C)cccc1C(C)C ; *Oc1ccc(C(C)(C)CC(C)(C)C)cc1 ; *Oc1ccccc1]

or wherein the core structure comprises no additional substituents.

More preferably, the core structures are substituted with at least one radical RI being selected from the following radicals

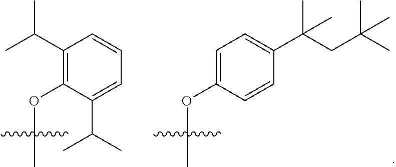 [SMILES: *Oc1c(C(C)C)cccc1C(C)C ; *Oc1ccc(C(C)(C)CC(C)(C)C)cc1]

It is to be understood that in case, the colorant comprises the core structure

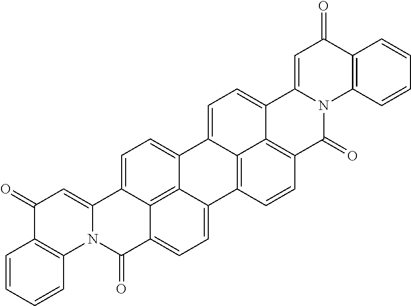 [SMILES: O=c1cc2c3ccc4c5ccc6c7c(ccc(c8ccc(c(=O)n2c2ccccc12)c3c84)c57)c(=O)n1c2ccccc2c(=O)cc61]

the colorant may further comprise, the respective isomeric core structure

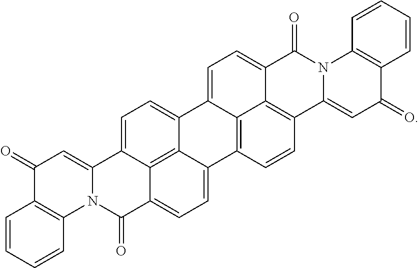 [SMILES: O=c1cc2c3ccc4c5ccc6c(=O)n7c8ccccc8c(=O)cc7c7ccc(c8ccc(c(=O)n2c2ccccc12)c3c84)c5c67]

Similarly, in case the colorant comprises the core structure

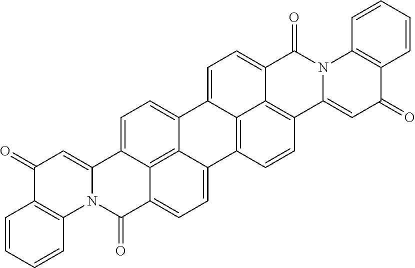 [SMILES: O=c1cc2c3ccc4c5ccc6c(=O)n7c8ccccc8c(=O)cc7c7ccc(c8ccc(c(=O)n2c2ccccc12)c3c84)c5c67]

the colorant may further comprise, the respective isomeric core structure

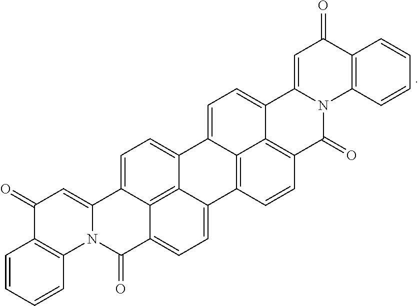 [SMILES: O=c1cc2c3ccc4c5ccc6c7c(ccc(c8ccc(c(=O)n2c2ccccc12)c3c84)c57)c(=O)n1c2ccccc2c(=O)cc61]

Thus, the colorant may be a mixture of both isomers. Alternatively, the colorant may be a pure isomer.

Even more preferably, the rylene colorant has one of the following structures:

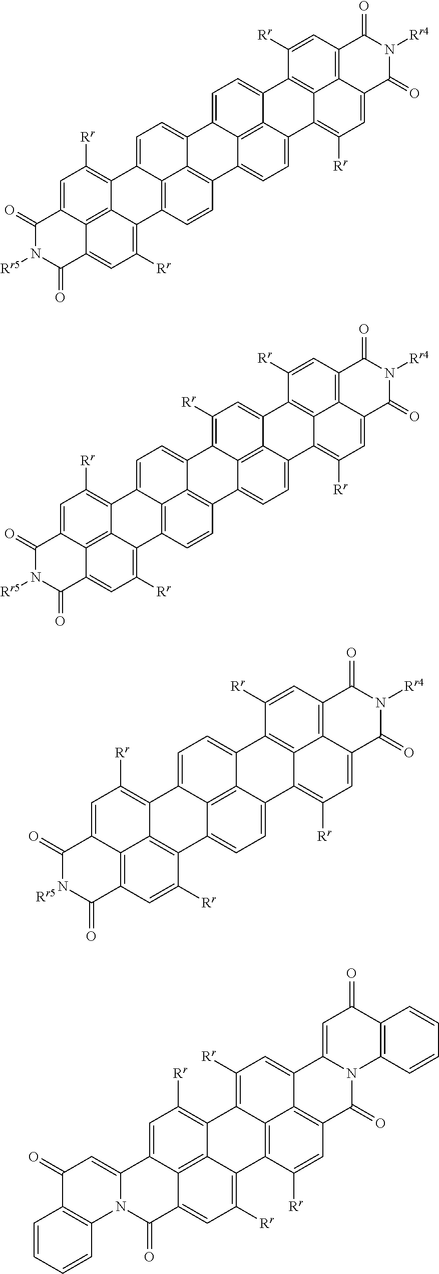

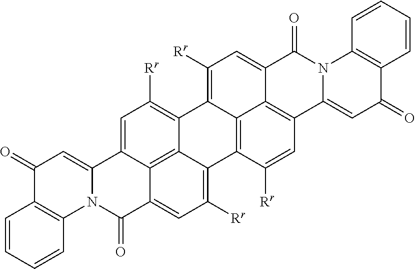

Especially preferably, the rylene fluorescent colorant according to the invention is selected from the group consisting of the following structures:

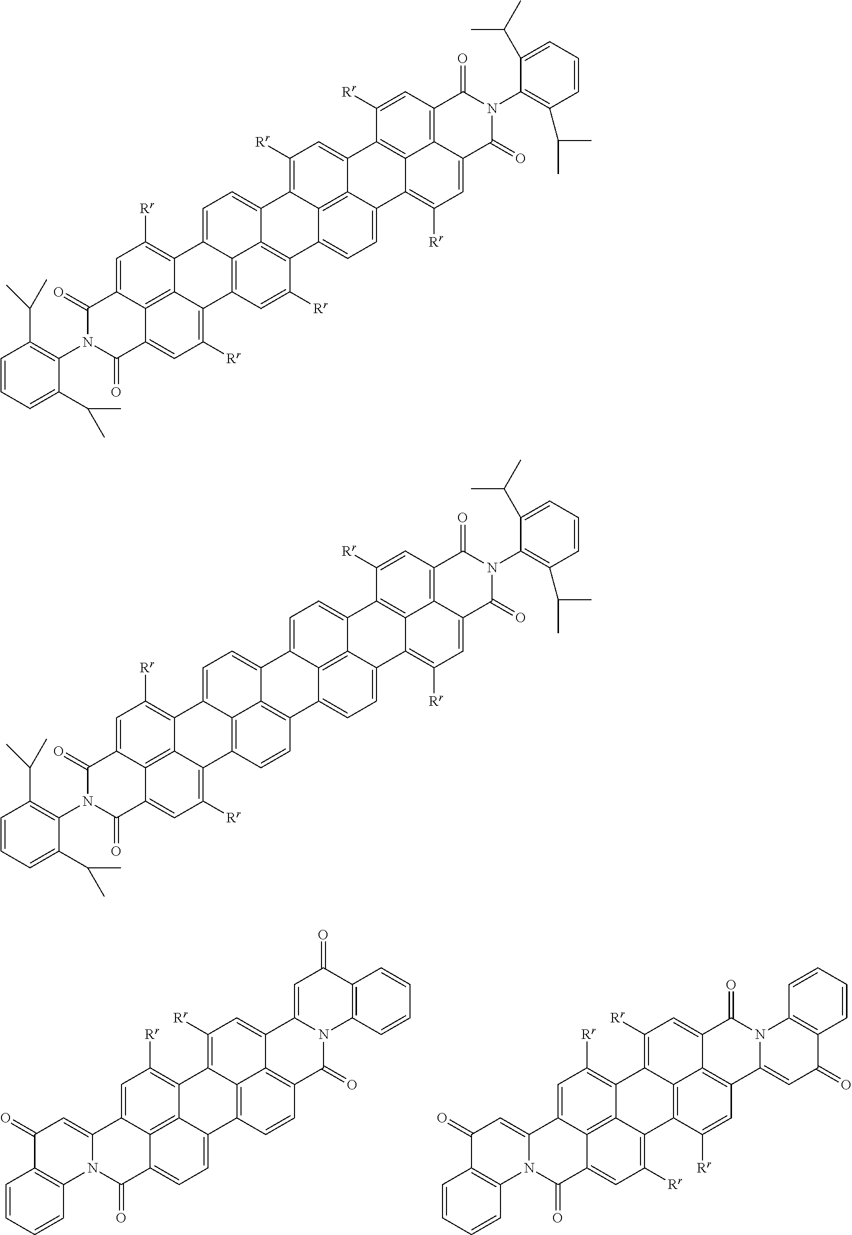

with RI being

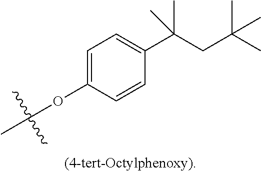 [SMILES: *Oc1ccc(C(C)(C)CC(C)(C)C)cc1]

Thus, preferably, the rylene fluorescent colorant according to the invention is selected from the group consisting of compound 1 of Table 1, Compound 2 of Table 1, Compound 3 of Table 1, and compound 4 of Table 1.

More preferably the rylene fluorescent colorant, even more preferably the fluorescent colorant, is

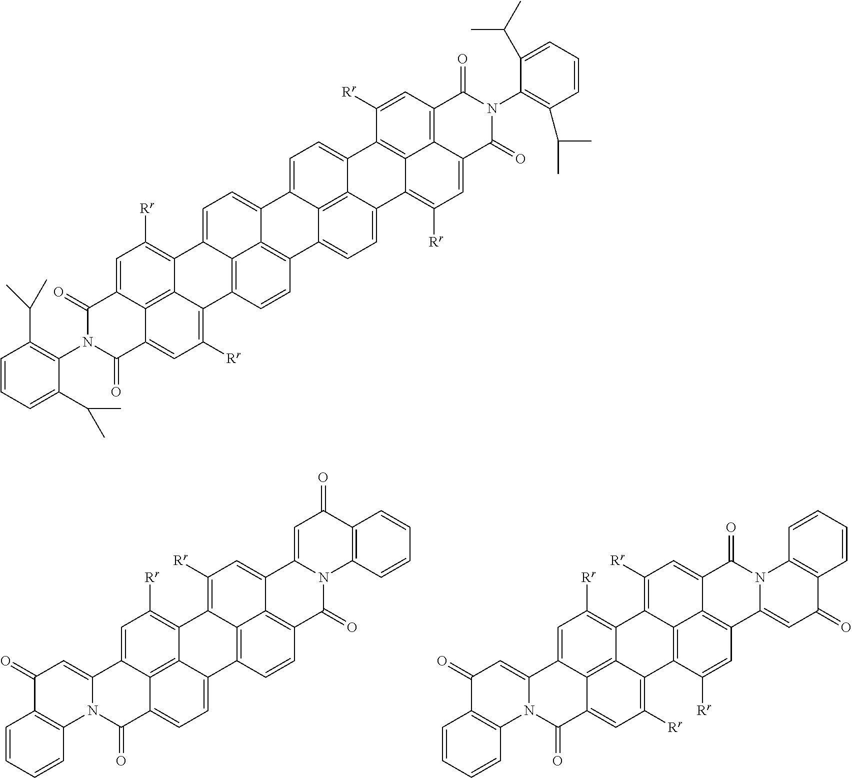

with R^{r} being

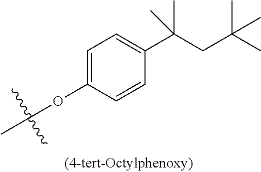 [SMILES: *Oc1ccc(C(C)(C)CC(C)(C)C)cc1]

wherein

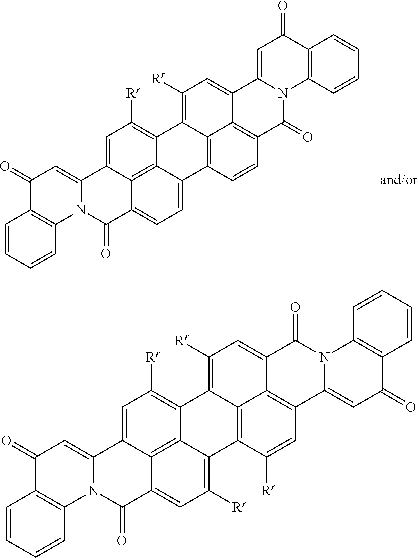

with R^{r} being

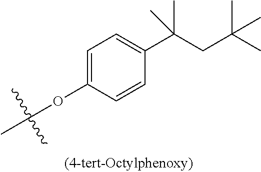 [SMILES: *Oc1ccc(C(C)(C)CC(C)(C)C)cc1]

(2,13-Bis[2,6-bis(1-methylethyl)phenyl]-5,10,16,21-tetrakis[4-(1,1,3,3-tetramethylbutyl)phenoxy]anthra[9″,1″,2″:6,5,10;10″,5″,6″:6′,5′,10′]dianthra[2,1,9-def:2′,1″,9′-d′e′f′]diisoquinoline-1,3,12,14(2H,13H)-tetrone) is particularly preferred.

According to an alternative preferred embodiment, the rylene fluorescent colorant, even more preferably the fluorescent colorant, is selected from the group consisting of compound 15 of Table 1, compound 16 of Table 1 and compound 17 of Table 1.

Thus, preferred rylene colorants according to the invention are compound 1 of Table 1, compound 2 of Table 1, compound 3 of Table 1, compound 4 of Table 1, compound 15 of Table 1, compound 16 of Table 1 and compound 17 of Table 1. More preferably, as already outlined above, the rylene fluorescent colorant according to the invention is however selected from the group consisting of compound 1 of Table 1, Compound 2 of Table 1, Compound 3 of Table 1, and compound 4 of Table 1, most preferred is compound 4.

The preparation of the rylene colorants described above as well as further suitable rylene colorants and are known to the skilled person. Such preparations are, for example, described in EP 1373272 B1, US2006/0075585, WO2016/083914 and WO 2007/006717, which respective contents is herewith incorporated by reference. 2,13-Bis[2,6-bis(1-methylethyl)phenyl]-5,10,16,21-tetrakis[4-(1,1,3,3-tetramethylbutyl)-phenoxy]anthra[9″,1″,2″:6,5,10;10″,5″,6″:6′,5′,10′]dianthra[2,1,9-def:2′,1′,9′-d′e′f′]diisoquinoline-1,3,12,14(2H,13H)-tetrone) (see Table 1, Compound 4) may e.g. be prepared according to example 4 of WO2016/083914, which contents is herewith incorporated by reference, and 2,11-Bis[2,6-bis(1-methylethyl)phenyl]-5,8,14,17-tetra[2,6-bis(1-methylethyl)phenoxy] benzo[13,14]pentapheno[3,4,5-def:10,9,8-d′e′f′]diisoquinoline-1,3,10,12(2H,11H)-tetrone (see Table 1, Compound 3), may e.g. be prepared according to example 2 of WO2007/006717, which contents is herewith incorporated by reference.

### Naphthalimide Colorants

The term naphthalimide colorant as used herein refers to colorants comprising the naphthalimide core structure

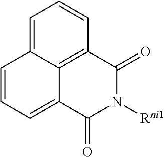

wherein Rⁿⁱ¹ is selected from the group consisting of alkyl, heteroalkyl, aryl, heteroaryl, cycloalkyl and cycloheteroalkyl.

Preferably, the naphthalimide colorant according to the invention has a structure according to the following formula,

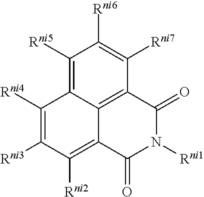

wherein Rⁿⁱ², Rⁿⁱ³, Rⁿⁱ⁴, Rⁿⁱ⁵, Rⁿⁱ⁶ and Rⁿⁱ⁷, are independently of each other, selected from the group consisting of H, alkyl, aryl, heteroalkyl, heteroaryl, alkoxy, cycloalkyl, heterocycloalkyl, alkylamin (Alkyl-NH—), arylamine (Aryl-NH—), alkylarylamin (Aryl-Alkyl-NH—), heteroarylamine (Heteroaryl-NH—) and heteroalkylarylamin (Heteroaryl-Alkyl-NH—), and wherein preferably at least one of Rⁿⁱ², Rⁿⁱ³ Rⁿⁱ⁴ Rⁿⁱ⁵, Rⁿⁱ⁶ and Rⁿⁱ⁷ is selected from the group alkylamin (Alkyl-NH—), arylamine (Aryl-NH—), alkylarylamin (Aryl-Alkyl-NH—), heteroarylamine (Heteroaryl-NH—), heteroalkylarylamin and (Heteroaryl-Alkyl-NH-).

Such naphthalimide colorants are e.g. described in FIBRES & TEXTILES in Eastern Europe 2009, Vol. 17, No. 2 (73) pp. 91-95, the contents of which is hereby incorporated by reference. Further suitable naphthalimide colorants and their preparations are known to the skilled person.

### Phthalocyanine Colorants

The term phthalocyanine colorant as used herein refers to metal free as well as to metal containing phthalocyanines, thus to colorants comprising one of the following structures, this structure preferably being suitably substituted.

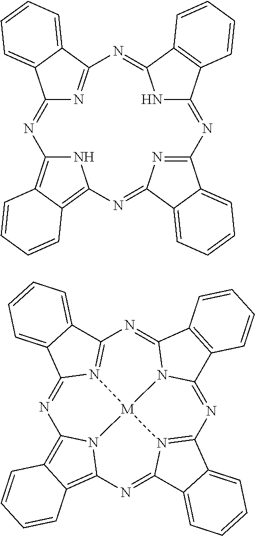

wherein M is metal or metallic component selected from the group consisting of M¹, M²(R^{p1}), M³(R^{p2})(R^{P3}) and M⁴(═R^{p4}), wherein M¹ is selected from the group consisting of Zn, Fe, Co, Ni, Pd, Pt and Mn, M² is selected from the group consisting of Al, In, La, and lanthanoids, M³ is selected from the group consisting of Ge, Si, Ti, and V, and M⁴ is Ti or V, wherein R^{p1} is selected from the group consisting of halogen, OH, alkyl, —O-alkyl, —O-aryl, —S-alkyl, alkyl, —OSi(alkyl)₃, —O-alkoxy, such as preferably —O-(alkyl-O)₁₋₅-alkyl², and —O—B^{p1}—O—L, wherein B^{p1} is C₁-C₁₂alkylene, C₁-C₁₂alkylene which is interrupted by one or more oxygen atoms or C₁-C₁₂alkylene which is substituted by at least one OH group, and L is a further phthalocyanine colorant group, and wherein R^{p2} and R^{p3} are, independent of each other, selected from the group consisting of halogen, OH, —O-alkyl, —O-aryl, —O-alkoxy, such as preferably —O-(alkyl-O)₁₋₅-alkyl², and —M⁵(R^{p5})(R^{p6})(R^{p7}), wherein R^{p5}, R^{p6} and R^{p7}, are independently of each other, selected from the group consisting of alkyl, alkenyl, alkenyl, cycloalkyl, aryl, arlyalkyl, trialkylsiloxy, —CO₂H, —SO₃H, —O-(alkyl-O)₁₋₅-alkyl²and trialkylammonium substituted alkyl, and wherein M⁵ is selected from the group consisting of Ge, Si, Ti, and V, and wherein R^{p4} is O or S, preferably O, and wherein M⁵ and M³ are preferably the same.

In case, M is M²(R^{p1}) and R^{p1} is —O—B^{p1}—O—L, the colorant preferably has the structure

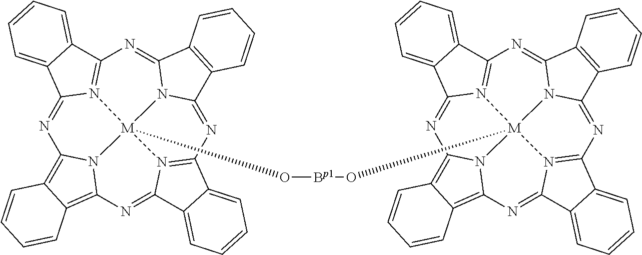

wherein, the aromatic rings may be suitably substituted.

In case the phthalocyanine is a metal containing phthalocyanine, M is preferably Si(R^{p2})(R^{P3}) or Ge(R^{p2})(R^{P3}), more preferably M is Si(R^{p2})(R^{P3}) with R^{p1} being —O-alkyl or —O-alkoxy, more preferably —O-(alkyl-O)₁₋₅-alkyl² with alkyl² being preferably methyl or ethyl, more preferably with R^{p1} being —O—(CH₂CH₂O)₃—CH₃, and with R^{p2} and R^{p3} being, independent of each other, selected from the group consisting of halogen OH, —O-alkyl, —O-aryl, —O-alkoxy, such as preferably —O-(alkyl-O)₁₋₅-alkyl², and —M⁵(R^{p5})(R^{p6})(R^{p7}), wherein R^{p5}, R^{p6} and R^{p7}, are independently of each other, selected from the group consisting of alkyl, alkenyl, alkenyl, cycloalkyl, aryl, arlyalkyl, tri-alkylsiloxy, —CO2H, —SO3H, —O-(alkyl-O)₁₋₅-alkyl² and trialkylammonium substituted alkyl.

Preferably, the phthalocyanine colorant is a metal free colorant.

The phthalocyanine colorants described hereinabove and hereinunder as well as further suitable phthalocyanine colorants and their respective preparations are e.g. described in WO 2008/122531 as well as in Dyes and Pigments 99 (2013), 613-619, which respective contents is herewith incorporated by reference. Further, suitable preparation methods are described in Hairong Li, Ngan Nguyen, Frank R. Fronczek, M. Graça H. Vicente, Tetrahedron 65 (2009) 3357-3363.

As described above, the structures

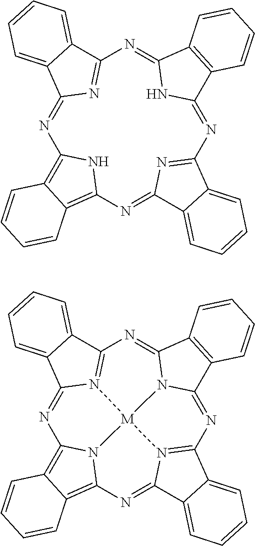

are preferably suitably substituted. Preferably, the phthalocyanine colorants according to the invention, have one of the following structures:

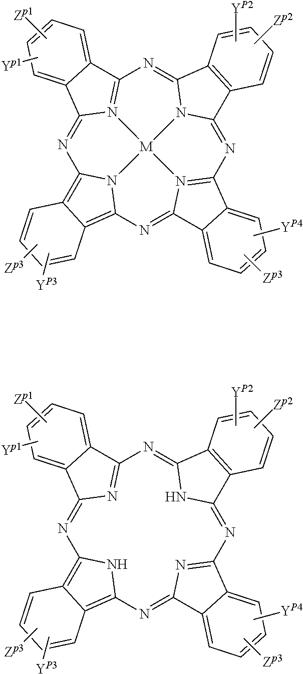

with Z^{P1}, Z^{P2}, Z^{P3} and Z^{P4} being, the same or being different, and being independently of each other selected from the group consisting of halogen, nitro, —OH, —CN, Amino, alkyl, alkenyl, alkinyl, cycloalkyl, heterocycloalkyl, aryl, heteroaryl, —O-aryl, —O-heteroaryl, —O-cycloalkyl, —O-heterocycloalkyl, —O-alkyl, —S-alkyl, —S-aryl, —S-heteroaryl, —S-cycloalkyl, and —S-heterocycloalkyl, and with Y^{P1}, Y^{P2}, Y^{P3} and Y^{P4} being, the same or being different, and being independently of each other selected from the group consisting of H, halogen, nitro, —OH, —CN, Amino, alkyl, alkenyl, alkinyl, cycloalkyl, heterocycloalkyl, aryl, heteroaryl, —O-aryl, —O-heteroaryl, —O-cycloalkyl, —O-heterocycloalkyl, —O-alkyl, —S-alkyl, —S-aryl, —S-heteroaryl, —S-cycloalkyl and —S-heterocycloalkyl.

Preferably, the phthalocyanine colorants according to the invention, have one of the following structures:

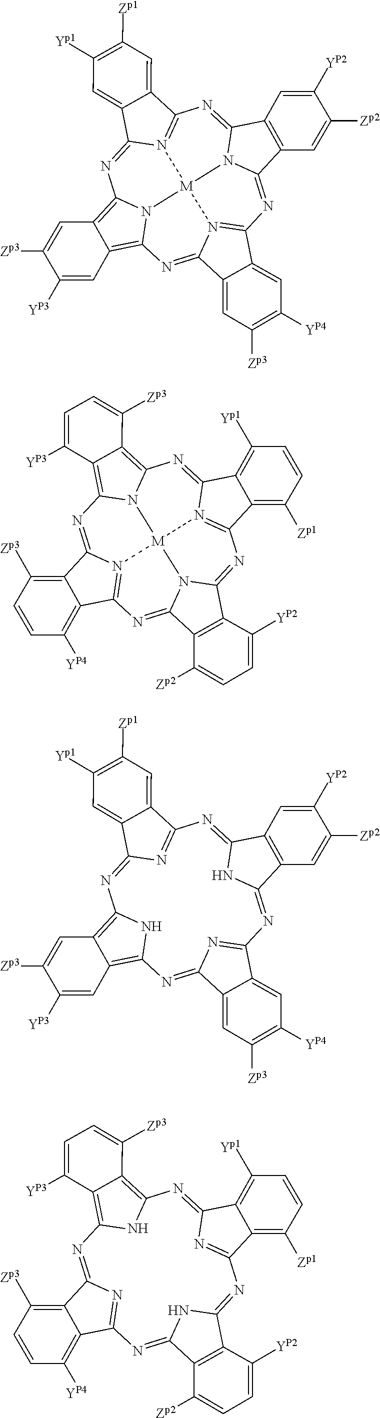

more preferably, one of the following structures

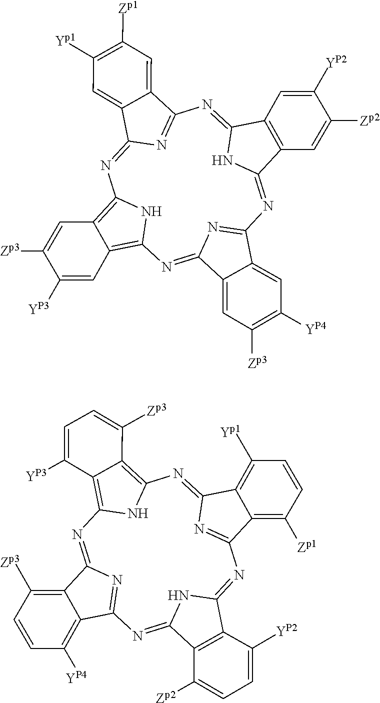

and in particular, the following structure:

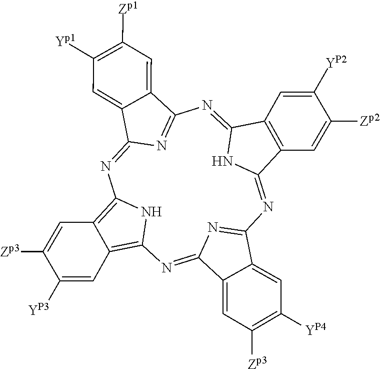

Preferably, Z^{P1}, Z^{P2}, Z^{P3} and Z^{P4}, are independently of each other, selected from the group consisting of —O-aryl, —O-heteroaryl, —S-aryl and —S-heteroaryl, more preferably, Z^{P1}, Z^{P2}, Z^{P3} and Z^{P4}, are independently of each other, selected from the group consisting of the following residues

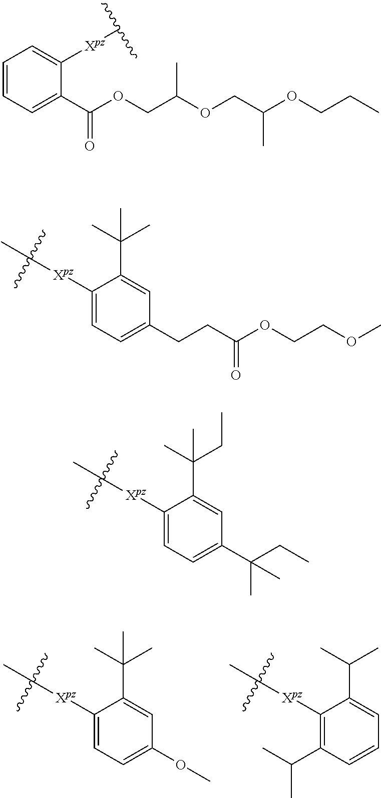

with X^{pz} being O or S, preferably O.

Preferably, Z^{P1}, Z^{P2}, Z^{P3} and Z^{P4} are all the same.

Preferably, Y^{P1}, Y^{P2}, Y^{P3} and Y^{P4}, are independently of each other, selected from the group consisting of H, —O-aryl, —O-heteroaryl, —S-aryl and —S-heteroaryl, more preferably, Y^{P1}, Y^{P2}, Y^{P3} and Y^{P4}, are independently of each other, selected from the group consisting of

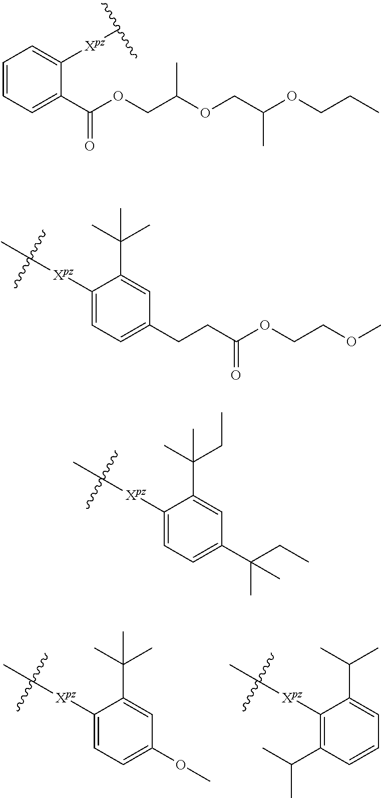

with Y^{pz} being O or S, preferably O.

More preferably, Y^{P1}, Y^{P2}, Y^{P3} and Y^{P4}, are independently of each other, H or

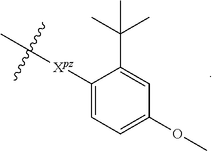

Preferably, Y^{P1}, Y^{P2}, Y^{P3} and Y^{P4} are all the same.

Most preferably Y^{P1}, Y^{P2}, Y^{P3} and YP4 are H.

In particular, the phthalocyanine colorant, more preferably the fluorescent colorant, is selected from the group consisting of compound 5 of Table 1, compound 6 of Table 1, compound 7 of Table 1, compound 8 of Table 1, compound 9 of Table 1, compound 10 of Table 1 and compound 14 of Table 1, more preferably the phthalocyanine colorant is the compound 14 of Table 1 or compound 10 of Table 1, most preferably, the phthalocyanine colorant is the compound 14 of Table 1.

Suitable preparation methods for the preparation of such compounds are known to the skilled person and e.g. described in Hairong Li, Ngan Nguyen, Frank R. Fronczek, M. Graça H. Vicente, Tetrahedron 65 (2009) 3357-3363.

### Naphthalocyanine Colorants

The term naphthalocyanine colorant as used herein refers to metal free as well as to metal containing naphthalocyanines, thus to colorants comprising one of the following core structures, wherein this structure may be suitably substituted.

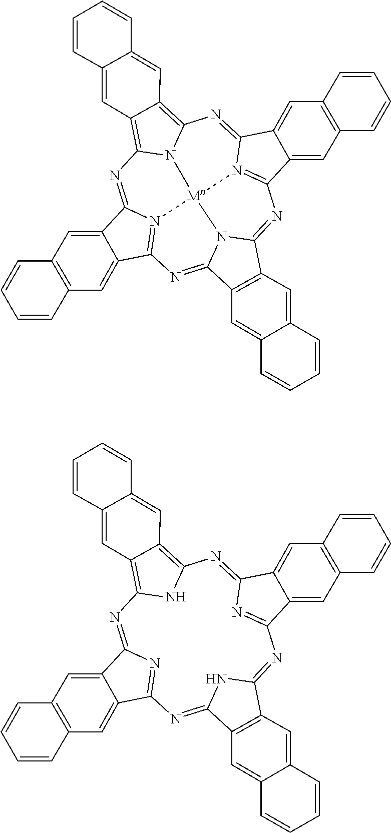

wherein Mn is metal or metallic component selected from the group consisting of Mⁿ¹, Mⁿ²(R^{p1}), Mⁿ³(Rⁿ²)(Rⁿ³) and Mⁿ⁴(═Rⁿ⁴) wherein Mⁿ¹ is selected from the group consisting of Zn, Fe, Co, Ni, Pd, Pt and Mn, Mⁿ² is selected from the group consisting of Al, In, La, and lanthanoids, Mⁿ³ is selected from the group consisting of Ge, Si, Ti, and V, and Mⁿ⁴ is Ti or V, wherein Rⁿ¹ is selected from the group consisting of halogen, OH, alkyl, —O-alkyl, —O-aryl, —S-alkyl, alkyl, —OSi(alkyl)₃—O-alkoxy, such as preferably —O-(alkyl-O)₁₋₅-alkyl², and —O-Bⁿ¹—O—L, wherein Bn¹ is C₁-C₁₂alkylene, C₁-C₁₂alkylene which is interrupted by one or more oxygen atoms or C₁-C₁₂alkylene which is substituted by at least one OH group, and L is a further naphthalocyanine colorant group, and wherein Rⁿ² and Rⁿ³ are, independent of each other, selected from the group consisting of halogen, OH, —O-alkyl, —O-aryl, —O-alkoxy, such as preferably —O-(alkyl-O)₁₋₅-alkyl², and Mⁿ⁵(Rⁿ⁵)(Rⁿ⁶)(Rⁿ⁷), wherein Rⁿ⁵, Rⁿ⁶ and Rⁿ⁷, are independently of each other, selected from the group consisting of alkyl, alkenyl, alkenyl, cycloalkyl, aryl, arlyalkyl, trialkylsiloxy, —CO₂H, —SO₃H, —O-(alkyl-O)₁₋₅-alkyl² and trialkylammonium substituted alkyl, and wherein Mⁿ⁵ is selected from the group consisting of Ge, Si, Ti, and V, wherein R^{p4} is O or S, preferably O, and wherein Mⁿ⁵ and Mⁿ³ are preferably the same.

The naphthalocyanine colorants described hereinabove and hereinunder as well as further suitable naphthalocyanine colorants and there respective preparations are known to the skilled person.

As described above, the structures

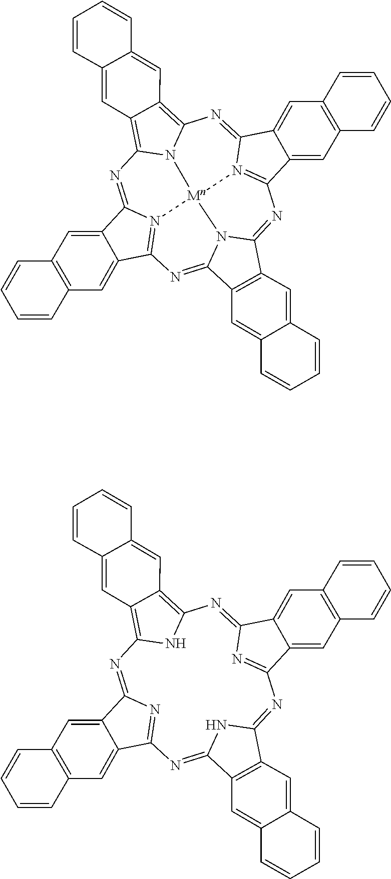

may be suitably substituted. The naphthalocyanine colorants according to the invention may thus have one of the following structures:

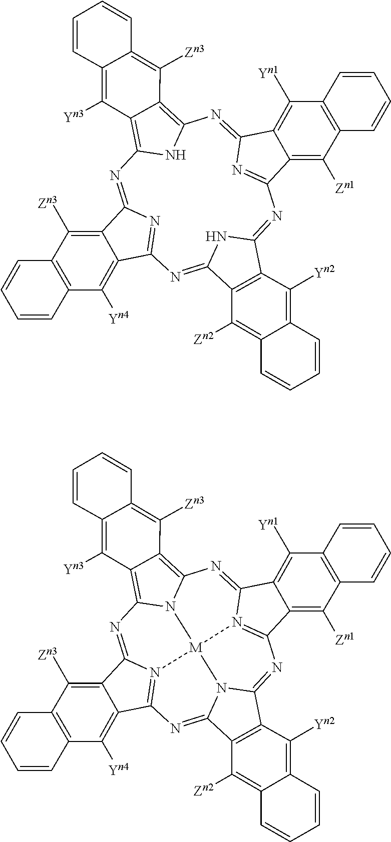

with Zⁿ¹, Zⁿ², Zⁿ³ and Zⁿ⁴ being, the same or being different, and being independently of each other selected from the group consisting of H, halogen, nitro, —OH, —CN, Amino, alkyl, alkenyl, alkinyl, cycloalkyl, heterocycloalkyl, aryl, heteroaryl, —O-aryl, —O-heteroaryl, —O-cycloalkyl, —O-heterocycloalkyl, —O-alkyl, —S-alkyl, —S-aryl, —S-heteroaryl, —S-cycloalkyl and —S-heterocycloalkyl, wherein Z^{P1}, Z^{P2}, Z^{P3} and Z^{P4} are preferably all the same. Most preferably, Zⁿ¹, Zⁿ², Zⁿ³ and Zⁿ⁴ are H.

Yⁿ¹, Yⁿ² Yⁿ³ and Yⁿ⁴ being, the same or being different, and being independently of each other selected from the group consisting of H, halogen, nitro, —OH, —CN, Amino, alkyl, alkenyl, alkinyl, cycloalkyl, heterocycloalkyl, aryl, heteroaryl, —O-aryl, —O-heteroaryl, —O-cycloalkyl, —O-heterocycloalkyl, —O-alkyl, —S-alkyl, —S-aryl, —S-heteroaryl, —S-cycloalkyl and —S-heterocycloalkyl. Preferably, Yⁿ¹, Yⁿ², Yⁿ³ and Yⁿ⁴ are all the same. Most preferably, Y^{P1}, Y^{P2}, Y^{P3} and Y^{P4}are H.

### Cyanine Colorants

The term cyanine colorant as used herein refers to colorants comprising a polymethine group, thus a comprising at least three methine groups (CH) bound together by alternating single and double bonds. Such cyanine colorants include, e.g., indocarbocyanine, oxacarbocyanine, thiacarbocyanine, merocyanine, or derivatives of any one of the aforementioned compounds. Preferably, the cyanine colorant according to the invention the structure (Ic) or (IIc),

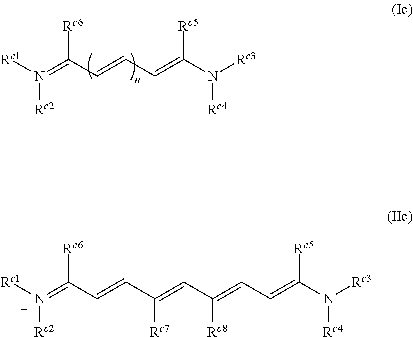

wherein R^{c2} and R^{c4}, are independently of each other selected from the group consisting of alkyl, heteroalkyl, cycloalkyl, heterocycloalkyl, aryl and heteroaryl, and wherein R^{c1} is selected from the group consisting of alkyl, heteroalkyl, cycloalkyl, heterocycloalkyl, aryl and heteroaryl or forms together with R^{c6} an, optionally substituted, cyclic ring, such as cycloalkyl, heterocy-cloalkyl, aryl or heteroaryl ring, and wherein R^{c3} is selected from the group consisting of alkyl, heteroalkyl, cycloalkyl, heterocycloalkyl, aryl and heteroaryl or forms together with R^{c4} an, optionally substituted, cyclic ring, such as a cycloalkyl, heterocycloalkyl, aryl or heteroaryl ring, and wherein R^{c6} is selected from the group consisting of H, alkyl, heteroalkyl, cycloalkyl, heterocycloalkyl, aryl and heteroaryl or forms together with R^{c1} an, optionally substituted, cyclic ring, such as a cycloalkyl, heterocycloalkyl, aryl or heteroaryl ring, and wherein R^{c5} is selected from the group consisting of H, alkyl, heteroalkyl, cycloalkyl, heterocycloalkyl, aryl and heteroaryl or forms together with R^{c5} an, optionally substituted, cyclic ring, such as an cycloalkyl, heterocycloalkyl, aryl or heteroaryl ring and wherein R^{c2} and R^{c4}, are, independently of each other, selected from the group consisting of H, alkyl and cycloalkyl or form a cyclic ring with one another, and wherein n is an integer in the range of from 1 to 10, preferably 1 to 10, more preferably 1 to 5, most preferably n is 2.

Such colorants are known in the art, and e.g. commercially available under the trademark names, Cy3, Cy5, Cy7, Cy3.5, Cy5.5, Cy7.5, S 0315 (3-Butyl-2-[5-(3-butyl-1,3-dihydro-1,1-dimethyl-2H-benzo[e]indol-2-ylidene)-penta-1,3-dienyl]-1,1-dimethyl-1H-benzo[e]indolium perchlorate) and S 0944 (1,3,3-Trimethyl-2-[5-(1,3,3-trimethyl-1,3-dihydro-indol-2-ylidene)-penta-1,3-dienyl]-3Hindolium chloride). S 0315 and S 0944 are e.g. commercially available from FEW Chemicals GmbH Deutschland.

Further suitable compounds and their preparation are described, e.g. in Ullmann's Encyclopedia of Industrial Chemistry, Vol. 23 (2012), Chapter “Methine Dyes and Pigments”.

More preferably, the cyanine colorant according to the invention has the structure (Ic), wherein R^{c2} and R^{c4}, are, independently of each other an, optionally substituted, alkyl group, wherein the alkyl group may be different or the same, preferably C1-C10alkyl, more preferably selected from the group consisting of, optionally substituted, methyl, ethyl, propyl, butyl, pentyl and hexyl, more preferably wherein the alkyl group is methyl, butyl or pentyl, wherein the methyl, butyl or pentyl group may be suitably substituted such as with a Carboxy group —COOH, and wherein R^{c1} forms together with R^{c6} an, optionally substituted, cyclic ring, and wherein R^{c3} r forms together with R^{c4} an, optionally substituted, cyclic ring, and wherein n is preferably an integer from 1 to 10, more preferably 1 to 5, most preferably n is 2.

More preferably, the cyanine colorant according to the invention has a structure according formula (Icₐ) or (IIc_{b}), more preferably according to (Icₐ).

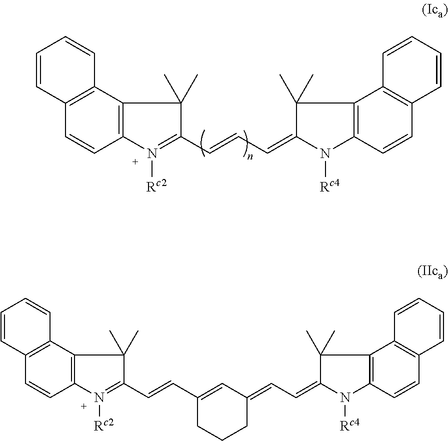

wherein R^{c2} and R^{c4}, are, independently of each other an, optionally substituted, alkyl group, wherein the alkyl group may be different or the same, preferably C1-C10alkyl, more preferably selected from the group consisting of, optionally substituted, methyl, ethyl, propyl, butyl, pentyl and hexyl, more preferably wherein the alkyl group is methyl, butyl or pentyl, wherein the methyl, butyl or pentyl group may be suitably substituted such as with a Carboxy group —COOH, more preferably, wherein R^{c4} is methyl or butyl, and wherein R^{c2} is butyl or —O5H10—COOH, more preferably wherein both, R^{c2} and R^{c4} are butyl, with n being preferably of from 1 to 5, more preferably 2.

Most preferably the cyanine colorant is S 0315 (Compound 12 of Table 1; 3-Butyl-2-[5-(3-butyl-1,3-dihydro-1,1-dimethyl-2H-benzo[e]indol-2-ylidene)-penta-1,3-dienyl]-1,1-dimethyl-1H-benzo[e]indolium perchlorate) or S0944 (Compound 13 of Table 1, 1,3,3-Trimethyl-2-[5-(1,3,3-trimethyl-1,3-dihydro-indol-2-ylidene)-penta-1,3-dienyl]-3H-indolium chloride), more preferably S 0315.

### Xanthene Colorants:

The term xanthene colorant as used herein refers to derivatives of xanthene, thus colorants comprising the following core structure, which is suitably substituted.

Such colorants include, but are not limited to rhodamine colorants, such as Pyrano[3,2-g:5,6-g′] diquinolin-13-ium, 6-[2-(butoxycarbonyl)phenyl]-1,11-diethyl-1,2,10,11-tetrahydro-2,2,4,8,10,10-hexamethyl-, perchlorate, rhodamine B, Rhodamine 6G, rhodamine 123, eosin, texas red, sulfon-rhodamine colorants derivatives of any component thereof.

Further, suitable compounds are described in WO2003098617 A2 as well as in Appl. Mater. Interfaces 2016, 8, 22953-62, which respective contents is hereby incorporates by reference.

Such compounds are commercially available or their synthesis is well known to the skilled person. Suitable methods to prepare such compounds are e.g. described in E. Noelting, K. Dziewonski,: Berichte der deutschen chemischen Gesellschaft. Band 38, 1905, S. 3516-3527 as well as in T. Nedelcev, D. Racko, I. Krupa, Dyes and Pigments. Band 76, 2008, S. 550-556.

Preferably, the xanthene colorant according to the invention is Pyrano[3,2-g:5,6-g′]diquinolin-13-ium, 6-[2-(butoxycarbonyl)phenyl]-1,11-diethyl-1,2,10,11-tetrahydro-2,2,4,8,10,10-hexamethyl-, perchlorate having the structure (compound 11 of Table 1):

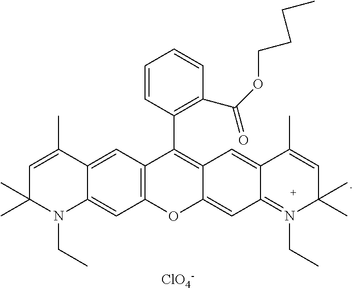

### Oxazine Colorants

The term oxazine colorant refers to any colorant comprising an oxazine ring. Such colorants include, but are not limited to, preferably one or more of nile red (7-Diethylamino-3,4-benzophenoxazin-2-on), nile blue [9-(diethylamino)benzo[a]phenoxazin-5-ylidene]azanium;sulfate), oxazine 170 (ethyl-[9-(ethylamino)-10-methylbenzo[a]phenoxazin-5-ylidene]azanium;perchlorate), or a derivative of any component thereof. Such compounds are commercially available or their synthesis is well known to the skilled person.

### Boron-Dipyrromethene Colorants and Aza-Boron-Dipyrromethene Colorants

The term Boron-dipyrromethene colorants refers to colorants comprising a dipyrromethene complexed with a disubstituted boron atom, such as BF2 unit. Preferably, the colorant comprises a BODIPY core, i.e. a 4,4-difluoro-4-bora-3a,4a-diaza-s-indacene core structure, this structure preferably being suitably substituted.

The term Aza-boron-dipyrromethene colorants refers to colorants comprising a difluoro-bora-1,3,5,7-tetraphenyl-aza-dipyrromethene core structure, this structure preferably being suitably substituted.

Various Boron-dipyrromethene colorants and Aza-boron-dipyrromethene colorants are known to the skilled person, and are e.g. described in Loudet et al., Chem. Rev'. 2007, 107, 4891-4932, which contents is herewith incorporated by reference.

By way of example the following suitable Boron-dipyrromethene colorants and Aza-boron-dipyrromethene colorants are mentioned

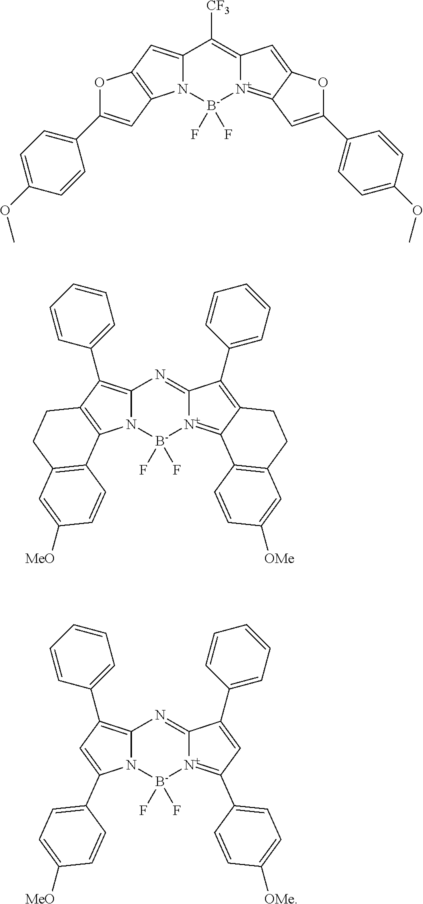 [SMILES: COc1ccc(-c2cc3c(o2)=CC2=C(C(F)(F)F)c4cc5oc(-c6ccc(OC)cc6)cc5n4[B-](F)(F)[N+]=32)cc1 ; COc1ccc2c(c1)CCC1=C(c3ccccc3)C3=Nc4c(-c5ccccc5)c5c(n4[B-](F)(F)[N+]3=C12)-c1ccc(OC)cc1CC5 ; COc1ccc(C2=[N+]3C(=Nc4c(-c5ccccc5)cc(-c5ccc(OC)cc5)n4[B-]3(F)F)C(c3ccccc3)=C2)cc1]

Such compounds and there preparation are e.g. described in WO 2008/145172 A1 and W. Zhao et al, Angew. Chem. Int. Ed. 2005, 44, 1677-79, which contents is hereby incorporated by reference.

### Diketopyrrolopyrrol Colorants

The term diketopyrrolopyrrol colorants (DPP colorants) according to the invention refers to colorants based on the bicyclic heterocyclic compound diketopyrrolopyrrole, i.e. on 2,5-Dihydropyrrolo[3,4-c]pyrrol-1,4-dione, or on any derivate thereof. Such colorants and ways to prepare them are known to the skilled person.

It is to be understood that the term diketopyrrolopyrrol colorants also includes colorants based on heterocyclic derivatives of diketopyrrolopyrrole, such as, e.g., the following colorants which are mentioned by way of example:

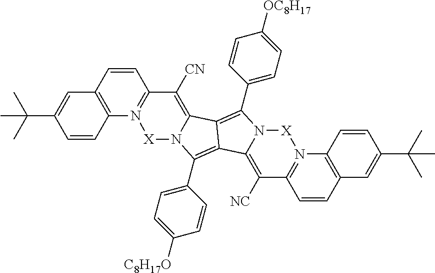

wherein X is selected from the group consisting of H, BF2 and BPH2. Such colorants are described e.g. in E Daltrozzo, A. Zumbusch et al, Angew. Chem. Int. Ed. 2007, 46, 3750-3753, which contents is hereby incorporated by reference.

### Further Suitable Colorants

As mentioned above, besides the colorants discussed above in detail also stilbenes, benzoxazoles, coumarins and benzopyrans, squaraines, oxadiols, anthrachinones, acridines, arylmethanes, violanthrons and isoviolanthrons, and oxazines should be mentioned as preferred colorants according to the invention.

As preferred stilbenes, any stilbene colorant, which in a wavelength range of 400 nm to 900 nm, has an absorption maximum which occurs in the wavelength range of 500 nm to 850 nm, may be used. In this context, divinyl stilbenes, triazine stilbines, stilbene triazoles and stilbene benzoxazoles are mentioned by way of example.

Preferred benzoxazoles, which in a wavelength range of 400 nm to 900 nm, have an absorption maximum which occurs in the wavelength range of 500 nm to 850 nm, are, e.g. naphthalene benzoxazoles, bis-benzoxazoles, benzoxazole thiophenes and the like. Preferred arylmethanes, are e.g. crystal violet ((4-(4,4′-Bis(dimethylaminophenyl) benzhydryli-den)cyclohexa-2,5-dien-1-yliden)dimethylammoniumchloride), malachite green (4-{[4-(dimethylamino)phenyl](phenyl)methylidene}-N,N-dimethylcyclohexa-2,5-dien-1-iminium chloride), or derivatives of the aforementioned colorants.

As merocyanines, coumarins and benzopyrans colorant, any merocyanine, coumarin or benzopyran, in particular any merocyanine, coumarin or benzopyran which in a wavelength range of 400 nm to 900 nm, has an absorption maximum which occurs in the wavelength range of 500 nm to 850 nm, may be used. By way of example, the following preferred colorants are mentioned:

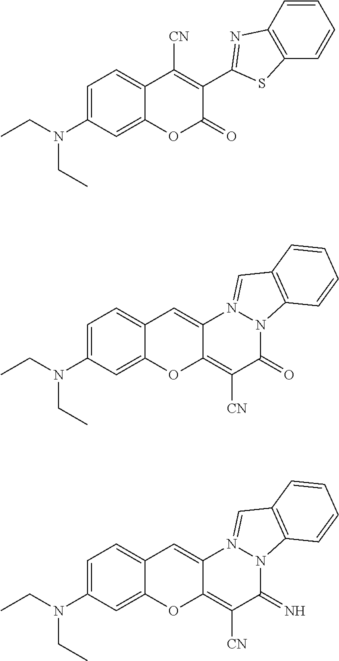

As squaraine colorant, any squaraine, preferably any squaraine which in a wavelength range of 400 nm to 900 nm, has an absorption maximum which occurs in the wavelength range of 500 nm to 850 nm, may be used. This includes squaraine derivatives or ring-substituted squaraines, such as, e.g.,

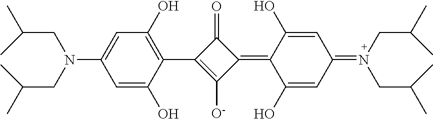

Such squaraine colorants and their preparation is known to the silled person and e.g. described in Angew. Chem. Int. Ed. 2012, 51, 2020-2068, which contents is hereby incorporated by reference.

As suitable anthrachinone colorant, by way of example, Disperse Blue 60 (4,11-diamino-2-(3-methoxypropyl)naphtho[2,3-f]isoindole-1,3,5,10-tetrone)

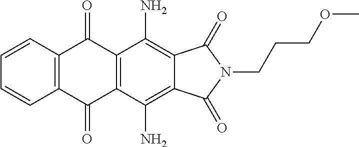 [SMILES: COCCCn1c(=O)c2c(N)c3c(=O)c4ccccc4c(=O)c3c(N)c2c1=O]

may be mentioned. However, other anthrachinone colorants may be conceivable. As acridines, acridine orange (N,N,N′,N′-Tetramethylacridine-3,6-diamine, CAS 65-61-2), neutral red (3-Amino-7-dimethylamino-2-methylphenazine hydrochloride, CAS 553-24-2) and Safranin O (3,7-Diamino-2,8-dimethyl-5-phenyl-phenaziniumchlorid, CAS 477-73-6) are mentioned, by way of example. However, other acridine colorant may be conceivable.

As suitable oxazine colorant, by way of example, Darrow Red (CAS 15391-59-0), having the structure

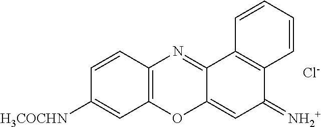

is mentioned. However, other oxazine colorants, may be conceivable.

Besides the above mentioned, colorants, violanthron and isoviolanthron colorants, are also particularly preferred. These colorants comprise one of the following core structures or a mixture thereof, the core structures being suitably substituted.

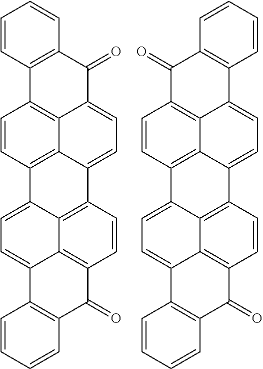

As preferred violanthron colorant, a colorant having the following structure is mentioned:

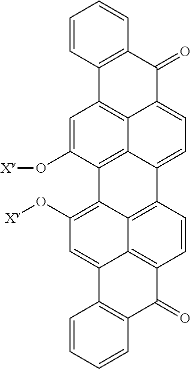

with X^{v} being

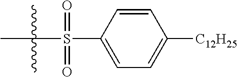

As preferred isoviolanthron colorant, a colorant having the following structure is mentioned:

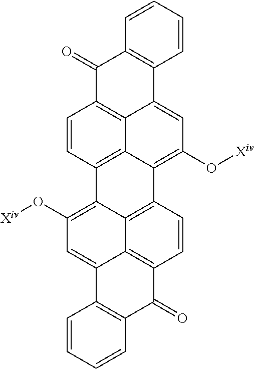

with Xi^{v} being

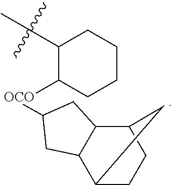

Such colorants, are e.g. described in Dyes and Pigments 11 (1989) 303-317 (in particular on page 309-311), which contents is hereby incorporated by reference. It is, however, to be understood, that, other violanthron or isoviolanthron colorant, in particular such which in a wavelength range of 400 nm to 900 nm, have an absorption maximum which occurs in the wavelength range of 500 nm to 850 nm, may be conceivable.

As can be derived from this assembly, a large number of different fluorescent dyes may be available for being used in the transversal optical sensor according to the present invention. Within this regard, the fluorescent material as used for the fluorescent waveguiding sheet may be selected according to considerations with respect to costs and availability of the material but also with respect to the performance of the material with regard to material properties, such as a fluorescence gain with a specific wavelength range. In addition, when using organic materials for both the PSD device and the FiP sensor, materials can be selected for the respective components of the mentioned sensors and/or devices which may be adjusted with respect to each other. These considerations and/or properties may, in particular, allow producing a detector being suitable for realizing a 3D-sensing concept with adjustable sensing performance under reasonable productions costs.

Further optional details of the detector referred to the photosensitive elements. The same options, as outlined above, generally also may refer to the optional at least one reference photosensitive element. Thus, as an example, the photosensitive elements may comprise at least one photodiode, preferably at least one inorganic photodiode. The photosensitive elements may each comprise a dot-shaped photosensitive element which may be located at a side or a corner of an edge of the waveguiding sheet. Alternatively or in addition, the photosensitive elements may, preferably, comprise at least one elongated photosensitive element extending along at least one segment of an edge of the waveguiding sheet. This embodiment may be used for allowing a more accurate determination of the position of the light spot at particularly low illumination power.

Irrespective of the specific embodiment of the photosensitive elements used for the transversal optical sensor according to the present invention, the photosensitive elements which are located only at the edges of the transversal sensitive area may, therefore, be embodied as small and, thus, fast electronic elements which only require a short time to provide the desired transversal sensor signals compared to commonly available PSD devices which, usually, comprise arrays of pixelated sensitive areas and/or resistive interlayers. As a synergetic effect, this advantage of the transversal optical sensor may be used to have more time available for the transversal optical sensor and the corresponding partition of the evaluation device used for determining the longitudinal position. Consequently, in contrast to the known prior art, the combination of the PSD device as used here with one or more of the mentioned FiP sensors allows determining the 3D position of the object or a part thereof in a faster manner and/or with increased accuracy.

As outlined above, the fluorescent waveguiding sheet specifically may be a rectangular fluorescent waveguiding sheet, preferably a square waveguiding sheet. In the setup, as an example, the photosensitive elements may be located at each of the four edges, e.g. at each of the four rim portions and/or corners, of the waveguiding sheet. Other embodiments are feasible.

As outlined above, the detector may further comprise one or more additional elements such as one or more additional optical elements. Further, the detector may fully or partially be integrated into at least one housing. The detector specifically may comprise at least one transfer device, the transfer device being adapted to guide the light beam onto the at least two optical sensors. The transfer device may comprise one or more of: at least one lens, preferably at least one focus-tunable lens; at least one beam deflection element, preferably at least one mirror; at least one beam splitting element, preferably at least one of a beam splitting cube or a beam splitting mirror; at least one multi-lens system.

As outlined above, the detector may further comprise one or more optical elements, such as one or more lenses and/or one or more refractive elements, one or more mirrors, one or more diaphragms or the like. These optical elements which are adapted to modify the light beam, such as by modifying one or more of a beam parameter of the light beam, a width of the light beam or a direction of the light beam, above and in the following, are also referred to as a “transfer element”. Thus, the detector may further comprise at least one transfer device, wherein the transfer device may be adapted to guide the light beam onto the at least two optical sensors, such as by one or more of deflecting, focusing or defocusing the light beam. Specifically, the transfer device may comprise one or more lenses and/or one or more curved mirrors and/or one or more other types of refractive elements.

In case the detector comprises one or more transfer devices, the at least one transfer device specifically may have at least one focal length. Therein, the focal length may be fixed or variable. In the latter case, specifically, one or more focused tunable lenses may be comprised in the at least one transfer device. In this context, as an example, reference may be made to European patent application number 14 196 944.4, filed on December 9, 2014, the full content of which is herewith included by reference. The focus-tunable lenses disclosed therein may also be used in the at least one optional transfer device of the detector according to the present invention.

As used herein, the term “focus-tunable lens” generally refers to an optical element being adapted to modify a focal position of a light beam passing the focus-tunable lens in a controlled fashion. The focus-tunable lens may be or may comprise one or more lens elements such as one or more lenses and/or one or more curved mirrors, with an adjustable or tunable focal length. The one or more lenses, as an example, may comprise one or more of a biconvex lens, a biconcave lens, a plano-convex lens, a plano-concave lens, a convex-concave lens, or a concave-convex lens. The one or more curved mirrors may be or may comprise one or more of a concave mirror, a convex mirror, or any other type of mirror having one or more curved reflective surfaces. Any arbitrary combination thereof is generally feasible, as the skilled person will recognize. Therein, a “focal position” generally refers to a position at which the light beam has the narrowest width. Still, the term “focal position” generally may refer to other beam parameters, such as a divergence, a Raleigh length or the like, as will be obvious to the person skilled in the art of optical design. Thus, as an example, the focus-tunable lens may be or may comprise at least one lens, the focal length of which may be changed or modified in a controlled fashion, such as by an external influence light, a control signal, a voltage or a current. The change in focal position may also be achieved by an optical element with switchable refractive index, which by itself may not be a focusing device, but which may change the focal point of a fixed focus lens when placed into the light beam. As further used in this context, the term “in a controlled fashion” generally refers to the fact that the modification takes place due to an influence which may be exerted onto the focus-tunable lens, such that the actual focal position of the light beam passing the focus-tunable lens and/or the focal length of the focus-tunable lens may be adjusted to one or more desired values by exerting an external influence on to the focus-tunable lens, such as by applying a control signal to the focus-tunable lens, such as one or more of a digital control signal, an analog control signal, a control voltage or a control current. Specifically, the focus-tunable lens may be or may comprise a lens element such as a lens or a curved mirror, the focal length of which may be adjusted by applying an appropriate control signal, such as an electrical control signal. Examples of focus-tunable lenses are known in the literature and are commercially available. As an example, reference may be made to the tunable lenses, preferably the electrically tunable lenses, as available by Optotune AG, CH-8953 Dietikon, Switzerland, which may be employed in the context of the present invention. Further, focus tunable lenses as commercially available from Varioptic, 69007 Lyon, France, may be used. For a review on focus-tunable lenses, specifically based on fluidic effects, reference may be made, e.g., to N. Nguyen: “Micro-optofluidic Lenses: A review”, Biomicrofluidics, 4, 031501 (2010) and/or to Uriel Levy, Romi Shamai: “Tunable optofluidic devices”, Microfluid Nanofluid, 4, 97 (2008). It shall be noted, however, that other principles of focus-tunable lenses may be used in addition or alternatively.

Various principles of focus-tunable lenses are known in the art and may be used within the present invention. Thus, firstly, the focus-tunable lens may comprise at least one transparent shapeable material, preferably a shapeable material which may change its shape and, thus, may change its optical properties and/or optical interfaces due to an external influence, such as a mechanical influence and/or an electrical influence. An actuator exerting the influence may specifically be part of the focus-tunable lens. Additionally or alternatively, the focus tunable lens may have one or more ports for providing at least one control signal to the focus tunable lens, such as one or more electrical ports. The shapeable material may specifically be selected from the group consisting of a transparent liquid and a transparent organic material, preferably a polymer, more preferably an electroactive polymer. Still, combinations are possible. Thus, as an example, the shapeable material may comprise two different types of liquids, such as a hydrophilic liquid and a lipophilic liquid. Other types of materials are feasible. The focus-tunable lens may further comprise at least one actuator for shaping at least one interface of the shapeable material. The actuator specifically may be selected from the group consisting of a liquid actuator for controlling an amount of liquid in a lens zone of the focus-tunable lens or an electrical actuator adapted for electrically changing the shape of the interface of the shapeable material. One embodiment of focus-tunable lenses are electrostatic focus-tunable lenses. Thus, the focus-tunable lens may comprise at least one liquid and at least two electrodes, wherein the shape of at least one interface of the liquid is changeable by applying one or both of a voltage or a current to the electrodes, preferably by electro-wetting. Additionally or alternatively, the focus tunable lens may be based on a use of one or more electroactive polymers, the shape of which may be changed by applying a voltage and/or an electric field.

A single focus-tunable lens or a plurality of focus-tunable lenses may be used. Thus, the focus-tunable lens may be or may comprise a single lens element or a plurality of single lens elements. Additionally or alternatively, a plurality of lens elements may be used which are interconnected, such as in one or more modules, each module having a plurality of focus-tunable lenses. Thus, as an example, the at least one focus-tunable lens may be or may comprise at least one lens array, such as a micro-lens array, such as disclosed in C. U. Murade et al., Optics Express, Vol. 20, No. 16, 18180-18187 (2012). Other embodiments are feasible, such as a single focus-tunable lens.

The at least one focus-tunable lens may be used in various ways. Thus, specifically, by using at least one focus tunable lens in the at least one optional transfer device, ambiguities in the determination of the z coordinate may be resolved. Thus, as explained e.g. in WO 2014/097181 A1, a beam waist or beam diameter of a light beam, specifically of a Gaussian ray, is symmetric before and after the focal point and, thus, an ambiguity exists in case the size of the light spot is determined in only one longitudinal position. Therefore, as proposed in WO 2014/097181 A1, the size of the light spot into different positions may be determined, which is also possible in the context of the present invention, in order to resolve the ambiguity and in order to determine the at least one z-coordinate of the object in a non-ambiguous fashion. For this purpose, as an example, two or more than two longitudinal optical sensors may be used, which preferably are positioned at different positions along an optical beam path and/or which are positioned in different partial beam paths, as will be explained in further detail below. Additionally or alternatively, however, the at least one optional focus-tunable lens may be used, and an evaluation according to the present invention may take place with at least two different adjustments, i.e. at least two different focal positions of the at least one focus-tunable lens. By shifting the focal position, the above-mentioned ambiguity may be resolved since the sizes of the beam spot measured, in one case, at a constant distance before the focal position and, in a second case, measured at the constant distance behind the focal position will behave differently when the focal position is changed. Thus, in one case, the size of the light spot will increase and in the other case decrease, or vice versa, as the skilled person easily may derive when looking at e.g. FIGS. 5A or 5B of WO 2014/097181 A1.

Thus, by using the at least one focus-tunable lens, beam splitters or a splitting of the beam path into two or more partial beam paths may be avoided. Still, one or more intransparent optical sensors may be used. At least one focus-tunable lens can be used to record two or more images in a row, which, as an example, may be used as an input signal for the evaluation device. Thereby, a detector or a camera with only one beam path may be realized, such as by recording two or more images in a row with different lens focus of the at least one focus-tunable lens. The images may be used as an input for the at least one evaluation device.

Secondly, the at least one focus-tunable lens may be used for recording images in different object planes. Thus, by changing the focal length of the at least one focus-tunable lens, a 3-D imaging may take place.

Thus, generally, the at least one optional transfer device may comprise at least one focus-tunable lens. The detector, specifically the evaluation device, may be configured to subsequently record images in different object planes. Additionally or alternatively, the detector, specifically the evaluation device, may be configured to determine longitudinal coordinates of at least two different parts of the object having different longitudinal coordinates z by evaluating at least two different longitudinal sensor signals acquired at at least two different adjustments of the at least one focus-tunable lens. The detector, specifically the evaluation device, may be configured to resolve ambiguities in the determination of the at least one longitudinal coordinate z by comparing results obtained at at least two different adjustments of the at least one focus-tunable lens.

Further, additionally or alternatively, the at least one transfer device may comprise at least one multi-lens system, such as at least one array of lenses, specifically at least one micro-lens array. As used herein, a “multi-lens” system generally refers to a plurality of lenses, an “array of lenses” refers to a plurality of lenses arranged in a pattern, such as in a rectangular, circular, hexagonal or star-shaped pattern, specifically in a plane perpendicular to an optical axis of the detector. A “micro-lens array” refers to an array of lenses having a diameter or equivalent diameter in the submillimeter range, such as having a diameter or equivalent diameter of less than 1 mm, specifically 500 μm or less, more specifically 300 μm or less. By using at least one multi-lens system, specifically at least one array of lenses, more specifically at least one micro-lens array, optionally in conjunction with at least one further lens, such as at least one main lens, the detector may be embodied as one or both of a light field camera and/or a plenoptic camera. As used herein, a “light-field detector” generally refers to an optical detector which is configured to record information from at least two different object planes, preferably simultaneously. Further, as used herein, a “light-field camera” generally refers to a camera which is configured to record images from at least two different object planes, preferably simultaneously. As further used herein, a “plenoptic detector” generally refers to a detector having a plurality of lenses and/or a plurality of curved mirrors having differing focal points, such as a plurality of lenses and/or a plurality of curved mirrors being located in a plane perpendicular to an optical axis of the detector. Similarly, as used herein, a “plenoptic camera” generally refers to a camera having a plurality of lenses and/or a plurality of curved mirrors having differing focal points, such as a plurality of lenses and/or a plurality of curved mirrors being located in a plane perpendicular to an optical axis of the camera. The optics of the light-field detector and/or the light-field camera specifically may comprise at least one main lens or main lens system, and, additionally, at least one multi-lens system, specifically at least one array of lenses, more specifically at least one micro-lens array. The light-field detector and/or the light-field camera further comprises the at least one optical sensor, such as the at least one CCD and/or CMOS sensor, wherein the optical sensor may specifically be an image sensor. While recording an image, objects in a first object plane may be in focus, so that the image plane may coincide with the lenses of a plane of the multi-lens system, specifically of the at least one array of lenses, more specifically of the at least one micro-lens array. The image focused on this object plane may be obtained by summing up the nonlinear sensor signals or intensities below each lens, such as below each micro-lens.

As outlined above, the detector comprises at least one longitudinal optical sensor and at least one transversal optical sensor. Generally, the optical sensors may be transparent, semitransparent, or intransparent. Thus, as an example, the optical sensor may be transparent and adapted to transmit more than 50%, preferably at least 90% and, more preferably, at least 99% of the power of the light beam or semitransparent and adapted to transmit at least 1%, preferably at least 10% and, more preferably, at least 25% up to 50% of the power of the light beam.

In case a plurality of the optical sensors is provided in a stacked fashion, preferably, at least one of the optical sensors is semitransparent or, preferably, transparent. In a particular embodiment, at least one of the optical sensors may, thus, be transparent or semitransparent over one or more predefined wavelength ranges. By way of example, a first optical sensor being first impinged by an incident light beam may be transparent or semitransparent within a first wavelength range, whereas a second optical sensor being impinged by an incident light beam, thereafter, may be particularly sensitive within the first wavelength range. By way of another example, the second optical sensor may be particularly insensitive within the first wavelength range within which the first optical sensor may be particularly transparent in order to still allow acquiring a comparatively high signal by the second optical sensor within the first wavelength range. However, other arrangements may also be feasible. Still, one of the major advantages of the present invention resides in the fact that conventional camera chips may be used as optical sensors, which, typically, are intransparent. In this case, a splitting of the beam path is typically preferable in case a plurality of optical sensors is used, in order to avoid the necessity of using transparent optical sensors.

In case a plurality of the same kind of optical sensors is provided, i.e. a plurality of longitudinal optical sensors or a plurality of transversal optical sensors, which may be arranged in the stacked fashion and/or in another arrangement, the respective kind optical sensors may have identical spectral sensitivities or may provide different spectral sensitivities. Thus, as an example, at least two of this kind of optical sensors may have a differing spectral sensitivity. As used herein, the term spectral sensitivity generally refers to the fact that the respective sensor signal of the corresponding optical sensor, for the same power of the light beam, may vary with the wavelength of the light beam. Thus, generally, at least two of the same kind of optical sensors may differ with regard to their spectral properties. This embodiment generally may be achieved by using different types of optical filters and/or different types of absorbing materials for the respective optical sensors, such as different types of dyes or other absorbing materials. Additionally or alternatively, differing spectral properties of the optical sensors may be generated by other means implemented into the optical sensors and/or into the detector, such as by using one or more wavelength-selective elements, such as one or more filters (such as color filters) in front of the optical sensors and/or by using one or more prisms and/or by using one or more dichroitic mirrors. Thus, in case a plurality of one kind of optical sensors is provided, at least one of the optical sensors may comprise a wavelength-selective element such as a color filter, having a specific transmission or reflection characteristic, thereby generating differing spectral properties of the optical sensors.

In case a plurality of the same kind of optical sensors is used, wherein at least two of the optical sensors differ with regard to their respective spectral sensitivity, the evaluation device generally may be adapted to determine a color of the light beam by comparing sensor signals of the optical sensors having the differing spectral sensitivity. As used herein, the expression “determine a color” generally refers to the step of generating at least one item of spectral information about the light beam. The at least one item of spectral information may be selected from the group consisting of a wavelength, specifically a peak wavelength; color coordinates, such as CIE coordinates.

The determination of the color of the light beam may be performed in various ways which are generally known to the skilled person. Thus, the spectral sensitivities of the optical sensors may span a coordinate system in color space, and the signals provided by the optical sensors may provide a coordinate in this color space, as known to the skilled person for example from the way of determining CIE coordinates.

As an example, the detector may comprise two, three or more optical sensors of the same kind in a stack. Thereof, at least two, preferably at least three, of the optical sensors may have differing spectral sensitivities. Further, the evaluation device may be adapted to generate at least one item of color information for the light beam by evaluating the signals of the optical sensors having differing spectral sensitivities.

As an example, at least three optical sensors of the same kind being spectrally sensitive optical sensors may be contained in the stack. Thus, e.g., the spectrally sensitive optical sensors may comprise at least one red sensitive optical sensor, the red sensitive optical sensor having a maximum absorption wavelength λr in a spectral range 600 nm<Ar<780 nm, wherein the spectrally sensitive optical sensors further comprise at least one green sensitive optical sensor, the green sensitive optical sensor having a maximum absorption wavelength Ag in a spectral range 490 nm<λg<600 nm, wherein the spectrally sensitive optical sensors further may comprise at least one blue sensitive optical sensor, the blue sensitive optical sensor having a maximum absorption wavelength Ab in a spectral range 380 nm<λb<490 nm. As an example, the red sensitive optical sensor, the green sensitive optical sensor and the blue sensitive optical sensor, in this order or in a different order, may be the first optical sensors of the optical sensor stack, facing towards the object.

The evaluation device may be adapted to generate at least two color coordinates, preferably at least three color coordinates, wherein each of the color coordinates is determined by dividing a signal of one of the spectrally sensitive optical sensors by a normalization value. As an example, the normalization value may contain a sum of the signals of all spectrally sensitive optical sensors. Additionally or alternatively, the normalization value may contain a detector signal of a white detector.

The at least one item of color information may contain the color coordinates. The at least one item of color information may, as an example, contain CIE coordinates.

In addition to the preferred at least two, more preferably at least three, spectrally sensitive optical sensors, the detector may further comprise at least one white optical sensor, wherein the white detector may be adapted to absorb light in an absorption range of all spectrally sensitive detectors. Thus, as an example, the white optical sensor may have an absorption spectrum absorbing light all over the visible spectral range.

Further, in case a plurality of optical sensors is provided, the plurality of the optical sensors may differ with regard to device setup and/or with regard to the materials used in the optical sensors. Specifically, the optical sensors may differ with regard to their organic or inorganic nature. Thus, the plurality of optical sensors may comprise one or more organic optical sensors, one or more inorganic optical sensors, one or more hybrid organic-inorganic optical sensors or an arbitrary combination of at least two of these optical sensors. Thus, as an example, the detector may consist of organic optical sensors only, may consist of inorganic optical sensors only or may consist of hybrid organic-inorganic optical sensors, only. Additionally or alternatively, the detector may comprise at least one organic optical sensor and at least one inorganic optical sensor or may comprise at least one organic optical sensor and at least one hybrid organic-inorganic optical sensor or may comprise at least one organic optical sensor and at least one hybrid organic-inorganic optical sensor.

In a further aspect of the present invention, a detector system for determining a position of at least one object is disclosed. The detector system comprises at least one detector according to the present invention, such as according to one or more of the embodiments disclosed above or according to one or more of the embodiments disclosed in further detail below. The detector system further comprising at least one beacon device adapted to direct at least one light beam towards the detector, wherein the beacon device is at least one of attachable to the object, holdable by the object and integratable into the object. Further details regarding the beacon device will be given below, including potential embodiments thereof. Thus, the at least one beacon device may be or may comprise at least one active beacon device, comprising one or more illumination sources such as one or more light sources like lasers, LEDs, light bulbs or the like. As an example, the light emitted by the illumination source may have a wavelength of 300-500 nm. Additionally or alternatively, the at least one beacon device may be adapted to reflect one or more light beams towards the detector, such as by comprising one or more reflective elements. Further, the at least one beacon device may be or may comprise one or more scattering elements adapted for scattering a light beam. Therein, elastic or inelastic scattering may be used. In case the at least one beacon device is adapted to reflect and/or scatter a primary light beam towards the detector, the beacon device may be adapted to leave the spectral properties of the light beam unaffected or, alternatively, may be adapted to change the spectral properties of the light beam, such as by modifying a wavelength of the light beam.

In a further aspect of the present invention, a human-machine interface for exchanging at least one item of information between a user and a machine is disclosed. The human-machine interface comprises at least one detector system according to the embodiments disclosed above and/or according to one or more of the embodiments disclosed in further detail below. Therein, the at least one beacon device is adapted to be at least one of directly or indirectly attached to the user or held by the user. The human-machine interface is designed to determine at least one position of the user by means of the detector system, wherein the human-machine interface is designed to assign to the position at least one item of information.

In a further aspect of the present invention, an entertainment device for carrying out at least one entertainment function is disclosed. The entertainment device comprises at least one human-machine interface according to the embodiment disclosed above and/or according to one or more of the embodiments disclosed in further detail below. The entertainment device is configured to enable at least one item of information to be input by a player by means of the human-machine interface. The entertainment device is further configured to vary the entertainment function in accordance with the information.

In a further aspect of the present invention, a tracking system for tracking a position of at least one movable object is disclosed. The tracking system comprises at least one detector system according to one or more of the embodiments referring to a detector system as disclosed above and/or as disclosed in further detail below. The tracking system further comprises at least one track controller. The track controller is adapted to track a series of positions of the object at specific points in time.

In a further aspect of the present invention, a camera for imaging at least one object is disclosed. The camera comprises at least one detector according to any one of the embodiments referring to a detector as disclosed above or as disclosed in further detail below.

In a further aspect of the present invention, a scanning system for determining at least one position of at least one object is provided. As used herein, the scanning system is a device which is adapted to emit at least one light beam being configured for an illumination of at least one dot located at at least one surface of the at least one object and for generating at least one item of information about the distance between the at least one dot and the scanning system. For the purpose of generating the at least one item of information about the distance between the at least one dot and the scanning system, the scanning system comprises at least one of the detectors according to the present invention, such as at least one of the detectors as disclosed in one or more of the embodiments listed above and/or as disclosed in one or more of the embodiments below.

Thus, the scanning system comprises at least one illumination source which is adapted to emit the at least one light beam being configured for the illumination of the at least one dot located at the at least one surface of the at least one object. As used herein, the term “dot” refers to an area, specifically a small area, on a part of the surface of the object which may be selected, for example by a user of the scanning system, to be illuminated by the illumination source. Preferably, the dot may exhibit a size which may, on one hand, be as small as possible in order to allow the scanning system to determine a value for the distance between the illumination source comprised by the scanning system and the part of the surface of the object on which the dot may be located as exactly as possible and which, on the other hand, may be as large as possible in order to allow the user of the scanning system or the scanning system itself, in particular by an automatic procedure, to detect a presence of the dot on the related part of the surface of the object.

For this purpose, the illumination source may comprise an artificial illumination source, in particular at least one laser source and/or at least one incandescent lamp and/or at least one semiconductor light source, for example, at least one light-emitting diode, in particular an organic and/or inorganic light-emitting diode. As an example, the light emitted by the illumination source may have a wavelength of 300-500 nm. On account of their generally defined beam profiles and other properties of handleability, the use of at least one laser source as the illumination source is particularly preferred. Herein, the use of a single laser source may be preferred, in particular in a case in which it may be important to provide a compact scanning system that might be easily storable and transportable by the user. The illumination source may thus, preferably be a constituent part of the detector and may, therefore, in particular be integrated into the detector, such as into the housing of the detector. In a preferred embodiment, particularly the housing of the scanning system may comprise at least one display configured for providing distance-related information to the user, such as in an easy-to-read manner. In a further preferred embodiment, particularly the housing of the scanning system may, in addition, comprise at least one button which may be configured for operating at least one function related to the scanning system, such as for setting one or more operation modes. In a further preferred embodiment, particularly the housing of the scanning system may, in addition, comprise at least one fastening unit which may be configured for fastening the scanning system to a further surface, such as a rubber foot, a base plate or a wall holder, such as a base plate or holder comprising a magnetic material, in particular for increasing the accuracy of the distance measurement and/or the handleability of the scanning system by the user.

Particularly, the illumination source of the scanning system may, thus, emit a single laser beam which may be configured for the illumination of a single dot located at the surface of the object. By using at least one of the detectors according to the present invention at least one item of information about the distance between the at least one dot and the scanning system may, thus, be generated. Hereby, preferably, the distance between the illumination system as comprised by the scanning system and the single dot as generated by the illumination source may be determined, such as by employing the evaluation device as comprised by the at least one detector. However, the scanning system may, further, comprise an additional evaluation system which may, particularly, be adapted for this purpose. Alternatively or in addition, a size of the scanning system, in particular of the housing of the scanning system, may be taken into account and, thus, the distance between a specific point on the housing of the scanning system, such as a front edge or a back edge of the housing, and the single dot may, alternatively, be determined.

Alternatively, the illumination source of the scanning system may emit two individual laser beams which may be configured for providing a respective angle, such as a right angle, between the directions of an emission of the beams, whereby two respective dots located at the surface of the same object or at two different surfaces at two separate objects may be illuminated. However, other values for the respective angle between the two individual laser beams may also be feasible. This feature may, in particular, be employed for indirect measuring functions, such as for deriving an indirect distance which may not be directly accessible, such as due to a presence of one or more obstacles between the scanning system and the dot or which may otherwise be hard to reach. By way of example, it may, thus, be feasible to determine a value for a height of an object by measuring two individual distances and deriving the height by using the Pythagoras formula. In particular for being able to keep a predefined level with respect to the object, the scanning system may, further, comprise at least one leveling unit, in particular an integrated bubble vial, which may be used for keeping the predefined level by the user.

As a further alternative, the illumination source of the scanning system may emit a plurality of individual laser beams, such as an array of laser beams which may exhibit a respective pitch, in particular a regular pitch, with respect to each other and which may be arranged in a manner in order to generate an array of dots located on the at least one surface of the at least one object. For this purpose, specially adapted optical elements, such as beam-splitting devices and mirrors, may be provided which may allow a generation of the described array of the laser beams. In particular, the illumination source may be directed to scan an area or a volume by using one or more movable mirrors to redirect the light beam in a periodic or non-periodic fashion. The illumination source may further be redirected using an array of micro-mirrors in order to provide in this manner a structured light source. The structured light source may be used to project optical features, such as points or fringes.

Thus, the scanning system may provide a static arrangement of the one or more dots placed on the one or more surfaces of the one or more objects. Alternatively, the illumination source of the scanning system, in particular the one or more laser beams, such as the above described array of the laser beams, may be configured for providing one or more light beams which may exhibit a varying intensity over time and/or which may be subject to an alternating direction of emission in a passage of time, in particular by moving one or more mirrors, such as the micro-mirrors comprised within the mentioned array of micro-mirrors. As a result, the illumination source may be configured for scanning a part of the at least one surface of the at least one object as an image by using one or more light beams with alternating features as generated by the at least one illumination source of the scanning device. In particular, the scanning system may, thus, use at least one row scan and/or line scan, such as to scan the one or more surfaces of the one or more objects sequentially or simultaneously. As non-limiting examples, the scanning system may be used in safety laser scanners, e.g. in production environments, and/or in 3D-scanning devices as used for determining the shape of an object, such as in connection to 3D-printing, body scanning, quality control, in construction applications, e.g. as range meters, in logistics applications, e.g. for determining the size or volume of a parcel, in household applications, e.g. in robotic vacuum cleaners or lawn mowers, or in other kinds of applications which may include a scanning step.

The optional transfer device can, as explained above, be designed to feed light propagating from the object to the detector to the at least two optical sensors, preferably successively. As explained above, this feeding can optionally be effected by means of imaging or else by means of non-imaging properties of the transfer device. In particular the transfer device can also be designed to collect the electromagnetic radiation before the latter is fed to one or more of the optical sensors. The optional transfer device can also, as explained in even greater detail below, be wholly or partly a constituent part of at least one optional illumination source, for example by the illumination source being designed to provide a light beam having defined optical properties, for example having a defined or precisely known beam profile, for example at least one Gaussian beam, in particular at least one laser beam having a known beam profile.

For potential embodiments of the optional illumination source, reference may be made to WO 2012/110924 A1. Still, other embodiments are feasible. Light emerging from the object can originate in the object itself, but can also optionally have a different origin and propagate from this origin to the object and subsequently toward the transversal and/or longitudinal optical sensor. The latter case can be effected for example by at least one illumination source being used. This illumination source can for example be or comprise an ambient illumination source and/or may be or may comprise an artificial illumination source. By way of example, the detector itself can comprise at least one illumination source, for example at least one laser and/or at least one incandescent lamp and/or at least one semiconductor illumination source, for example, at least one light-emitting diode, in particular an organic and/or inorganic light-emitting diode. On account of their generally defined beam profiles and other properties of handleability, the use of one or a plurality of lasers as illumination source or as part thereof, is particularly preferred. The illumination source itself can be a constituent part of the detector or else be formed independently of the detector. The illumination source can be integrated in particular into the detector, for example a housing of the detector. Alternatively or additionally, at least one illumination source can also be integrated into the at least one beacon device or into one or more of the beacon devices and/or into the object or connected or spatially coupled to the object.

The light emerging from the beacon devices can accordingly, alternatively or additionally from the option that said light originates in the respective beacon device itself, emerge from the illumination source and/or be excited by the illumination source. By way of example, the electromagnetic light emerging from the beacon device can be emitted by the beacon device itself and/or be reflected by the beacon device and/or be scattered by the beacon device before it is fed to the detector. In this case, emission and/or scattering of the electromagnetic radiation can be effected without spectral influencing of the electromagnetic radiation or with such influencing. Thus, by way of example, a wavelength shift can also occur during scattering, for example according to Stokes or Raman. Furthermore, emission of light can be excited, for example, by a primary illumination source, for example by the object or a partial region of the object being excited to generate luminescence, in particular phosphorescence and/or fluorescence. Other emission processes are also possible, in principle. If a reflection occurs, then the object can have for example at least one reflective region, in particular at least one reflective surface. Said reflective surface can be a part of the object itself, but can also be for example a reflector which is connected or spatially coupled to the object, for example a reflector plaque connected to the object. If at least one reflector is used, then it can in turn also be regarded as part of the detector which is connected to the object, for example, independently of other constituent parts of the detector.

The beacon devices and/or the at least one optional illumination source generally may emit light in at least one of: the ultraviolet spectral range, preferably in the range of 200 nm to 380 nm; the visible spectral range (380 nm to 780 nm); the infrared spectral range, preferably in the range of 780 nm to 3.0 micrometers. For thermal imaging applications the target may emit light in the far infrared spectral range, preferably in the range of 3.0 micrometers to 20 micrometers. Most preferably, the at least one illumination source is adapted to emit light in the visible spectral range, preferably in the range of 500 nm to 780 nm, most preferably at 650 nm to 750 nm or at 690 nm to 700 nm.

The feeding of the light beam to the optical sensors can be effected in particular in such a way that a light spot, for example having a round, oval or differently configured cross section, is produced on the sensitive area of the optical sensor. By way of example, the detector can have a visual range, in particular a solid angle range and/or spatial range, within which objects can be detected. Preferably, the optional transfer device is designed in such a way that the light spot, for example in the case of an object arranged within a visual range of the detector, is arranged completely on the sensitive areas of the optical sensors. By way of example, a sensitive area can be chosen to have a corresponding size in order to ensure this condition.

Further, the present invention discloses a method for determining a position of at least one object by using a detector, such as a detector according to the present invention, such as according to one or more of the embodiments referring to a detector as disclosed above or as disclosed in further detail below. Still, other types of detectors may be used. The method comprises the following method steps, wherein the method steps may be performed in the given order or may be performed in a different order. Further, one or more additional method steps may be present which are not listed. Further, one, more than one or even all of the method steps may be performed repeatedly.

The method steps are as follows:
illuminating at least one longitudinal sensitive area in at least one longitudinal sensor region of at least one longitudinal optical sensor in a manner that at least one longitudinal sensor signal being dependent on an illumination of the longitudinal sensitive area by the light beam is generated, wherein the longitudinal sensor signal, given the same total power of the illumination, is dependent on a beam cross-section of the light beam in the longitudinal sensitive area;
illuminating at least one transversal sensitive area of at least one fluorescent wave-guiding sheet of at least one transversal optical sensor of the detector with the at least one light beam propagating from the object towards the detector, wherein the light beam generates at least one light spot in the transversal sensitive area, wherein the fluorescent waveguiding sheet contains at least one fluorescent material;
generating fluorescence light in response to the illumination by the light beam by the fluorescent waveguiding sheet;
guiding the fluorescence light from the light spot towards at least two photosensitive elements located at at least two edges of the fluorescent waveguiding sheet;
detecting the fluorescence light by using the photosensitive elements and generating transversal sensor signals;
evaluating the longitudinal sensor signal by using at least one evaluation device and determining at least one longitudinal coordinate of the object; and
evaluating the transversal sensor signals of the photosensitive elements by using the at least one evaluation device and determining at least one transversal coordinate of the object thereof.

For details, options and definitions, reference may be made to the detector as discussed above. Thus, specifically, as outlined above, the method may comprise using the detector according to the present invention, such as according to one or more of the embodiments given above or given in further detail below.

In a further aspect of the present invention, use of the detector according to the present invention, such as according to one or more of the embodiments given above or given in further detail below, is proposed, for a purpose of use, selected from the group consisting of: a position measurement in traffic technology; an entertainment application; a security application; a surveillance application; a safety application; a human-machine interface application; a tracking application; a photography application; a use in combination with at least one time-of-flight detector; a use in combination with a structured light source; a use in combination with a stereo camera; a machine vision application; a robotics application; a quality control application; a manufacturing application; a use in combination with a structured illumination source; a use in combination with a stereo camera.

The optical sensor may comprise one or more signal processing devices, such as one or more filters and/or analogue-digital-converters for processing and/or preprocessing the at least one signal. The one or more signal processing devices may fully or partially be integrated into the optical sensor and/or may fully or partially be embodied as independent software and/or hardware components.

The object generally may be a living or non-living object. The detector system even may comprise the at least one object, the object thereby forming part of the detector system. Preferably, however, the object may move independently from the detector, in at least one spatial dimension.

The object generally may be an arbitrary object. In one embodiment, the object may be a rigid object. Other embodiments are feasible, such as embodiments in which the object is a non-rigid object or an object which may change its shape.

As will be outlined in further detail below, the present invention may specifically be used for tracking positions and/or motions of a person, such as for the purpose of controlling machines, gaming or simulation of sports. In this or other embodiments, specifically, the object may be selected from the group consisting of: an article of sports equipment, preferably an article selected from the group consisting of a racket, a club, a bat; an article of clothing; a hat; a shoe.

In an aspect of the present invention, as outlined above, the human-machine interface for exchanging at least one item of information between a user and a machine is disclosed. The human-machine interface comprises at least one detector system according to the present invention, such as to one or more of the embodiments disclosed above and/or according to one or more of the embodiments disclosed in further detail below. The beacon devices are adapted to be at least one of directly or indirectly attached to the user and held by the user. The human-machine interface is designed to determine at least one position of the user by means of the detector system. The human-machine interface further is designed to assign to the position at least one item of information.

In an aspect of the present invention, as outlined above, an entertainment device for carrying out at least one entertainment function is disclosed. The entertainment device comprises at least one human-machine interface according to the present invention. The entertainment device further is designed to enable at least one item of information to be input by a player by means of the human-machine interface. The entertainment device further is designed to vary the entertainment function in accordance with the information.

As outlined above, in a further aspect of the present invention, the tracking system for tracking a position of at least one movable object is disclosed. The tracking system comprises at least one detector system according to the present invention, such as to one or more of the embodiments disclosed above and/or according to one or more of the embodiments disclosed in further detail below. The tracking system further comprises at least one track controller, wherein the track controller is adapted to track a series of positions of the object at specific points in time.

Thus, generally, the devices according to the present invention, such as the detector, may be applied in various fields of uses. Specifically, the detector may be applied for a purpose of use, selected from the group consisting of: a position measurement in traffic technology; an entertainment application; a security application; a human-machine interface application; a tracking application; a photography application; a mapping application for generating maps of at least one space, such as at least one space selected from the group of a room, a building and a street; a mobile application; a webcam; an audio device; a dolby surround audio system; a computer peripheral device; a gaming application; a camera or video application; a security application; a surveillance application; an automotive application; a transport application; a medical application; a sports' application; a machine vision application; a vehicle application; an airplane application; a ship application; a spacecraft application; a building application; a construction application; a cartography application; a manufacturing application; a use in combination with at least one time-of-flight detector. Additionally or alternatively, applications in local and/or global positioning systems may be named, especially landmark-based positioning and/or navigation, specifically for use in cars or other vehicles (such as trains, motorcycles, bicycles, trucks for cargo transportation), robots or for use by pedestrians. Further, indoor positioning systems may be named as potential applications, such as for household applications and/or for robots used in manufacturing technology.

Thus, firstly, the devices according to the present invention may be used in mobile phones, tablet computers, laptops, smart panels or other stationary or mobile or wearable computer or communication applications. Thus, the devices according to the present invention may be combined with at least one active light source, such as a light source emitting light in the visible range or infrared spectral range, in order to enhance performance. Thus, as an example, the devices according to the present invention may be used as cameras and/or sensors, such as in combination with mobile software for scanning environment, objects and living beings. The devices according to the present invention may even be combined with 2D cameras, such as conventional cameras, in order to increase imaging effects. The devices according to the present invention may further be used for surveillance and/or for recording purposes or as input devices to control mobile devices, especially in combination with voice and/or gesture recognition. Thus, specifically, the devices according to the present invention acting as human-machine interfaces, also referred to as input devices, may be used in mobile applications, such as for controlling other electronic devices or components via the mobile device, such as the mobile phone. As an example, the mobile application including at least one device according to the present invention may be used for controlling a television set, a game console, a music player or music device or other entertainment devices.

Further, the devices according to the present invention may be used in webcams or other peripheral devices for computing applications. Thus, as an example, the devices according to the present invention may be used in combination with software for imaging, recording, surveillance, scanning or motion detection. As outlined in the context of the human-machine interface and/or the entertainment device, the devices according to the present invention are particularly useful for giving commands by facial expressions and/or body expressions. The devices according to the present invention can be combined with other input generating devices like e.g. mouse, keyboard, touchpad, microphone etc. Further, the devices according to the present invention may be used in applications for gaming, such as by using a webcam. Further, the devices according to the present invention may be used in virtual training applications and/or video conferences. Further, devices according to the present invention may be used to recognize or track hands, arms, or objects used in a virtual or augmented reality application, especially when wearing head mounted displays.

Further, the devices according to the present invention may be used in mobile audio devices, television devices and gaming devices, as partially explained above. Specifically, the devices according to the present invention may be used as controls or control devices for electronic devices, entertainment devices or the like. Further, the devices according to the present invention may be used for eye detection or eye tracking, such as in 2D- and 3D-display techniques, especially with transparent displays for augmented reality applications and/or for recognizing whether a display is being looked at and/or from which perspective a display is being looked at. Further, devices according to the present invention may be used to explore a room, boundaries, obstacles, in connection with a virtual or augmented reality application, especially when wearing a head-mounted display.

Further, the devices according to the present invention may be used in or as digital cameras such as DSC cameras and/or in or as reflex cameras such as SLR cameras. For these applications, reference may be made to the use of the devices according to the present invention in mobile applications such as mobile phones, as disclosed above.

Further, the devices according to the present invention may be used for security or surveillance applications. Thus, as an example, at least one device according to the present invention can be combined with one or more digital and/or analogue electronics that will give a signal if an object is within or outside a predetermined area (e.g. for surveillance applications in banks or museums). Specifically, the devices according to the present invention may be used for optical encryption. Detection by using at least one device according to the present invention can be combined with other detection devices to complement wavelengths, such as with IR, x-ray, UV-VIS, radar or ultrasound detectors. The devices according to the present invention may further be combined with an active infrared light source to allow detection in low light surroundings. The devices according to the present invention are generally advantageous as compared to active detector systems, specifically since the devices according to the present invention avoid actively sending signals which may be detected by third parties, as is the case e.g. in radar applications, ultrasound applications, LIDAR or similar active detector devices. Thus, generally, the devices according to the present invention may be used for an unrecognized and undetectable tracking of moving objects. Additionally, the devices according to the present invention generally are less prone to manipulations and irritations as compared to conventional devices.

Further, given the ease and accuracy of 3D detection by using the devices according to the present invention, the devices according to the present invention generally may be used for facial, body and person recognition and identification. Therein, the devices according to the present invention may be combined with other detection means for identification or personalization purposes such as passwords, finger prints, iris detection, voice recognition or other means. Thus, generally, the devices according to the present invention may be used in security devices and other personalized applications.

Further, the devices according to the present invention may be used as 3D barcode readers for product identification.

In addition to the security and surveillance applications mentioned above, the devices according to the present invention generally can be used for surveillance and monitoring of spaces and areas. Thus, the devices according to the present invention may be used for surveying and monitoring spaces and areas and, as an example, for triggering or executing alarms in case prohibited areas are violated. Thus, generally, the devices according to the present invention may be used for surveillance purposes in building surveillance or museums, optionally in combination with other types of sensors, such as in combination with motion or heat sensors, in combination with image intensifiers or image enhancement devices and/or photomultipliers.

Further, the devices according to the present invention may be used in public spaces or crowded spaces to detect potentially hazardous activities such as commitment of crimes such as theft in a parking lot or unattended objects such as unattended baggage in an airport. Further, the devices according to the present invention may advantageously be applied in camera applications such as video and camcorder applications. Thus, the devices according to the present invention may be used for motion capture and 3D-movie recording. Therein, the devices according to the present invention generally provide a large number of advantages over conventional optical devices. Thus, the devices according to the present invention generally require a lower complexity with regard to optical components. Thus, as an example, the number of lenses may be reduced as compared to conventional optical devices, such as by providing the devices according to the present invention having one lens only. Due to the reduced complexity, very compact devices are possible, such as for mobile use. Conventional optical systems having two or more lenses with high quality generally are voluminous, such as due to the general need for voluminous beam-splitters. Further, the devices according to the present invention generally may be used for focus/autofocus devices, such as autofocus cameras. Further, the devices according to the present invention may also be used in optical microscopy, especially in confocal microscopy.

Further, the devices according to the present invention generally are applicable in the technical field of automotive technology and transport technology. Thus, as an example, the devices according to the present invention may be used as distance and surveillance sensors, such as for adaptive cruise control, emergency brake assist, lane departure warning, surround view, blind spot detection, rear cross traffic alert, and other automotive and traffic applications. Further, the devices according to the present invention can also be used for velocity and/or acceleration measurements, such as by analyzing a first and second time-derivative of position information gained by using the detector according to the present invention. This feature generally may be applicable in automotive technology, transportation technology or general traffic technology. Applications in other fields of technology are feasible. A specific application in an indoor positioning system may be the detection of positioning of passengers in transportation, more specifically to electronically control the use of safety systems such as airbags. The use of an airbag may be prevented in case the passenger is located as such, that the use of an airbag will cause a severe injury.

In these or other applications, generally, the devices according to the present invention may be used as standalone devices or in combination with other sensor devices, such as in combination with radar and/or ultrasonic devices. Specifically, the devices according to the present invention may be used for autonomous driving and safety issues. Further, in these applications, the devices according to the present invention may be used in combination with infrared sensors, radar sensors, which are sonic sensors, two-dimensional cameras or other types of sensors. In these applications, the generally passive nature of the devices according to the present invention is advantageous. Thus, since the devices according to the present invention generally do not require emitting signals, the risk of interference of active sensor signals with other signal sources may be avoided. The devices according to the present invention specifically may be used in combination with recognition software, such as standard image recognition software. Thus, signals and data as provided by the devices according to the present invention typically are readily processable and, therefore, generally require lower calculation power than established stereovision systems such as LI DAR. Given the low space demand, the devices according to the present invention such as cameras may be placed at virtually any place in a vehicle, such as on a window screen, on a front hood, on bumpers, on lights, on mirrors or other places and the like. Various detectors according to the present invention such as one or more detectors based on the effect disclosed within the present invention can be combined, such as in order to allow autonomously driving vehicles or in order to increase the performance of active safety concepts. Thus, various devices according to the present invention may be combined with one or more other devices according to the present invention and/or conventional sensors, such as in the windows like rear window, side window or front window, on the bumpers or on the lights.

A combination of at least one device according to the present invention such as at least one detector according to the present invention with one or more rain detection sensors is also possible. This is due to the fact that the devices according to the present invention generally are advantageous over conventional sensor techniques such as radar, specifically during heavy rain. A combination of at least one device according to the present invention with at least one conventional sensing technique such as radar may allow for a software to pick the right combination of signals according to the weather conditions.

Further, the devices according to the present invention generally may be used as break assist and/or parking assist and/or for speed measurements. Speed measurements can be integrated in the vehicle or may be used outside the vehicle, such as in order to measure the speed of other cars in traffic control. Further, the devices according to the present invention may be used for detecting free parking spaces in parking lots.

Further, the devices according to the present invention may be used in the fields of medical systems and sports. Thus, in the field of medical technology, surgery robotics, e.g. for use in endoscopes, may be named, since, as outlined above, the devices according to the present invention may require a low volume only and may be integrated into other devices. Specifically, the devices according to the present invention having one lens, at most, may be used for capturing 3D information in medical devices such as in endoscopes. Further, the devices according to the present invention may be combined with an appropriate monitoring software, in order to enable tracking and analysis of movements. This may allow an instant overlay of the position of a medical device, such as an endoscope or a scalpel, with results from medical imaging, such as obtained from magnetic resonance imaging, x-ray imaging, or ultrasound imaging. These applications are specifically valuable e.g. in medical treatments where precise location information is important such as in brain surgery and long-distance diagnosis and tele-medicine. Further, the devices according to the present invention may be used in 3D-body scanning. Body scanning may be applied in a medical context, such as in dental surgery, plastic surgery, bariatric surgery, or cosmetic plastic surgery, or it may be applied in the context of medical diagnosis such as in the diagnosis of myofascial pain syndrome, cancer, body dysmorphic disorder, or further diseases. Body scanning may further be applied in the field of sports to assess ergonomic use or fit of sports equipment.

Body scanning may further be used in the context of clothing, such as to determine a suitable size and fitting of clothes. This technology may be used in the context of tailor-made clothes or in the context of ordering clothes or shoes from the internet or at a self-service shopping device such as a micro kiosk device or customer concierge device. Body scanning in the context of clothing is especially important for scanning fully dressed customers.

Further, the devices according to the present invention may be used in the context of people counting systems, such as to count the number of people in an elevator, a train, a bus, a car, or a plane, or to count the number of people passing a hallway, a door, an aisle, a retail store, a stadium, an entertainment venue, a museum, a library, a public location, a cinema, a theater, or the like. Further, the 3D-function in the people counting system may be used to obtain or estimate further information about the people that are counted such as height, weight, age, physical fitness, or the like. This information may be used for business intelligence metrics, and/or for further optimizing the locality where people may be counted to make it more attractive or safe.

In a retail environment, the devices according to the present invention in the context of people counting may be used to recognize returning customers or cross shoppers, to assess shopping behavior, to assess the percentage of visitors that make purchases, to optimize staff shifts, or to monitor the costs of a shopping mall per visitor. Further, people counting systems may be used for anthropometric surveys. Further, the devices according to the present invention may be used in public transportation systems for automatically charging passengers depending on the length of transport. Further, the devices according to the present invention may be used in playgrounds for children, to recognize injured children or children engaged in dangerous activities, to allow additional interaction with playground toys, to ensure safe use of playground toys or the like.

Further the devices according to the present invention may be used in construction tools, such as a range meter that determines the distance to an object or to a wall, to assess whether a surface is planar, to align or objects or place objects in an ordered manner, or in inspection cameras for use in construction environments or the like.

Further, the devices according to the present invention may be applied in the field of sports and exercising, such as for training, remote instructions or competition purposes. Specifically, the devices according to the present invention may be applied in the fields of dancing, aerobic, football, soccer, basketball, baseball, cricket, hockey, track and field, swimming, polo, handball, volleyball, rugby, sumo, judo, fencing, boxing, golf, car racing, laser tag, battlefield simulation etc. The devices according to the present invention can be used to detect the position of a ball, a bat, a sword, motions, etc., both in sports and in games, such as to monitor the game, support the referee or for judgment, specifically automatic judgment, of specific situations in sports, such as for judging whether a point or a goal actually was made.

Further, the devices according to the present invention may be used in the field of auto racing or car driver training or car safety training or the like to determine the position of a car or the track of a car, or the deviation from a previous track or an ideal track or the like.

The devices according to the present invention may further be used to support a practice of musical instruments, in particular remote lessons, for example lessons of string instruments, such as fiddles, violins, violas, celli, basses, harps, guitars, banjos, or ukuleles, keyboard instruments, such as pianos, organs, keyboards, harpsichords, harmoniums, or accordions, and/or percussion instruments, such as drums, timpani, marimbas, xylophones, vibraphones, bongos, congas, timbales, djembes or tablas.

The devices according to the present invention further may be used in rehabilitation and physiotherapy, in order to encourage training and/or in order to survey and correct movements. Therein, the devices according to the present invention may also be applied for distance diagnostics.

Further, the devices according to the present invention may be applied in the field of machine vision. Thus, one or more of the devices according to the present invention may be used e.g. as a passive controlling unit for autonomous driving and or working of robots. In combination with moving robots, the devices according to the present invention may allow for autonomous movement and/or autonomous detection of failures in parts. The devices according to the present invention may also be used for manufacturing and safety surveillance, such as in order to avoid accidents including but not limited to collisions between robots, production parts and living beings. In robotics, the safe and direct interaction of humans and robots is often an issue, as robots may severely injure humans when they are not recognized. Devices according to the present invention may help robots to position objects and humans better and faster and allow a safe interaction. Given the passive nature of the devices according to the present invention, the devices according to the present invention may be advantageous over active devices and/or may be used complementary to existing solutions like radar, ultrasound, 2D cameras, IR detection etc. One particular advantage of the devices according to the present invention is the low likelihood of signal interference. Therefore multiple sensors can work at the same time in the same environment, without the risk of signal interference. Thus, the devices according to the present invention generally may be useful in highly automated production environments like e.g. but not limited to automotive, mining, steel, etc. The devices according to the present invention can also be used for quality control in production, e.g. in combination with other sensors like 2-D imaging, radar, ultrasound, IR etc., such as for quality control or other purposes. Further, the devices according to the present invention may be used for assessment of surface quality, such as for surveying the surface evenness of a product or the adherence to specified dimensions, from the range of micrometers to the range of meters. Other quality control applications are feasible. In a manufacturing environment, the devices according to the present invention are especially useful for processing natural products such as food or wood, with a complex 3-dimensional structure to avoid large amounts of waste material. Further, devices according to the present invention may be used to monitor the filling level of tanks, silos etc. Further, devices according to the present invention may be used to inspect complex products for missing parts, incomplete parts, loose parts, low quality parts, or the like, such as in automatic optical inspection, such as of printed circuit boards, inspection of assemblies or sub-assemblies, verification of engineered components, engine part inspections, wood quality inspection, label inspections, inspection of medical devices, inspection of product orientations, packaging inspections, food pack inspections, or the like.

Further, the devices according to the present invention may be used in vehicles, trains, airplanes, ships, spacecraft and other traffic applications. Thus, besides the applications mentioned above in the context of traffic applications, passive tracking systems for aircraft, vehicles and the like may be named. The use of at least one device according to the present invention, such as at least one detector according to the present invention, for monitoring the speed and/or the direction of moving objects is feasible. Specifically, the tracking of fast moving objects on land, sea and in the air including space may be named. The at least one device according to the present invention, such as the at least one detector according to the present invention, specifically may be mounted on a still-standing and/or on a moving device. An output signal of the at least one device according to the present invention can be combined e.g. with a guiding mechanism for autonomous or guided movement of another object. Thus, applications for avoiding collisions or for enabling collisions between the tracked and the steered object are feasible. The devices according to the present invention generally are useful and advantageous due to the low calculation power required, the instant response and due to the passive nature of the detection system which generally is more difficult to detect and to disturb as compared to active systems, like e.g. radar. The devices according to the present invention are particularly useful but not limited to e.g. speed control and air traffic control devices. Further, the devices according to the present invention may be used in automated tolling systems for road charges.

The devices according to the present invention generally may be used in passive applications. Passive applications include guidance for ships in harbors or in dangerous areas, and for aircraft when landing or starting. Wherein, fixed, known active targets may be used for precise guidance. The same can be used for vehicles driving on dangerous but well defined routes, such as mining vehicles. Further, the devices according to the present invention may be used to detect rapidly approaching objects, such as cars, trains, flying objects, animals, or the like. Further, the devices according to the present invention can be used for detecting velocities or accelerations of objects, or to predict the movement of an object by tracking one or more of its position, speed, and/or acceleration depending on time.

Further, as outlined above, the devices according to the present invention may be used in the field of gaming. Thus, the devices according to the present invention can be passive for use with multiple objects of the same or of different size, color, shape, etc., such as for movement detection in combination with software that incorporates the movement into its content. In particular, applications are feasible in implementing movements into graphical output. Further, applications of the devices according to the present invention for giving commands are feasible, such as by using one or more of the devices according to the present invention for gesture or facial recognition. The devices according to the present invention may be combined with an active system in order to work under e.g. low light conditions or in other situations in which enhancement of the surrounding conditions is required. Additionally or alternatively, a combination of one or more devices according to the present invention with one or more IR or VIS light sources is possible. A combination of a detector according to the present invention with special devices is also possible, which can be distinguished easily by the system and its software, e.g. and not limited to, a special color, shape, relative position to other devices, speed of movement, light, frequency used to modulate light sources on the device, surface properties, material used, reflection properties, transparency degree, absorption characteristics, etc. The device can, amongst other possibilities, resemble a stick, a racquet, a club, a gun, a knife, a wheel, a ring, a steering wheel, a bottle, a ball, a glass, a vase, a spoon, a fork, a cube, a dice, a figure, a puppet, a teddy, a beaker, a pedal, a switch, a glove, jewelry, a musical instrument or an auxiliary device for playing a musical instrument, such as a plectrum, a drumstick or the like. Other options are feasible.

Further, the devices according to the present invention may be used to detect and or track objects that emit light by themselves, such as due to high temperature or further light emission processes. The light emitting part may be an exhaust stream or the like. Further, the devices according to the present invention may be used to track reflecting objects and analyze the rotation or orientation of these objects.

Further, the devices according to the present invention generally may be used in the field of building, construction and cartography. Thus, generally, one or more devices according to the present invention may be used in order to measure and/or monitor environmental areas, e.g. countryside or buildings. Therein, one or more devices according to the present invention may be combined with other methods and devices or can be used solely in order to monitor progress and accuracy of building projects, changing objects, houses, etc. The devices according to the present invention can be used for generating three-dimensional models of scanned environments, in order to construct maps of rooms, streets, houses, communities or landscapes, both from ground or from air. Potential fields of application may be construction, cartography, real estate management, land surveying or the like. As an example, the devices according to the present invention may be used in multicopters to monitor buildings, agricultural production environments such as fields, production plants, or landscapes, to support rescue operations, or to find or monitor one or more persons or animals, or the like.

Further, the devices according to the present invention may be used within an interconnecting network of home appliances such as CHAIN (Cedec Home Appliances Interoperating Network) to interconnect, automate, and control basic appliance-related services in a home, e.g. energy or load management, remote diagnostics, pet related appliances, child related appliances, child surveillance, appliances related surveillance, support or service to elderly or ill persons, home security and/or surveillance, remote control of appliance operation, and automatic maintenance support. Further, the devices according to the present invention may be used in heating or cooling systems such as an air-conditioning system, to locate which part of the room should be brought to a certain temperature or humidity, especially depending on the location of one or more persons. Further, the devices according to the present invention may be used in domestic robots, such as service or autonomous robots which may be used for household chores. The devices according to the present invention may be used for a number of different purposes, such as to avoid collisions or to map the environment, but also to identify a user, to personalize the robot's performance for a given user, for security purposes, or for gesture or facial recognition. As an example, the devices according to the present invention may be used in robotic vacuum cleaners, floor-washing robots, dry-sweeping robots, ironing robots for ironing clothes, animal litter robots, such as cat litter robots, security robots that detect intruders, robotic lawn mowers, automated pool cleaners, rain gutter cleaning robots, window washing robots, toy robots, telepresence robots, social robots providing company to less mobile people, or robots translating and speech to sign language or sign language to speech. In the context of less mobile people, such as elderly persons, household robots with the devices according to the present invention may be used for picking up objects, transporting objects, and interacting with the objects and the user in a safe way. Further the devices according to the present invention may be used in robots operating with hazardous materials or objects or in dangerous environments. As a non-limiting example, the devices according to the present invention may be used in robots or unmanned remote-controlled vehicles to operate with hazardous materials such as chemicals or radioactive materials especially after disasters, or with other hazardous or potentially hazardous objects such as mines, unexploded arms, or the like, or to operate in or to investigate insecure environments such as near burning objects or post disaster areas.

Further, the devices according to the present invention may be used in household, mobile or entertainment devices, such as a refrigerator, a microwave, a washing machine, a window blind or shutter, a household alarm, an air condition devices, a heating device, a television, an audio device, a smart watch, a mobile phone, a phone, a dishwasher, a stove or the like, to detect the presence of a person, to monitor the contents or function of the device, or to interact with the person and/or share information about the person with further household, mobile or entertainment devices.

The devices according to the present invention may further be used in agriculture, for example to detect and sort out vermin, weeds, and/or infected crop plants, fully or in parts, wherein crop plants may be infected by fungus or insects. Further, for harvesting crops, the devices according to the present invention may be used to detect animals, such as deer, which may otherwise be harmed by harvesting devices. Further, the devices according to the present invention may be used to monitor the growth of plants in a field or greenhouse, in particular to adjust the amount of water or fertilizer or crop protection products for a given region in the field or greenhouse or even for a given plant. Further, in agricultural biotechnology, the devices according to the present invention may be used to monitor the size and shape of plants.

Further, the devices according to the present invention may be combined with sensors to detect chemicals or pollutants, electronic nose chips, microbe sensor chips to detect bacteria or viruses or the like, Geiger counters, tactile sensors, heat sensors, or the like. This may for example be used in constructing smart robots which are configured for handling dangerous or difficult tasks, such as in treating highly infectious patients, handling or removing highly dangerous substances, cleaning highly polluted areas, such as highly radioactive areas or chemical spills, or for pest control in agriculture.

One or more devices according to the present invention can further be used for scanning of objects, such as in combination with CAD or similar software, such as for additive manufacturing and/or 3D printing. Therein, use may be made of the high dimensional accuracy of the devices according to the present invention, e.g. in x-, y- or z-direction or in any arbitrary combination of these directions, such as simultaneously. Further, the devices according to the present invention may be used in inspections and maintenance, such as pipeline inspection gauges. Further, in a production environment, the devices according to the present invention may be used to work with objects of a badly defined shape such as naturally grown objects, such as sorting vegetables or other natural products by shape or size or cutting products such as meat or objects that are manufactured with a precision that is lower than the precision needed for a processing step.

Further the devices according to the present invention may be used in local navigation systems to allow autonomously or partially autonomously moving vehicles or multicopters or the like through an indoor or outdoor space. A non-limiting example may comprise vehicles moving through an automated storage for picking up objects and placing them at a different location. Indoor navigation may further be used in shopping malls, retail stores, museums, airports, or train stations, to track the location of mobile goods, mobile devices, baggage, customers or employees, or to supply users with a location specific information, such as the current position on a map, or information on goods sold, or the like.

Further, the devices according to the present invention may be used to ensure safe driving of motorcycles such as driving assistance for motorcycles by monitoring speed, inclination, upcoming obstacles, unevenness of the road, or curves or the like. Further, the devices according to the present invention may be used in trains or trams to avoid collisions.

Further, the devices according to the present invention may be used in handheld devices, such as for scanning packaging or parcels to optimize a logistics process. Further, the devices according to the present invention may be used in further handheld devices such as personal shopping devices, RFID-readers, handheld devices for use in hospitals or health environments such as for medical use or to obtain, exchange or record patient or patient health related information, smart badges for retail or health environments, or the like.

As outlined above, the devices according to the present invention may further be used in manufacturing, quality control or identification applications, such as in product identification or size identification (such as for finding an optimal place or package, for reducing waste etc.). Further, the devices according to the present invention may be used in logistics applications. Thus, the devices according to the present invention may be used for optimized loading or packing containers or vehicles. Further, the devices according to the present invention may be used for monitoring or controlling of surface damages in the field of manufacturing, for monitoring or controlling rental objects such as rental vehicles, and/or for insurance applications, such as for assessment of damages. Further, the devices according to the present invention may be used for identifying a size of material, object or tools, such as for optimal material handling, especially in combination with robots. Further, the devices according to the present invention may be used for process control in production, e.g. for observing filling level of tanks. Further, the devices according to the present invention may be used for maintenance of production assets like, but not limited to, tanks, pipes, reactors, tools etc. Further, the devices according to the present invention may be used for analyzing 3D-quality marks. Further, the devices according to the present invention may be used in manufacturing tailor-made goods such as tooth inlays, dental braces, prosthesis, clothes or the like. The devices according to the present invention may also be combined with one or more 3D-printers for rapid prototyping, 3D-copying or the like. Further, the devices according to the present invention may be used for detecting the shape of one or more articles, such as for anti-product piracy and for anti-counterfeiting purposes.

Thus, specifically, the present application may be applied in the field of photography. Thus, the detector may be part of a photographic device, specifically of a digital camera. Specifically, the detector may be used for 3D photography, specifically for digital 3D photography. Thus, the detector may form a digital 3D camera or may be part of a digital 3D camera. As used herein, the term photography generally refers to the technology of acquiring image information of at least one object. As further used herein, a camera generally is a device adapted for performing photography. As further used herein, the term digital photography generally refers to the technology of acquiring image information of at least one object by using a plurality of light-sensitive elements adapted to generate electrical signals indicating an intensity and/or color of illumination, preferably digital electrical signals. As further used herein, the term 3D photography generally refers to the technology of acquiring image information of at least one object in three spatial dimensions. Accordingly, a 3D camera is a device adapted for performing 3D photography. The camera generally may be adapted for acquiring a single image, such as a single 3D image, or may be adapted for acquiring a plurality of images, such as a sequence of images. Thus, the camera may also be a video camera adapted for video applications, such as for acquiring digital video sequences.

Thus, generally, the present invention further refers to a camera, specifically a digital camera, more specifically a 3D camera or digital 3D camera, for imaging at least one object. As outlined above, the term imaging, as used herein, generally refers to acquiring image information of at least one object. The camera comprises at least one detector according to the present invention. The camera, as outlined above, may be adapted for acquiring a single image or for acquiring a plurality of images, such as image sequence, preferably for acquiring digital video sequences. Thus, as an example, the camera may be or may comprise a video camera. In the latter case, the camera preferably comprises a data memory for storing the image sequence.

As used within the present invention, the expression “position” generally refers to at least one item of information regarding one or more of an absolute position and an orientation of one or more points of the object. Thus, specifically, the position may be determined in a coordinate system of the detector, such as in a Cartesian coordinate system. Additionally or alternatively, however, other types of coordinate systems may be used, such as polar coordinate systems and/or spherical coordinate systems.

As outlined above and as will be outlined in further detail below, the present invention preferably may be applied in the field of human-machine interfaces, in the field of sports and/or in the field of computer games. Thus, preferably, the object may be selected from the group consisting of: an article of sports equipment, preferably an article selected from the group consisting of a racket, a club, a bat, an article of clothing, a hat, a shoe. Other embodiments are feasible.

As used herein, the object generally may be an arbitrary object, chosen from a living object and a non-living object. Thus, as an example, the at least one object may comprise one or more articles and/or one or more parts of an article. Additionally or alternatively, the object may be or may comprise one or more living beings and/or one or more parts thereof, such as one or more body parts of a human being, e.g. a user, and/or an animal.

With regard to the coordinate system for determining the position of the object, which may be a coordinate system of the detector, the detector may constitute a coordinate system in which an optical axis of the detector forms the z-axis and in which, additionally, an x-axis and a y-axis may be provided which are perpendicular to the z-axis and which are perpendicular to each other. As an example, the detector and/or a part of the detector may rest at a specific point in this coordinate system, such as at the origin of this coordinate system. In this coordinate system, a direction parallel or antiparallel to the z-axis may be regarded as a longitudinal direction, and a coordinate along the z-axis may be considered a longitudinal coordinate. An arbitrary direction perpendicular to the longitudinal direction may be considered a transversal direction, and an x- and/or y-coordinate may be considered a transversal coordinate.

Alternatively, other types of coordinate systems may be used. Thus, as an example, a polar coordinate system may be used in which the optical axis forms a z-axis and in which a distance from the z-axis and a polar angle may be used as additional coordinates. Again, a direction parallel or antiparallel to the z-axis may be considered a longitudinal direction, and a coordinate along the z-axis may be considered a longitudinal coordinate. Any direction perpendicular to the z-axis may be considered a transversal direction, and the polar coordinate and/or the polar angle may be considered a transversal coordinate.

The detector may be a device configured for providing at least one item of information on the position of the at least one object and/or a part thereof. Thus, the position may refer to an item of information fully describing the position of the object or a part thereof, preferably in the coordinate system of the detector, or may refer to a partial information, which only partially describes the position. The detector generally may be a device adapted for detecting light beams, such as the light beams propagating from the beacon devices towards the detector.

The evaluation device and the detector may fully or partially be integrated into a single device. Thus, generally, the evaluation device also may form part of the detector. Alternatively, the evaluation device and the detector may fully or partially be embodied as separate devices. The detector may comprise further components.

The detector may be a stationary device or a mobile device. Further, the detector may be a stand-alone device or may form part of another device, such as a computer, a vehicle or any other device. Further, the detector may be a hand-held device. Other embodiments of the detector are feasible.

The detector specifically may be used to record a light-field behind a lens or lens system of the detector, comparable to a plenoptic or light-field camera. Thus, specifically, the detector may be embodied as a light-field camera adapted for acquiring images in multiple focal planes, such as simultaneously. The term light-field, as used herein, generally refers to the spatial light propagation of light inside the detector such as inside camera. The detector according to the present invention, specifically having a stack of optical sensors, may have the capability of directly recording a light-field within the detector or camera, such as behind a lens. The plurality of sensors may record images at different distances from the lens. Using, e.g., convolution-based algorithms such as “depth from focus” or “depth from defocus”, the propagation direction, focus points, and spread of the light behind the lens can be modeled. From the modeled propagation of light behind the lens, images at various distances to the lens can be extracted, the depth of field can be optimized, pictures that are in focus at various distances can be extracted, or distances of objects can be calculated. Further information may be extracted.

Once the light propagation inside the detector, such as behind a lens of the detector, is modeled and/or recorded, this knowledge of light propagation provides a large number of advantages. Thus, the light-field may be recorded in terms of beam parameters for one or more light beams of a scene captured by the detector. As an example, for each light beam recorded, two or more beam parameters may be recorded, such as one or more Gaussian beam parameters, e.g. a beam waist, a minimum beam waist as a focal point, a Rayleigh length, or other beam parameters. Several representations of light beams may be used and beam parameters may be chosen accordingly.

This knowledge of light propagation, as an example, allows for slightly modifying the observer position after recording an image stack using image processing techniques. In a single image, an object may be hidden behind another object and is not visible. However, if the light scattered by the hidden object reaches the lens and through the lens one or more of the sensors, the object may be made visible, by changing the distance to the lens and/or the image plane relative to the optical axis, or even using non-planar image planes. The change of the observer position may be compared to looking at a hologram, in which changing the observer position slightly changes the image.

The knowledge of light propagation inside the detector, such as by modeling the light propagation behind the lens, may further allow for storing the image information in a more compact way as compared to conventional technology of storing each image recorded by each individual optical sensor. The memory demand of the light propagation scales with the number of modeled light beams times the number of parameters per light beam. Typical model functions for light beams may be Gaussians, Lorentzians, Bessel functions, especially spherical Bessel functions, other functions typically used for describing diffraction effects in physics, or typical spread functions used in depth from defocus techniques such as point spread functions, line spread functions or edge spread functions.

The use of several optical sensors further allows for correcting lens errors in an image processing step after recording the images. Optical instruments often become expensive and challenging in construction, when lens errors need to be corrected. These are especially problematic in microscopes and telescopes. In microscopes, a typical lens error is that rays of varying distance to the optical axis are distorted differently (spherical aberration). In telescopes, varying the focus may occur from differing temperatures in the atmosphere. Static errors such as spherical aberration or further errors from production may be corrected by determining the errors in a calibration step and then using a fixed image processing such as fixed set of pixels and sensor, or more involved processing techniques using light propagation information. In cases in which lens errors are strongly time-dependent, i.e. dependent on weather conditions in telescopes, the lens errors may be corrected by using the light propagation behind the lens, calculating extended depth of field images, using depth from focus techniques, and others.

As outlined above, the detector according to the present invention may further allow for color detection. For color detection in stacks of several optical sensors, the single stacks may have optical sensors that have different absorption properties, equal or similar to the so-called Bayer pattern, and color information may be obtained by interpolation techniques. A further method is to use sensors of alternating color, wherein different sensors in the stack may record different colors. In a Bayer pattern, color may be interpolated between same-color pixels. In a stack of sensors, the image information such as color and brightness, etc., can also be obtained by interpolation techniques.

The evaluation device may be or may comprise one or more integrated circuits, such as one or more application-specific integrated circuits (ASICs), and/or one or more data processing devices, such as one or more computers, preferably one or more microcomputers and/or microcontrollers. Additional components may be comprised, such as one or more preprocessing devices and/or data acquisition devices, such as one or more devices for receiving and/or preprocessing of the sensor signals, such as one or more AD-converters and/or one or more filters and/or more phase-sensitive electronic elements, particularly based on a lock-in measuring technique. Further, the evaluation device may comprise one or more measurement devices, such as one or more measurement devices for measuring electrical currents and/or electrical voltages. Further, the evaluation device may comprise one or more data storage devices. Further, the evaluation device may comprise one or more interfaces, such as one or more wireless interfaces and/or one or more wire-bound interfaces.

The at least one evaluation device may be adapted to perform at least one computer program, such as at least one computer program adapted for performing or supporting one or more or even all of the method steps of the method according to the present invention. As an example, one or more algorithms may be implemented which, by using the sensor signals as input variables, may determine the position of the object.

The evaluation device can be connected to or may comprise at least one further data processing device that may be used for one or more of displaying, visualizing, analyzing, distributing, communicating or further processing of information, such as information obtained by the optical sensors and/or by the evaluation device. The data processing device, as an example, may be connected or incorporate at least one of a display, a projector, a monitor, an LCD, a TFT, a loudspeaker, a multichannel sound system, an LED pattern, or a further visualization device. It may further be connected or incorporate at least one of a communication device or communication interface, a connector or a port, capable of sending encrypted or unencrypted information using one or more of email, text messages, telephone, Bluetooth, Wi-Fi, infrared or internet interfaces, ports or connections. It may further be connected or incorporate at least one of a processor, a graphics processor, a CPU, an Open Multimedia Applications Platform (OMAP™), an integrated circuit, a system on a chip such as products from the Apple A series or the Samsung S3C2 series, a microcontroller or microprocessor, one or more memory blocks such as ROM, RAM, EEPROM, or flash memory, timing sources such as oscillators or phase-locked loops, counter-timers, real-time timers, or power-on reset generators, voltage regulators, power management circuits, or DMA controllers. Individual units may further be connected by buses such as AMBA buses.

The evaluation device and/or the data processing device may be connected by or have further external interfaces or ports such as one or more of serial or parallel interfaces or ports, USB, Centronics Port, FireWire, HDMI, Ethernet, Bluetooth, RFID, Wi-Fi, USART, or SPI, or analogue interfaces or ports such as one or more of ADCs or DACs, or standardized interfaces or ports to further devices such as a 2D-camera device using an RGB-interface such as CameraLink. The evaluation device and/or the data processing device may further be connected by one or more of interprocessor interfaces or ports, FPGA-FPGA-interfaces, or serial or parallel interfaces ports. The evaluation device and the data processing device may further be connected to one or more of an optical disc drive, a CD-RW drive, a DVD+RW drive, a flash drive, a memory card, a disk drive, a hard disk drive, a solid state disk or a solid state hard disk.

The evaluation device and/or the data processing device may be connected by or have one or more further external connectors such as one or more of phone connectors, RCA connectors, VGA connectors, hermaphrodite connectors, USB connectors, HDMI connectors, 8P8C connectors, BCN connectors, IEC 60320 C14 connectors, optical fiber connectors, D-subminiature connectors, RF connectors, coaxial connectors, SCART connectors, XLR connectors, and/or may incorporate at least one suitable socket for one or more of these connectors. Possible embodiments of a single device incorporating one or more of the detectors according to the present invention, the evaluation device or the data processing device, such as incorporating one or more of the optical sensors, optical systems, evaluation device, communication device, data processing device, interfaces, system on a chip, display devices, or further electronic devices, are: mobile phones, personal computers, tablet PCs, televisions, game consoles or further entertainment devices. In a further embodiment, the 3D-camera functionality which will be outlined in further detail below may be integrated in devices that are available with conventional 2D-digital cameras, without a noticeable difference in the housing or appearance of the device, where the noticeable difference for the user may only be the functionality of obtaining and or processing 3D information.

Specifically, an embodiment incorporating the detector and/or a part thereof such as the evaluation device and/or the data processing device may be: a mobile phone incorporating a display device, a data processing device, the optical sensors, optionally the sensor optics, and the evaluation device, for the functionality of a 3D camera. The detector according to the present invention specifically may be suitable for integration in entertainment devices and/or communication devices such as a mobile phone.

A further embodiment of the present invention may be an incorporation of the detector or a part thereof such as the evaluation device and/or the data processing device in a device for use in automotive, for use in autonomous driving or for use in car safety systems such as Daimler's Intelligent Drive system, wherein, as an example, a device incorporating one or more of the optical sensors, optionally one or more optical systems, the evaluation device, optionally a communication device, optionally a data processing device, optionally one or more interfaces, optionally a system on a chip, optionally one or more display devices, or optionally further electronic devices may be part of a vehicle, a car, a truck, a train, a bicycle, an airplane, a ship, a motorcycle. In automotive applications, the integration of the device into the automotive design may necessitate the integration of the optical sensors, optionally optics, or device at minimal visibility from the exterior or interior. The detector or a part thereof such as the evaluation device and/or the data processing device may be especially suitable for such integration into automotive design.

As used herein, the term light generally refers to electromagnetic radiation in one or more of the visible spectral range, the ultraviolet spectral range and the infrared spectral range. Therein, the term visible spectral range generally refers to a spectral range of 380 nm to 780 nm. The term infrared spectral range generally refers to electromagnetic radiation in the range of 780 nm to 1 mm, preferably in the range of 780 nm to 3.0 micrometers. The term ultraviolet spectral range generally refers to electromagnetic radiation in the range of 1 nm to 380 nm, preferably in the range of 100 nm to 380 nm. Preferably, light as used within the present invention is visible light, i.e. light in the visible spectral range.

The term light beam generally refers to an amount of light emitted and/or reflected into a specific direction. Thus, the light beam may be a bundle of the light rays having a predetermined extension in a direction perpendicular to a direction of propagation of the light beam. Preferably, the light beams may be or may comprise one or more Gaussian light beams which may be characterized by one or more Gaussian beam parameters, such as one or more of a beam waist, a Rayleigh-length or any other beam parameter or combination of beam parameters suited to characterize a development of a beam diameter and/or a beam propagation in space.

As outlined above, the present invention further relates to a human-machine interface for exchanging at least one item of information between a user and a machine. The human-machine interface as proposed may make use of the fact that the above-mentioned detector in one or more of the embodiments mentioned above or as mentioned in further detail below may be used by one or more users for providing information and/or commands to a machine. Thus, preferably, the human-machine interface may be used for inputting control commands.

Generally, as used herein, the at least one position of the user may imply one or more items of information on a position of the user as a whole and/or one of or more body parts of the user. Thus, preferably, the position of the user may imply one or more items of information on a position of the user as provided by the evaluation device of the detector. The user, a body part of the user or a plurality of body parts of the user may be regarded as one or more objects the position of which may be detected by the at least one detector device. Therein, precisely one detector may be provided, or a combination of a plurality of detectors may be provided. As an example, a plurality of detectors may be provided for determining positions of a plurality of body parts of the user and/or for determining a position of at least one body part of the user.

The detector according to the present invention may further be combined with one or more other types of sensors or detectors. Thus, the detector may further comprise at least one additional detector. The at least one additional detector may be adapted for detecting at least one parameter, such as at least one of: a parameter of a surrounding environment, such as a temperature and/or a brightness of a surrounding environment; a parameter regarding a position and/or orientation of the detector; a parameter specifying a state of the object to be detected, such as a position of the object, e.g. an absolute position of the object and/or an orientation of the object in space. Thus, generally, the principles of the present invention may be combined with other measurement principles in order to gain additional information and/or in order to verify measurement results or reduce measurement errors or noise.

Specifically, the detector according to the present invention may further comprise at least one time-of-flight (ToF) detector adapted for detecting at least one distance between the at least one object and the detector by performing at least one time-of-flight measurement. As used herein, a time-of-flight measurement generally refers to a measurement based on a time a signal needs for propagating between two objects or from one object to a second object and back. In the present case, the signal specifically may be one or more of an acoustic signal or an electromagnetic signal such as a light signal. A time-of-flight detector consequently refers to a detector adapted for performing a time-of-flight measurement. Time-of-flight measurements are well-known in various fields of technology such as in commercially available distance measurement devices or in commercially available flow meters, such as ultrasonic flow meters. Time-of-flight detectors even may be embodied as time-of-flight cameras. These types of cameras are commercially available as range-imaging camera systems, capable of resolving distances between objects based on the known speed of light.

Presently available ToF detectors generally are based on the use of a pulsed signal, optionally in combination with one or more light sensors such as CMOS-sensors. A sensor signal produced by the light sensor may be integrated. The integration may start at two different points in time. The distance may be calculated from the relative signal intensity between the two integration results.

Further, as outlined above, ToF cameras are known and may generally be used, also in the context of the present invention. These ToF cameras may contain pixelated light sensors. However, since each pixel generally has to allow for performing two integrations, the pixel construction generally is more complex and the resolutions of commercially available ToF cameras are rather low (typically 200×200 pixels). Distances below ˜40 cm and above several meters typically are difficult or impossible to detect. Furthermore, the periodicity of the pulses leads to ambiguous distances, as only the relative shift of the pulses within one period is measured.

ToF detectors, as standalone devices, typically suffer from a variety of shortcomings and technical challenges. Thus, in general, ToF detectors and, more specifically, ToF cameras suffer from rain and other transparent objects in the light path, since the pulses might be reflected too early, objects behind the raindrop are hidden, or in partial reflections the integration will lead to erroneous results. Further, in order to avoid errors in the measurements and in order to allow for a clear distinction of the pulses, low light conditions are preferred for ToF-measurements. Bright light such as bright sunlight can make a ToF-measurement impossible. Further, the energy consumption of typical ToF cameras is rather high, since pulses must be bright enough to be back-reflected and still be detectable by the camera. The brightness of the pulses, however, may be harmful for eyes or other sensors or may cause measurement errors when two or more ToF measurements interfere with each other. In summary, current ToF detectors and, specifically, current ToF-cameras suffer from several disadvantages such as low resolution, ambiguities in the distance measurement, limited range of use, limited light conditions, sensitivity towards transparent objects in the light path, sensitivity towards weather conditions and high energy consumption. These technical challenges generally lower the aptitude of present ToF cameras for daily applications such as for safety applications in cars, cameras for daily use or human-machine-interfaces, specifically for use in gaming applications.

In combination with the detector according to the present invention, the advantages and capabilities of both systems may be combined in a fruitful way. Thus, the detector may provide advantages at bright light conditions, while the ToF detector generally provides better results at low-light conditions. A combined device, i.e. a detector according to the present invention further including at least one ToF detector, therefore provides increased tolerance with regard to light conditions as compared to both single systems. This is especially important for safety applications, such as in cars or other vehicles.

Specifically, the detector may be designed to use at least one ToF measurement for correcting at least one measurement performed by using the detector according to the present invention and vice versa. Further, the ambiguity of a ToF measurement may be resolved by using the detector.

The at least one optional ToF detector may be combined with basically any of the embodiments of the detector according to the present invention. Specifically, the at least one ToF detector which may be a single ToF detector or a ToF camera, may be combined with a single optical sensor or with a plurality of optical sensors such as a sensor stack. Further, the detector may also comprise one or more imaging devices such as one or more inorganic imaging devices like CCD chips and/or CMOS chips, preferably one or more full-color CCD chips or full-color CMOS chips. Additionally or alternatively, the detector may further comprise one or more thermographic cameras.

As outlined above, the human-machine interface may comprise a plurality of beacon devices which are adapted to be at least one of directly or indirectly attached to the user and held by the user. Thus, the beacon devices each may independently be attached to the user by any suitable means, such as by an appropriate fixing device. Additionally or alternatively, the user may hold and/or carry the at least one beacon device or one or more of the beacon devices in his or her hands and/or by wearing the at least one beacon device and/or a garment containing the beacon device on a body part.

The beacon device generally may be an arbitrary device which may be detected by the at least one detector and/or which facilitates detection by the at least one detector. Thus, as outlined above or as will be outlined in further detail below, the beacon device may be an active beacon device adapted for generating the at least one light beam to be detected by the detector, such as by having one or more illumination sources for generating the at least one light beam. Additionally or alternatively, the beacon device may fully or partially be designed as a passive beacon device, such as by providing one or more reflective elements adapted to reflect a light beam generated by a separate illumination source. The at least one beacon device may permanently or temporarily be attached to the user in a direct or indirect way and/or may be carried or held by the user. The attachment may take place by using one or more attachment means and/or by the user himself or herself, such as by the user holding the at least one beacon device by hand and/or by the user wearing the beacon device.

Additionally or alternatively, the beacon devices may be at least one of attached to an object and integrated into an object held by the user, which, in the sense of the present invention, shall be included into the meaning of the option of the user holding the beacon devices. Thus, as will be outlined in further detail below, the beacon devices may be attached to or integrated into a control element which may be part of the human-machine interface and which may be held or carried by the user, and of which the orientation may be recognized by the detector device. Thus, generally, the present invention also refers to a detector system comprising at least one detector device according to the present invention and which, further, may comprise at least one object, wherein the beacon devices are one of attached to the object, held by the object and integrated into the object. As an example, the object preferably may form a control element, the orientation of which may be recognized by a user. Thus, the detector system may be part of the human-machine interface as outlined above or as outlined in further detail below. As an example, the user may handle the control element in a specific way in order to transmit one or more items of information to a machine, such as in order to transmit one or more commands to the machine.

Alternatively, the detector system may be used in other ways. Thus, as an example, the object of the detector system may be different from a user or a body part of the user and, as an example, may be an object which moves independently from the user. As an example, the detector system may be used for controlling apparatuses and/or industrial processes, such as manufacturing processes and/or robotics processes. Thus, as an example, the object may be a machine and/or a machine part, such as a robot arm, the orientation of which may be detected by using the detector system.

The human-machine interface may be adapted in such a way that the detector device generates at least one item of information on the position of the user or of at least one body part of the user. Specifically in case a manner of attachment of the at least one beacon device to the user is known, by evaluating the position of the at least one beacon device, at least one item of information on a position and/or an orientation of the user or of a body part of the user may be gained.

The beacon device preferably is one of a beacon device attachable to a body or a body part of the user and a beacon device which may be held by the user. As outlined above, the beacon device may fully or partially be designed as an active beacon device. Thus, the beacon device may comprise at least one illumination source adapted to generate at least one light beam to be transmitted to the detector, preferably at least one light beam having known beam properties. Additionally or alternatively, the beacon device may comprise at least one reflector adapted to reflect light generated by an illumination source, thereby generating a reflected light beam to be transmitted to the detector.

The object, which may form part of the detector system, may generally have an arbitrary shape. Preferably, the object being part of the detector system, as outlined above, may be a control element which may be handled by a user, such as manually. As an example, the control element may be or may comprise at least one element selected from the group consisting of: a glove, a jacket, a hat, shoes, trousers and a suit, a stick that may be held by hand, a bat, a club, a racket, a cane, a toy, such as a toy gun. Thus, as an example, the detector system may be part of the human-machine interface and/or of the entertainment device.

As used herein, an entertainment device is a device which may serve the purpose of leisure and/or entertainment of one or more users, in the following also referred to as one or more players. As an example, the entertainment device may serve the purpose of gaming, preferably computer gaming. Thus, the entertainment device may be implemented into a computer, a computer network or a computer system or may comprise a computer, a computer network or a computer system which runs one or more gaming software programs.

The entertainment device comprises at least one human-machine interface according to the present invention, such as according to one or more of the embodiments disclosed above and/or according to one or more of the embodiments disclosed below. The entertainment device is designed to enable at least one item of information to be input by a player by means of the human-machine interface. The at least one item of information may be transmitted to and/or may be used by a controller and/or a computer of the entertainment device.

The at least one item of information preferably may comprise at least one command adapted for influencing the course of a game. Thus, as an example, the at least one item of information may include at least one item of information on at least one orientation of the player and/or of one or more body parts of the player, thereby allowing for the player to simulate a specific position and/or orientation and/or action required for gaming. As an example, one or more of the following movements may be simulated and communicated to a controller and/or a computer of the entertainment device: dancing; running; jumping; swinging of a racket; swinging of a bat; swinging of a club; pointing of an object towards another object, such as pointing of a toy gun towards a target.

The entertainment device as a part or as a whole, preferably a controller and/or a computer of the entertainment device, is designed to vary the entertainment function in accordance with the information. Thus, as outlined above, a course of a game might be influenced in accordance with the at least one item of information. Thus, the entertainment device might include one or more controllers which might be separate from the evaluation device of the at least one detector and/or which might be fully or partially identical to the at least one evaluation device or which might even include the at least one evaluation device. Preferably, the at least one controller might include one or more data processing devices, such as one or more computers and/or microcontrollers.

As further used herein, a tracking system is a device which is adapted to gather information on a series of past positions of the at least one object and/or at least one part of the object. Additionally, the tracking system may be adapted to provide information on at least one predicted future position and/or orientation of the at least one object or the at least one part of the object. The tracking system may have at least one track controller, which may fully or partially be embodied as an electronic device, preferably as at least one data processing device, more preferably as at least one computer or microcontroller. Again, the at least one track controller may fully or partially comprise the at least one evaluation device and/or may be part of the at least one evaluation device and/or may fully or partially be identical to the at least one evaluation device.

The tracking system comprises at least one detector according to the present invention, such as at least one detector as disclosed in one or more of the embodiments listed above and/or as disclosed in one or more of the embodiments below. The tracking system further comprises at least one track controller. The track controller is adapted to track a series of positions of the object at specific points in time, such as by recording groups of data or data pairs, each group of data or data pair comprising at least one position information and at least one time information.

The tracking system may further comprise the at least one detector system according to the present invention. Thus, besides the at least one detector and the at least one evaluation device and the optional at least one beacon device, the tracking system may further comprise the object itself or a part of the object, such as at least one control element comprising the beacon devices or at least one beacon device, wherein the control element is directly or indirectly attachable to or integratable into the object to be tracked.

The tracking system may be adapted to initiate one or more actions of the tracking system itself and/or of one or more separate devices. For the latter purpose, the tracking system, preferably the track controller, may have one or more wireless and/or wire-bound interfaces and/or other types of control connections for initiating at least one action. Preferably, the at least one track controller may be adapted to initiate at least one action in accordance with at least one actual position of the object. As an example, the action may be selected from the group consisting of: a prediction of a future position of the object; pointing at least one device towards the object; pointing at least one device towards the detector; illuminating the object; illuminating the detector.

As an example of application of a tracking system, the tracking system may be used for continuously pointing at least one first object to at least one second object even though the first object and/or the second object might move. Potential examples, again, may be found in industrial applications, such as in robotics and/or for continuously working on an article even though the article is moving, such as during manufacturing in a manufacturing line or assembly line. Additionally or alternatively, the tracking system might be used for illumination purposes, such as for continuously illuminating the object by continuously pointing an illumination source to the object even though the object might be moving. Further applications might be found in communication systems, such as in order to continuously transmit information to a moving object by pointing a transmitter towards the moving object.

The detector, the detector system, the human machine interface, the entertainment device or the tracking system may further comprise at least one illumination source or may be used in conjunction with at least one illumination source. Specifically, the at least one illumination source may be or may comprise at least one structured or patterned illumination source. The use of a structured illumination source may increase a resolution of the position detection of the object and/or may increase a contrast.

The proposed devices and methods provide a large number of advantages over known detectors of this kind. Thus, the detector may be realized as a simple device combining the functionality of distance measurement or measurement of z-coordinates, with the additional option of measuring transversal coordinates, thereby integrating the functionality of a PSD device. The detector simply may employ a sheet of fluorescent material and four dot-shaped or, preferably, stripe-shaped diodes at the edges of the fluorescent sheet. Additionally, one or more reference photosensitive elements may be provided. The fluorescent sheet may be used as a luminescent collector, which means the fluorescent light from the light spot location may be guided in the waveguide modes of the fluorescent material sheet. This concept is generally known to the skilled person in the art of solar cells, such as in the art of concentrator solar cells.

To measure the at least one transversal coordinate, such as the xy-coordinate of the light spot and/or of the object, four transversal sensor signals of the dot-shaped or, preferably, stripe-shaped photosensitive elements at the edges may be measured. A relationship between the signal amplitudes may indicate the xy-coordinate. For the purpose of signal evaluation, a phase-sensitive electronic element which, in particular, uses a lock-in based technique, maybe used. Further, a light spot close to a photosensitive element will yield a stronger signal at this photosensitive element, as compared to the other photosensitive elements. This may be a combined effect of the waveguide attenuation and the geometric fill factor of illumination of the photosensitive element, since, typically, a light spot close to a detector sees more of the fluorescence light, because the light is emitted in a circle and the detector close to the light spot sees a larger angle.

A summation of the transversal sensor signals, such as of the four photodiode signals, will typically yield a signal that is smaller for smaller focus size and larger for larger size, if the same amount of power is in the light beam. If the power of the light beam is unknown, the at least one optional reference photosensitive element may be used. Thus, as an example, another photodiode behind the fluorescent sheet may be used to provide a reference signal. Generally, one or more filter elements, such as one or more short-pass filters, may be used to exclude fluorescence light from the at least one reference photosensitive element. Preferably, the fluorescent waveguiding sheet is transparent. Due to the transparency of the fluorescent waveguiding sheet, the at least one reference photosensitive element simply may be placed behind the fluorescent waveguiding sheet. Specifically, a transparency of the fluorescent waveguiding sheet is much simpler to achieve as compared to achieving transparency in an ordinary photodetector such as in organic or inorganic photodiodes or solar cells.

The optical sensor may comprise a plurality of photodiodes. The photosensitive elements may be located at the edges, such as straight edges, e.g. rim portions, and/or corners and/or at one or more other surfaces of the fluorescent waveguiding sheet, such as by placing these photosensitive elements very close to the straight edges and/or corners. Further, the fluorescent waveguiding sheet generally may be designed in a fully or partially transparent fashion. Thereby, the at least one optical sensor may be generated as a fully or partially transparent PSD. No further PSD may be required within the detector.

The outcoupling of the fluorescence light out of the fluorescent waveguiding sheet, as outlined above, may take place in a very simple fashion, such as by using a drop of glue, an etching, a scratch, or the like. Outcoupling may take place specifically close to straight edges and/or corners of the fluorescent waveguiding sheet.

Referring to the photosensitive elements, these photosensitive elements, as an example, may be rendered very small or even spot-like. Generally, in the art of electronics, a small size of the photodiodes renders photodiodes very fast, generally due to the lower electrical capacitance. Additionally or alternatively, however, other types of photosensitive elements may be used, such as strip-shaped photodiodes.

As already mentioned above, the possibility of locating a (semi-)transparent PSD device within the same beam path in front of at least one FiP sensor may constitute a specific advantage of the present arrangement as this feature may, in contrast to commonly available PSD devices as described above, be realized with the PSD comprising a transparent fluorescent waveguiding sheet according to the present invention. Further, this combination may be suited for a simultaneous 3D determination of more than one object or more than one parts thereof. As a result, such a combination of the (semi-)transparent PSD device with the FiP sensor may, particularly, be suited for providing detectors which may realize 3D-sensing concepts exhibiting an improved performance with respect to one or more of miniaturization, robustness, determination time, determination accuracy, and cost effectiveness.

Overall, in the context of the present invention, the following embodiments are regarded as preferred:

Embodiment 1: A detector for determining a position of at least one object, the detector comprising:
at least one longitudinal optical sensor for determining a longitudinal position of at least one light beam traveling from the object to the detector, wherein the longitudinal optical sensor has at least one longitudinal sensor region forming a longitudinal sensitive area, wherein the longitudinal optical sensor is designed to generate at least one longitudinal sensor signal in a manner dependent on an illumination of the longitudinal sensitive area region by the light beam, wherein the longitudinal sensor signal, given the same total power of the illumination, is dependent on a beam cross-section of the light beam in the longitudinal sensitive area;
at least one transversal optical sensor for determining at least one transversal position of the at least one light beam traveling from the object to the detector, comprising
   at least one fluorescent waveguiding sheet forming a transversal sensitive area, wherein the fluorescent waveguiding sheet is oriented towards the object such that the at least one light beam propagating from the object towards the detector generates at least one light spot in the transversal sensitive area, wherein the fluorescent waveguiding sheet contains at least one fluorescent material, wherein the fluorescent material is adapted to generate fluorescence light in response to the illumination by the light beam,
   at least two photosensitive elements located at at least two edges of the fluorescent waveguiding sheet capable of detecting fluorescence light guided from the light spot towards the photosensitive elements by the fluorescent waveguiding sheet and capable of generating transversal sensor signals; and
at least one evaluation device, the evaluation device being configured to determine at least one longitudinal coordinate z of the object by evaluating the longitudinal sensor signals, and wherein the evaluation device is further configured to determine at least one transversal coordinate x, y of the object by evaluating the transversal sensor signals of the photosensitive elements.

Embodiment 2: The detector according to the preceding embodiment, wherein the total power of the fluorescence light nonlinearly depends on the intensity of the illumination by the light beam.

Embodiment 3: The detector according to any one of the two preceding embodiments, wherein the evaluation device is configured to determine the at least one longitudinal coordinate z of the object by using at least one predetermined relationship between the longitudinal sensor signal and the longitudinal coordinate z.

Embodiment 4 The detector according to any one of the preceding embodiments, wherein the transversal optical sensor further comprises at least one optical filter element, preferably at least one optical short-pass filter.

Embodiment 5: The detector according to any one of the preceding embodiments, wherein the transversal optical sensor further comprises at least one reference photosensitive element, wherein the reference photosensitive element is arranged to detect light of the light beam after passing the fluorescent waveguiding sheet and to generate at least one reference sensor signal.

Embodiment 6: The detector according to the preceding embodiment, wherein the evaluation device is adapted to take into account the reference sensor signal for determining the position of the object, preferably for determining at least one transversal coordinate x, y of the object.

Embodiment 7: The detector according to any one of the preceding embodiments, wherein the evaluation device comprises at least one subtracting device configured to form at least one difference signal D between the transversal sensor signals generated by at least two of the photosensitive elements.

Embodiment 8: The detector according to the preceding embodiment, wherein the transversal sensor signals comprise at least one first sensor signal si and at least one second sensor signal s₂, wherein the at least one difference signal D is proportional to a·s₁−b·s₂, with a, b being real number coefficients, preferably with a=1 and b=1.

Embodiment 9: The detector according to the preceding embodiment, wherein the at least one difference signal D is derived according to the formula D=(a·s₁−b·s₂)/(a·s₁+b·s₂).

Embodiment 10: The detector according to any one of the three preceding embodiments, wherein the subtracting device is configured to form at least one first difference signal Dₓ from which at least one first transversal coordinate x of the object is derived, wherein the subtracting device is further configured to form at least one second difference signal D_{y} from which at least one second transversal coordinate y of the object is derived.

Embodiment 11: The detector according to the preceding embodiment, wherein the first difference signal Dₓ is generated from at least two sensor signals sₓ₁, sₓ₂ of at least two photosensitive elements located at opposing edges of the waveguiding sheet in a first dimension, and wherein the second difference signal D_{y} is generated from at least two sensor signals s_{y1}, s_{y2} of at least two photosensitive elements located at opposing edges of the waveguiding sheet in a second dimension.

Embodiment 12: The detector according to the preceding embodiment, wherein the at least one first difference signal Dₓ is derived according to the formula Dₓ=(a·sₓ₁−b·sₓ₂)/(a·sₓ₁+b·sₓ₂), and wherein the at least one second difference signal D_{y} is derived according to the formula D_{y}=(c·s_{y1}−d·s_{y2})/(c·s_{y1}+d·s_{y2}), with a, b, c, d being real number coefficients, preferably with a=1, b=1, c=1 and d=1.

Embodiment 13: The detector according to any one of the preceding embodiments, wherein the photosensitive elements comprise at least two photosensitive elements located at opposing edges of the fluorescent waveguiding sheet.

Embodiment 14: The detector according to any one of the preceding embodiments, wherein the photosensitive elements comprise at least one first pair of photosensitive elements located at opposing edges of the fluorescent waveguiding sheet in a first dimension of a coordinate system, wherein the photosensitive elements further comprise at least one second pair of photosensitive elements located at opposing edges of the fluorescent waveguiding sheet in a second dimension of the coordinate system.

Embodiment 15: The detector according to any one of the preceding embodiments, wherein the photosensitive elements comprise at least two photosensitive elements located at opposing edges, preferably straight edges, e.g. straight rim portions, of the fluorescent waveguiding sheet.

Embodiment 16: The detector according to any one of the preceding embodiments, wherein the photosensitive elements comprise at least one first pair of photosensitive elements located at opposing edges of the fluorescent waveguiding sheet in a first dimension of a coordinate system, wherein the fluorescent elements further comprise at least one second pair of photosensitive elements located at opposing edges of the fluorescent waveguiding sheet in a second dimension of the coordinate system.

Embodiment 17: The detector according to any one of the preceding embodiments, wherein the longitudinal sensitive area is a homogeneous sensitive area.

Embodiment 18: The detector according to any one of the preceding embodiments, wherein the longitudinal sensitive area has a surface of at least 5 mm², preferably of at least 10 mm², more preferably of at least 100 mm², more preferably of at least 400 mm².

Embodiment 19: The detector according to any one of the preceding embodiments, wherein the transversal sensitive area is a homogeneous sensitive area.

Embodiment 20: The detector according to any one of the preceding embodiments, wherein the transversal sensitive area has a surface of at least 5 mm², preferably of at least 10 mm², more preferably of at least 100 mm², more preferably of at least 400 mm².

Embodiment 21: The detector according to any one of the preceding embodiments, wherein the longitudinal optical sensor and the transversal optical sensor are arranged in a manner that lateral dimensions of the longitudinal sensitive area and the transversal sensitive area are identical within a factor between 0.1 and 10.

Embodiment 22: The detector according to any one of the preceding embodiments, wherein the longitudinal sensitive area is oriented in a parallel arrangement with respect to the transversal sensitive area.

Embodiment 23: The detector according to any one of the preceding embodiments, wherein the fluorescent waveguiding sheet comprises at least one planar sheet.

Embodiment 24: The detector according to any one of the preceding embodiments, wherein the fluorescent waveguiding sheet has a thickness of 10 μm to 3 mm, preferably a thickness of 100 μm to 1 mm, such as a thickness of 50 μm to 2 mm.

Embodiment 25: The detector according to any one of the preceding embodiments, wherein the fluorescent waveguiding sheet is flexible or deformable.

Embodiment 26: The detector according to any one of the preceding embodiments, wherein the fluorescent waveguiding sheet comprises at least one matrix material, wherein the at least one fluorescent material is one or more of mixed into the matrix material, dispersed into the matrix material, chemically bound to the matrix material or dissolved in the matrix material.

Embodiment 27: The detector according to the preceding embodiment, wherein the matrix material comprises at least one plastic material.

Embodiment 28: The detector according to the preceding embodiment, wherein the plastic material comprises at least one polymer material.

Embodiment 29: The detector according to any one of the two preceding embodiments, wherein the plastic material comprises at least one material selected from the group consisting of: a polycarbonate, a poly(methyl methacrylate), a polystyrene, a polyurethane, a polypropylene, a polyethylene terephthalate, a polyvinylchloride.

Embodiment 30: The detector according to any one of the preceding embodiments, wherein the fluorescent material comprises at least one fluorescent colorant, preferably at least one fluorescent dye, more preferably, wherein the fluorescent material is a fluorescent colorant, preferably a fluorescent dye.

Embodiment 31: The detector according to the preceding embodiment, wherein the fluorescent dye is capable of being saturated by the light beam, such that a total power of the fluorescence light generated by the fluorescent dye is a nonlinear function of an intensity of the light beam.

Embodiment 32: The detector according to the preceding embodiment, wherein the total power of the fluorescence light is sub-proportional to the intensity of the light beam.

Embodiment 33: The detector according to any one of the three preceding embodiments, wherein the fluorescent dye comprises at least one organic fluorescent dye.

Embodiment 34: The detector according to any one of the four preceding embodiments, wherein the fluorescent dye is selected from the group consisting of: a xanthene derivative, preferably one or more of fluorescein, rhodamine, oregon green, eosin, texas red, or a derivative of any component thereof; a cyanine derivative, preferably one or more of cyanine, indocarbocyanine, oxacarbocyanine, thiacarbocyanine, merocyanine, or a derivative of any component thereof; a squaraine derivative or a ring-substituted squaraine, preferably one or more of Seta, SeTau, and Square dyes, or a derivative of any component thereof; a naphthalene derivative, preferably one or more of a dansyl or a prodan derivative thereof; a coumarin derivative; a oxadiazole derivative, preferably one or more of pyridyloxazole, nitrobenzoxadiazole, benzoxadiazole, or a derivative of any component thereof; an anthracene derivative, preferably one or more of an anthraquinone, DRAQS, DRAQ7, CyTRAK orange, or a derivative of any component thereof; a pyrene derivative, preferably cascade blue; an oxazine derivative, preferably one or more of nile red, nile blue, cresyl violet, oxazine 170, or a derivative of any component thereof; an acridine derivative, preferably one or more of proflavin, acridine orange, acridine yellow, or a derivative of any component thereof; an arylmethine derivative, preferably one or more of auramine, crystal violet, malachite green, or a derivative of any component thereof; a tetrapyrrole derivative, preferably one or more of porphin, phthalocyanine, bilirubin; a rylene dye or any derivative thereof, such as a perylene dye; a naphthalene imid or perylene imide; a naphthoilene benzimidazole dye such as published in WO 2012/168395 Al; or a derivative of any component thereof.

Embodiment 35: The detector according to the preceding embodiment, wherein the absorption maximum is measured with the colorant embedded into the matrix material.

Embodiment 36: The detector according to one of the two preceding embodiments, wherein the absorption maximum is an absolute maximum over the range of 400 nm to 900 nm.

Embodiment 37: The detector according to any one of the preceding embodiments, wherein the fluorescent material comprises at least one fluorescent colorant, wherein the fluorescent colorant, in the range of 400 nm to 900 nm, has an absorption maximum in the wavelength range of 550 nm to 850 nm.

Embodiment 38: The detector according to any one of the preceding embodiments, wherein the fluorescent material comprises at least one fluorescent colorant, wherein the fluorescent colorant, in the range of 400 nm to 900 nm, has an absorption maximum in the range of 600 nm to 800 nm.

Embodiment 39: The detector according to any one of the preceding embodiments, wherein the fluorescent material comprises at least one fluorescent colorant, wherein the fluorescent colorant is selected from the group consisting of stilbenes, benzoxazoles, squaraines, bisdiphenylethylenes, merocyanines, coumarins, benzopyrans, naphthalimides, rylenes, phthalocyanines, naphthalocyanines, cyanines, xanthenes, oxazines, oxadiazols, squaraines, oxadiols, anthrachinones, acridines, arylmethanes, boron-dipyrromethenes, Aza-boron-dipyrromethenes, violanthrons, isoviolanthrons and diketopyrrolopyrrols.

Embodiment 40: The detector according to any one of the preceding embodiments, wherein the fluorescent material comprises at least one fluorescent colorant, wherein the fluorescent colorant is selected from the group consisting rylenes, phthalocyanines, naphthalocyanines, cyanines, xanthenes, oxazines, boron-dipyrromethenes, aza-boron-dipyrromethenes and diketopyrrolopyrrols.

Embodiment 41: The detector according to any one of the preceding embodiments, wherein the fluorescent material comprises at least one fluorescent colorant, wherein the fluorescent colorant is a rylene colorant, preferably wherein the colorant is selected from the group consisting of compound 1 of Table 1, Compound 2 of Table 1, Compound 3 of Table 1, compound 15 of Table 1, compound 16 of Table 1, compound 17 of Table 1 and compound 4 of Table 1, Embodiment 42: The detector according to any one of the preceding embodiments, wherein the fluorescent material comprises at least one fluorescent colorant wherein the colorant is selected from the group consisting of compound 1 of Table 1, Compound 2 of Table 1, Compound 3 of Table 1, and compound 4 of Table 1, preferably wherein the colorant is the compound 3 of Table 1 or the compound 4 of Table 1, with compound 4 (2,13-Bis[2,6-bis(1-methylethyl)phenyl]-5,10,16,21-tetrakis[4-(1,1,3,3-tetramethylbutyl)phenoxy]-anthra[9″,1″,2″:6,5,10;10″,5″,6″:6′,5′,10′]dianthra[2′,1′,9′-d′e′f′]diisoquinoline-1,3,12,14(2H,13H)-tetrone) being particularly preferred.

Embodiment 43: The detector according to any one of the preceding embodiments, wherein the fluorescent material comprises at least one fluorescent colorant, wherein the fluorescent colorant is a naphthalimide colorant, and wherein the colorant has preferably a structure according to the following formula,

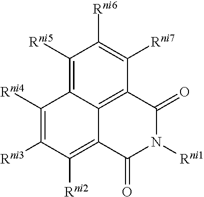

wherein Rⁿⁱ², Rⁿⁱ³, Rⁿⁱ⁴, Rⁿⁱ⁵, Rⁿⁱ⁶ and Rⁿⁱ⁷, are independently of each other, selected from the group consisting of H, alkyl, aryl, heteroalkyl, heteroaryl, alkoxy, cycloalkyl, heterocycloalkyl, alkylamin (Alkyl-NH—), arylamine (Aryl-NH—), alkylarylamin (Aryl-Alkyl-NH—), heteroarylamine (Heteroaryl-NH—) and heteroalkylarylamin (Heteroaryl-Alkyl-NH—), and wherein preferably at least one of Rⁿⁱ², Rⁿⁱ³, Rⁿⁱ⁴, Rⁿⁱ⁵, Rⁿⁱ⁶ and Rⁿⁱ⁷ is selected from the group alkylamin (Alkyl-NH—), arylamine (Aryl-NH—), alkylarylamin (Aryl-Alkyl-NH—), heteroarylamine (Heteroaryl-NH—), heteroalkylarylamin and (Heteroaryl-Alkyl-NH—).

Embodiment 44: The detector according to any one of the preceding embodiments, wherein the fluorescent material comprises at least one fluorescent colorant, wherein the fluorescent colorant is a phthalocyanine colorant, which is preferably selected from the group consisting of compound 5, compound 6, compound 7, compound 8, compound 9, compound 10 and compound 14 of Table 1, more preferably the phthalocyanine colorant is the compound 14 of Table 1 or the compound 10 of Table 1, most preferably, the phthalocyanine colorant is the compound 14 of Table 1.

Embodiment 45: The detector according to any one of the preceding embodiments, wherein the fluorescent material comprises at least one fluorescent colorant, wherein the fluorescent colorant is a naphthalocyanine colorant.

Embodiment 46: The detector according to any one of the preceding embodiments, wherein the fluorescent material comprises at least one fluorescent colorant, wherein the fluorescent colorant is a cyanine having the structure (Ic) or (IIc),

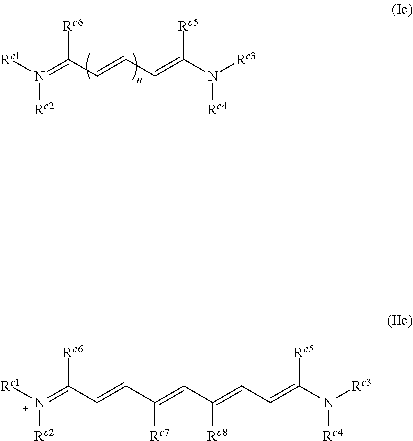

wherein R^{c2} and R^{c4}, are independently of each other selected from the group consisting of alkyl, heteroalkyl, cycloalkyl, heterocycloalkyl, aryl and heteroaryl, and wherein R^{c1} is selected from the group consisting of alkyl, heteroalkyl, cycloalkyl, heterocycloalkyl, aryl and heteroaryl or forms together with R^{c6} an, optionally substituted, cyclic ring, such as cycloalkyl, heterocycloalkyl, aryl or heteroaryl ring, and wherein R^{c3} is selected from the group consisting of alkyl, heteroalkyl, cycloalkyl, heterocycloalkyl, aryl and heteroaryl or forms together with R^{c4} an, optionally substituted, cyclic ring, such as a cycloalkyl, heterocycloalkyl, aryl or heteroaryl ring, and wherein R^{c6} is selected from the group consisting of H, alkyl, heteroalkyl, cycloalkyl, heterocycloalkyl, aryl and heteroaryl or forms together with R^{c1} an, optionally substituted, cyclic ring, such as a cycloalkyl, heterocycloalkyl, aryl or heteroaryl ring, and wherein R^{c5} is selected from the group consisting of H, alkyl, heteroalkyl, cycloalkyl, heterocycloalkyl, aryl and heteroaryl or forms together with R^{c5} an, optionally substituted, cyclic ring, such as an cycloalkyl, heterocycloalkyl, aryl or heteroaryl ring and wherein R^{c2} and R^{c4}, are, independently of each other, selected from the group consisting of H, alkyl and cycloalkyl or form a cyclic ring with one another, and wherein n is an integer in the range of from 1 to 10, preferably 1 to 10, more preferably 1 to 5, most preferably n is 2, preferably, wherein the cyanine colorant according to the invention has a structure according formula (Icₐ) or (IIc_{b}), more preferably according to (Icₐ).

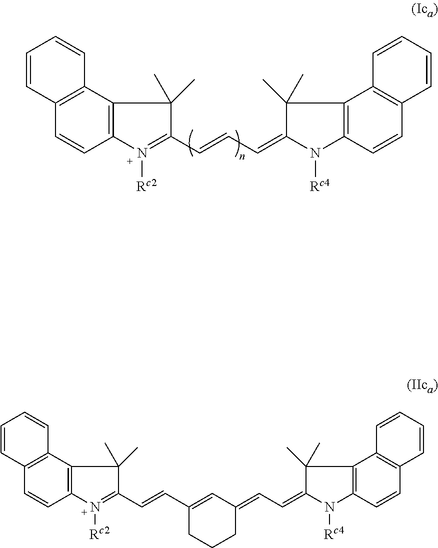

wherein R^{c4} is methyl or butyl, and wherein R^{c2} is butyl or —C5H10—COOH, more preferably wherein both, R^{c2} and R^{c4} are butyl, with n being preferably of from 1 to 5, more preferably 2, and wherein the cyanine colorant is more preferably S 0315 (3-Butyl-2-[5-(3-butyl-1,3-dihydro-1,1-dimethyl-2H-benzo[e]indol-2-ylidene)-penta-1,3-dienyl]-1,1-dimethyl-1H-benzo[e]indolium perchlorate) or S 0944 (1,3,3-Trimethyl-2-[5-(1,3,3-trimethyl-1,3-dihydro-indol-2-ylidene)-penta-1,3-dienyl]-3Hindolium chloride), more preferably S 0315.

Embodiment 47: The detector according to any one of the preceding embodiments, wherein the fluorescent material comprises at least one fluorescent colorant, wherein the fluorescent colorant is a xanthene colorant, preferably a rhodamine colorant, more preferably the colorant having the structure:

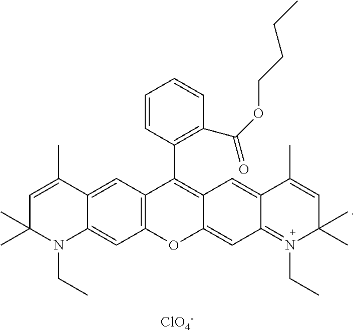

Embodiment 48: The detector according to any one of the preceding embodiments, wherein the fluorescent material comprises at least one fluorescent colorant, wherein the fluorescent colorant is selected from the group consisting of Compound 1 of Table 1, Compound 2 of Table 1, Compound 3 of Table 1, Compound 4 of Table 1, Compound 5 of Table 1, Compound 6 of Table 1, Compound 7 of Table 1, Compound 8 of Table 1, Compound 9 of Table 1, Compound 10 of Table 1, Compound 11 of Table 1, Compound 12 of Table 1, Compound 13 of Table 1, Compound 14 of Table 1, Compound 15 of Table 1, Compound 16 of Table 1, Compound 17 of Table 1, Compound 18 of Table 1, Compound 19 of Table 1 and Compound 20 of Table 1, preferably wherein the fluorescent colorant is selected from the group consisting of Compound 1 of Table 1, Compound 2 of Table 1, Compound 3 of Table 1, Compound 4 of Table 1, Compound 5 of Table 1, Compound 6 of Table 1, Compound 7 of Table 1, Compound 8 of Table 1, Compound 9 of Table 1, Compound 10 of Table 1, Compound 11 of Table 1, Compound 12 of Table 1, Compound 13 of Table 1 and Compound 14 of Table 1.

Embodiment 49: The detector according to any one of the preceding embodiments, wherein the fluorescent material comprises at least one fluorescent colorant, wherein the fluorescent colorant is selected from the group consisting of Compound 3 of Table 1, Compound 14 of Table 1, Compound 11 of Table 1, and Compound 5 of Table 1, with Compound 4 of Table 1, being particularly preferred.

Embodiment 50: The detector according to any one of the preceding embodiments, wherein the photosensitive elements comprise at least one photodiode, preferably at least one inorganic photodiode.

Embodiment 51: The detector according to any one of the preceding embodiments, wherein the photosensitive elements comprise at least one dot-shaped photosensitive element located at a corner and/or along an edge of the waveguiding sheet.

Embodiment 52: The detector according to any one of the preceding embodiments, wherein the photosensitive elements comprise at least one elongated photosensitive element extending along at least one segment of an edge, e.g. at a rim portions, of the waveguiding sheet.

Embodiment 53: The detector according to any one of the preceding embodiments, wherein the fluorescent waveguiding sheet is a rectangular fluorescent waveguiding sheet, preferably a square fluorescent waveguiding sheet, wherein photosensitive elements are located at each of the four edges of the waveguiding sheet.

Embodiment 54: The detector according to any one of the preceding embodiments, wherein the light beam originates from the object or from at least one illumination source, wherein the illumination source is integrated or attached to the object emitting the light beam is a different illumination source directly or indirectly illuminating the object

Embodiment 55: The detector according to the preceding embodiment, wherein the illumination source emits light in a wavelength range covering the range of 400 nm to 900 nm, more preferred the range of 550 nm to 850 nm, in particular, the range of 600 nm to 800 nm, where the fluorescent material exhibits an absorption maximum.

Embodiment 56: The detector according to any one of the preceding embodiments, wherein the longitudinal optical sensor is furthermore designed in a manner that the longitudinal sensor signal and/or the transversal sensor signal is dependent on a modulation frequency of a modulation of the illumination.

Embodiment 57: The detector according to any one of the preceding embodiments, wherein the detector is configured to detect at least two longitudinal sensor signals at respectively different modulation frequencies, wherein the evaluation device is configured to determine the longitudinal coordinates by evaluating the at least two longitudinal sensor signals.

Embodiment 58: The detector according to any one of the preceding embodiments, wherein the detector is configured to detect at least two transversal sensor signals at respectively different modulation frequencies, wherein the evaluation device is configured to determine the transversal coordinates by evaluating the at least two transversal sensor signals.

Embodiment 59: The detector according to any one of the preceding embodiments, wherein the light beam is a modulated light beam.

Embodiment 60: The detector according to any one of the preceding embodiments, wherein the detector furthermore has at least one modulation device for modulating the illumination.

Embodiment 61: The detector according to any one of the preceding embodiments, wherein the detector further comprises at least one transfer device, the transfer device being adapted to guide the light beam onto the optical sensor.

Embodiment 62: The detector according to the preceding embodiment, wherein the transfer device comprises one or more of: at least one lens, preferably at least one focus-tunable lens; at least one beam deflection element, preferably at least one mirror; at least one beam splitting element, preferably at least one of a beam splitting cube or a beam splitting mirror; at least one multi-lens system.

Embodiment 63: A detector system for determining a position of at least one object, the detector system comprising at least one detector according to any one of the preceding embodiments, the detector system further comprising at least one beacon device adapted to direct at least one light beam towards the detector, wherein the beacon device is at least one of attachable to the object, holdable by the object and integratable into the object.

Embodiment 64: A human-machine interface for exchanging at least one item of information between a user and a machine, wherein the human-machine interface comprises at least one detector system according to the preceding embodiment, wherein the at least one beacon device is adapted to be at least one of directly or indirectly attached to the user and held by the user, wherein the human-machine interface is designed to determine at least one position of the user by means of the detector system, wherein the human-machine interface is designed to assign to the position at least one item of information.

Embodiment 65: An entertainment device for carrying out at least one entertainment function, wherein the entertainment device comprises at least one human-machine interface according to the preceding embodiment, wherein the entertainment device is designed to enable at least one item of information to be input by a player by means of the human-machine interface, wherein the entertainment device is designed to vary the entertainment function in accordance with the information.

Embodiment 66: A tracking system for tracking a position of at least one movable object, the tracking system comprising at least one detector system according to any one of the preceding embodiments referring to a detector system, the tracking system further comprising at least one track controller, wherein the track controller is adapted to track a series of positions of the object at specific points in time.

Embodiment 67: A scanning system for determining at least one position of at least one object, the scanning system comprising at least one detector according to any of the preceding embodiments referring to a detector, the scanning system further comprising at least one illumination source adapted to emit at least one light beam configured for an illumination of at least one dot located at at least one surface of the at least one object, wherein the scanning system is designed to generate at least one item of information about the distance between the at least one dot and the scanning system by using the at least one detector.

Embodiment 68: A camera for imaging at least one object, the camera comprising at least one detector according to any one of the preceding embodiments referring to a detector.

Embodiment 69: A method for determining a position of at least one object by using at least one detector, specifically the detector according to any one of the preceding embodiments referring to a detector, the method comprising the following steps:
illuminating at least one longitudinal sensitive area in at least one longitudinal sensor region of at least one longitudinal optical sensor in a manner that at least one longitudinal sensor signal being dependent on an illumination of the longitudinal sensitive area by the light beam is generated, wherein the longitudinal sensor signal, given the same total power of the illumination, is dependent on a beam cross-section of the light beam in the longitudinal sensitive area;
illuminating at least one transversal sensitive area of at least one fluorescent wave-guiding sheet of at least one optical sensor of the detector with the at least one light beam propagating from the object towards the detector, wherein the light beam generates at least one light spot in the transversal sensitive area, wherein the fluorescent waveguiding sheet contains at least one fluorescent material;
generating fluorescence light in response to the illumination by the light beam by the fluorescent waveguiding sheet;
guiding the fluorescence light from the light spot towards at least two photosensitive elements located at at least two edges of the fluorescent waveguiding sheet;
detecting the fluorescence light by using the photosensitive elements and generating transversal sensor signals;
evaluating the longitudinal sensor signal by using at least one evaluation device and determining at least one longitudinal coordinate z of the object; and
evaluating the transversal sensor signals of the photosensitive elements by using at least one evaluation device and determining at least one transversal coordinate x, y of the object thereof.

Embodiment 70: The method according to the preceding embodiment, wherein the method further comprises distinguishing between at least two individual light beams illuminating the longitudinal sensitive area and/or the transversal sensitive area by evaluating the dependency on the modulation frequency of the longitudinal sensor signal and/or of the transversal sensor signals by using the evaluation device.

Embodiment 71: A use of the detector according to any one of the preceding embodiments relating to a detector, for a purpose of use, selected from the group consisting of: a position measurement in traffic technology; an entertainment application; a security application; a surveillance application; a safety application; a human-machine interface application; a tracking application; a photography application; a use in combination with at least one time-of-flight detector; a use in combination with a structured light source; a use in combination with a stereo camera; a machine vision application; a robotics application; a quality control application; a manufacturing application; a use in combination with a structured illumination source; a use in combination with a stereo camera.

### BRIEF DESCRIPTION OF THE FIGURES

Further optional details and features of the invention are evident from the description of preferred exemplary embodiments which follows in conjunction with the dependent claims. In this context, the particular features may be implemented alone or with several in combination. The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIGS. 1A and 1B show different views of an exemplary embodiment of a transversal partition of a detector according to the present invention, in a top view onto a transversal sensitive area (FIG. 1A) and in a cross-sectional view (FIG. 1B);

FIG. 2 shows a top view onto the transversal sensitive area of FIG. 1A, with a light spot generated by a light beam;

FIG. 3 shows an exemplary schematic setup of an evaluation device; and

FIG. 4 shows an exemplary embodiment of a detector, a detector system, a human-machine interface, an entertainment device and a tracking system according to the present invention.

FIG. 5: Overview over absorption spectra of experiments Nos. 1.1, 2.1-2.4, i.e. with Compounds 1, 2, 3 and 4 (see examples I.1 and I.2)

FIG. 6: Absorption spectrum of experiment No 1.1. (see example I.1, Compound 4)

FIG. 7: Absorption spectrum of experiment No 2.3. (see example I.2, Compound 3)

FIG. 8: Absorption spectrum of experiment No 2.1. (see example I.2, Compound 1)

FIG. 9: Absorption spectrum of experiment No 2.2 (see example I.2, Compound 2)

FIG. 10: Absorption and emission spectra measured on plastic films with compound 1 and compound 2 of Table 1 (experiments Nos 2.1-2.2).

FIG. 11: Absorption and emission spectra measured on plastic films with compound 1 and compound 2 of Table 1 (experiments Nos 2.1-2.2).

FIG. 12: Absorption spectrum of experiment No 1.2. (see example I.1, Compound 11)

FIG. 13: Overview over absorption specta of experiments Nos. 1.3-1.10 (see example I.1)

FIG. 14: Absorption spectrum of experiment No 1.5 (see example I.1).

FIG. 15: Absorption spectrum of experiment No 1.3 (see example I.1).

FIG. 16: Absorption spectrum of experiment No 1.9. (see example I.1)

FIG. 17: Absorption spectrum of experiment No 1.4 (see example I.1)

FIG. 18: Absorption spectrum of experiment No 1.10 (see example I.1)

FIG. 19: Absorption spectrum of experiment No 1.6 (see example I.1)

FIG. 20: Absorption spectrum of experiment No 1.8 (see example I.1)

FIG. 21: Absorption spectrum of experiment No 1.7 (see example I.1)

FIG. 22: Determination of the absorption of a plastic sheet with 0.02% Lumogen F (see example III)

FIG. 23-FIG. 30: Evaluation of the properties of plastic sheets incorporating 0.02% of various fluorescent colorants according to example IV.

TABLE 1
Preferred Fluorescent Colorants

| Compound | Chemical Structure |
|---|---|
| 1 | 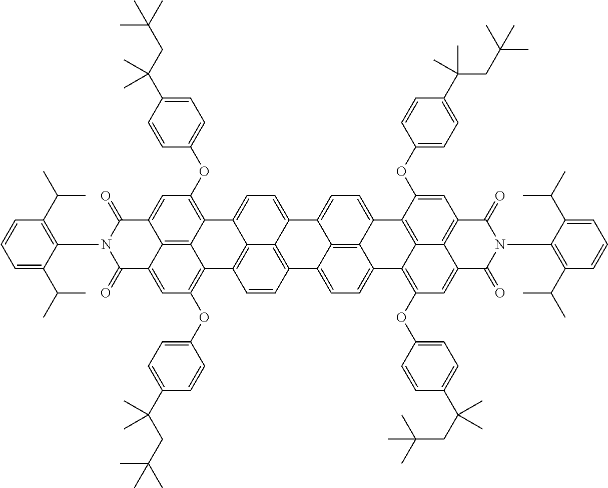 [SMILES: CC(C)c1cccc(C(C)C)c1N1C(=O)c2cc(Oc3ccc(C(C)(C)CC(C)(C)C)cc3)c3c4ccc5c6ccc7c8c(Oc9ccc(C(C)(C)CC(C)(C)C)cc9)cc9c%10c(cc(Oc%11ccc(C(C)(C)CC(C)(C)C)cc%11)c(c%11ccc(c%12ccc(c%13c(Oc%14ccc(C(C)(C)CC(C)(C)C)cc%14)cc(c2c3%13)C1=O)c4c5%12)c6c7%11)c%108)C(=O)N(c1c(C(C)C)cccc1C(C)C)C9=O] |
| 2 | 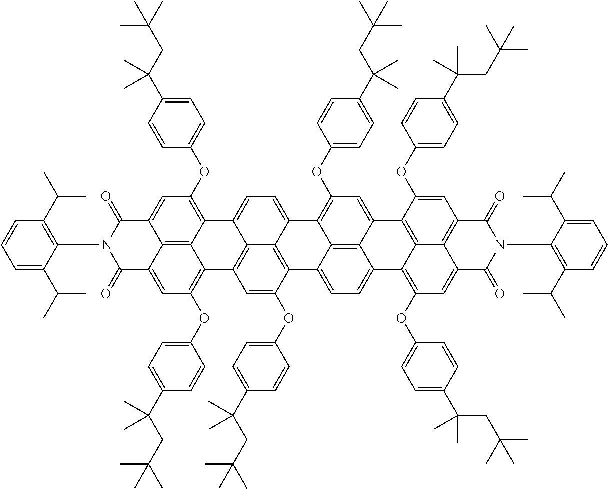 [SMILES: CC(C)c1cccc(C(C)C)c1N1C(=O)c2cc(Oc3ccc(C(C)(C)CC(C)(C)C)cc3)c3c4ccc5c6c(Oc7ccc(C(C)(C)CC(C)(C)C)cc7)cc7c8c(Oc9ccc(C(C)(C)CC(C)(C)C)cc9)cc9c%10c(cc(Oc%11ccc(C(C)(C)CC(C)(C)C)cc%11)c(c%11ccc(c%12c(Oc%13ccc(C(C)(C)CC(C)(C)C)cc%13)cc(c%13c(Oc%14ccc(C(C)(C)CC(C)(C)C)cc%14)cc(c2c3%13)C1=O)c4c5%12)c6c%117)c%108)C(=O)N(c1c(C(C)C)cccc1C(C)C)C9=O] |
| 3 | 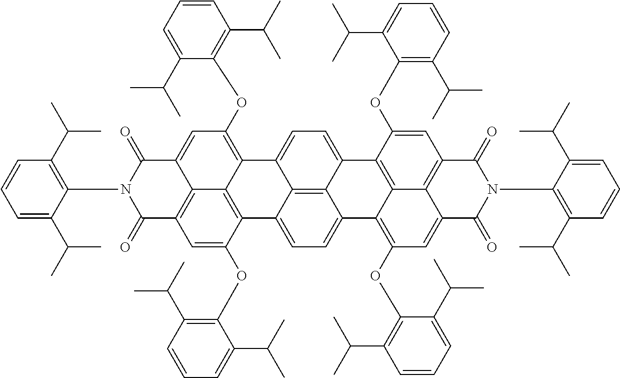 [SMILES: CC(C)c1cccc(C(C)C)c1Oc1cc2c3c(cc(Oc4c(C(C)C)cccc4C(C)C)c4c5ccc6c7c(Oc8c(C(C)C)cccc8C(C)C)cc8c9c(cc(Oc%10c(C(C)C)cccc%10C(C)C)c(c%10ccc(c1c34)c5c%106)c97)C(=O)N(c1c(C(C)C)cccc1C(C)C)C8=O)C(=O)N(c1c(C(C)C)cccc1C(C)C)C2=O] |
| 4 | 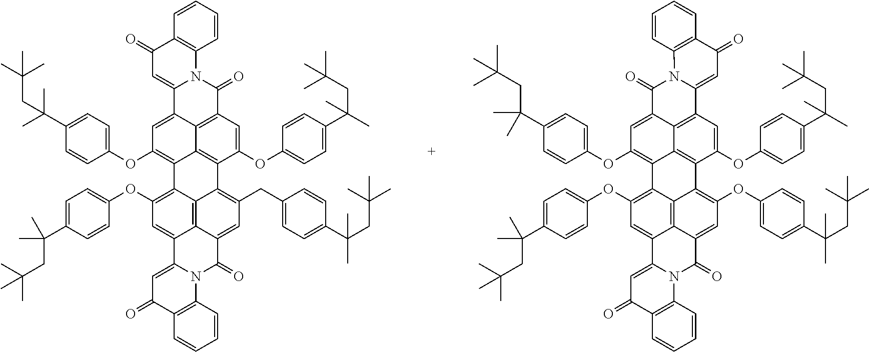 [SMILES: CC(C)(C)CC(C)(C)c1ccc(Cc2cc3c(=O)n4c5ccccc5c(=O)cc4c4cc(Oc5ccc(C(C)(C)CC(C)(C)C)cc5)c5c6c(Oc7ccc(C(C)(C)CC(C)(C)C)cc7)cc7c8c(cc(Oc9ccc(C(C)(C)CC(C)(C)C)cc9)c(c2c5c34)c68)c(=O)n2c3ccccc3c(=O)cc72)cc1 ; CC(C)(C)CC(C)(C)c1ccc(Oc2cc3c(=O)n4c5ccccc5c(=O)cc4c4cc(Oc5ccc(C(C)(C)CC(C)(C)C)cc5)c5c6c(Oc7ccc(C(C)(C)CC(C)(C)C)cc7)cc7c(=O)n8c9ccccc9c(=O)cc8c8cc(Oc9ccc(C(C)(C)CC(C)(C)C)cc9)c(c2c5c34)c6c78)cc1] |
| 5 | 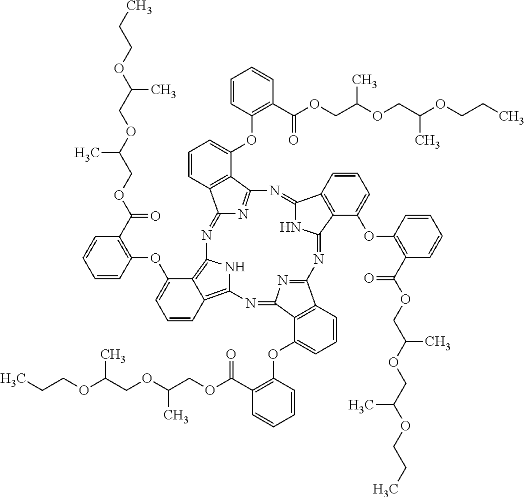 [SMILES: CCCOC(C)COC(C)COC(=O)c1ccccc1Oc1cccc2c1-c1nc-2nc2[nH]c(nc3nc(nc4[nH]c(n1)c1cccc(Oc5ccccc5C(=O)OCC(C)OCC(C)OCCC)c41)-c1cccc(Oc4ccccc4C(=O)OCC(C)OCC(C)OCCC)c1-3)c1cccc(Oc3ccccc3C(=O)OCC(C)OCC(C)OCCC)c21] |
| 6 | 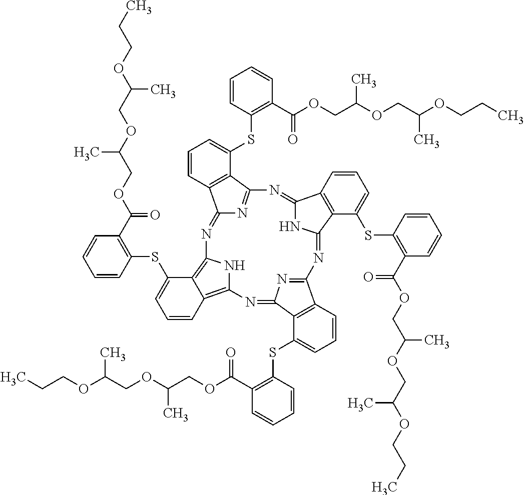 [SMILES: CCCOC(C)COC(C)COC(=O)c1ccccc1Sc1cccc2c1-c1nc-2nc2[nH]c(nc3nc(nc4[nH]c(n1)c1cccc(Sc5ccccc5C(=O)OCC(C)OCC(C)OCCC)c41)-c1cccc(Sc4ccccc4C(=O)OCC(C)OCC(C)OCCC)c1-3)c1cccc(Sc3ccccc3C(=O)OCC(C)OCC(C)OCCC)c21] |
| 7 | 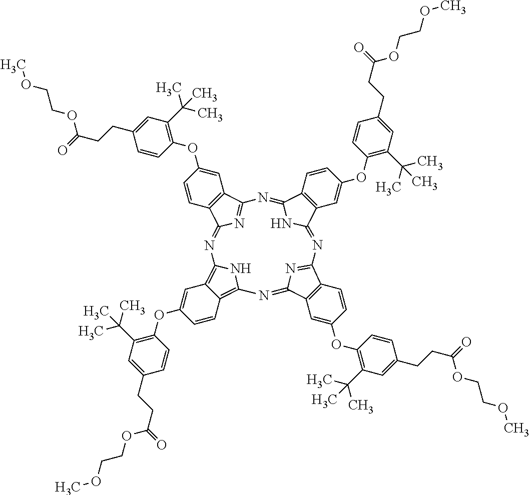 |
| 8 | 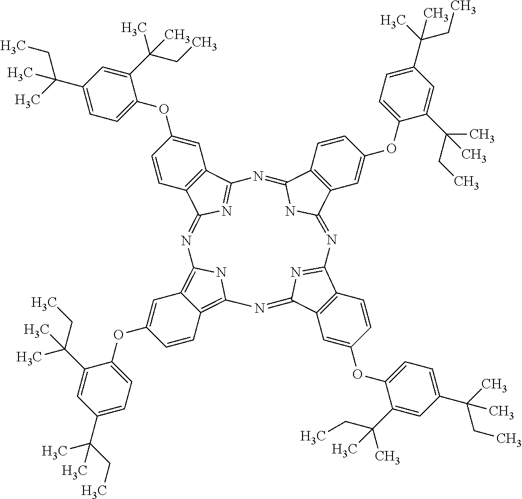 [SMILES: CCC(C)(C)c1ccc(Oc2ccc3c(c2)-c2nc-3nc3[nH]c(nc4nc(nc5[nH]c(n2)c2ccc(Oc6ccc(C(C)(C)CC)cc6C(C)(C)CC)cc52)-c2ccc(Oc5ccc(C(C)(C)CC)cc5C(C)(C)CC)cc2-4)c2ccc(Oc4ccc(C(C)(C)CC)cc4C(C)(C)CC)cc32)c(C(C)(C)CC)c1] |
| 9 | 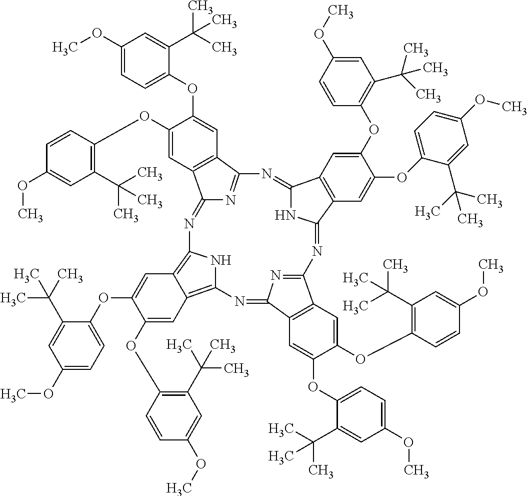 [SMILES: COc1ccc(Oc2cc3c(cc2Oc2ccc(OC)cc2C(C)(C)C)-c2nc-3nc3[nH]c(nc4nc(nc5[nH]c(n2)c2cc(Oc6ccc(OC)cc6C(C)(C)C)c(Oc6ccc(OC)cc6C(C)(C)C)cc52)-c2cc(Oc5ccc(OC)cc5C(C)(C)C)c(Oc5ccc(OC)cc5C(C)(C)C)cc2-4)c2cc(Oc4ccc(OC)cc4C(C)(C)C)c(Oc4ccc(OC)cc4C(C)(C)C)cc32)c(C(C)(C)C)c1] |
| 10 | 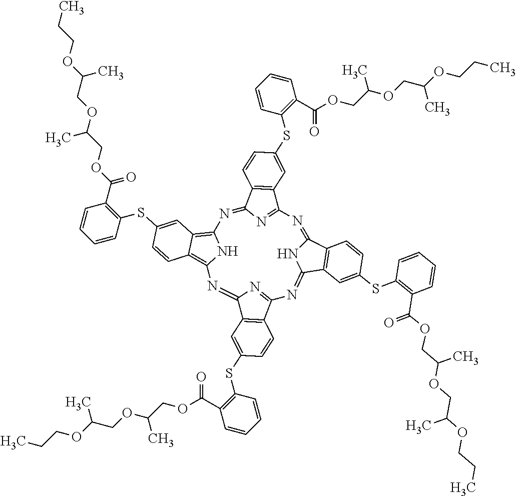 [SMILES: CCCOC(C)COC(C)COC(=O)c1ccccc1Sc1ccc2c(c1)-c1nc-2nc2[nH]c(nc3nc(nc4[nH]c(n1)c1ccc(Sc5ccccc5C(=O)OCC(C)OCC(C)OCCC)cc41)-c1ccc(Sc4ccccc4C(=O)OCC(C)OCC(C)OCCC)cc1-3)c1ccc(Sc3ccccc3C(=O)OCC(C)OCC(C)OCCC)cc21] |
| 11 | 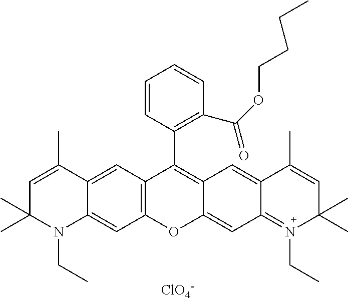 |
| 12 | 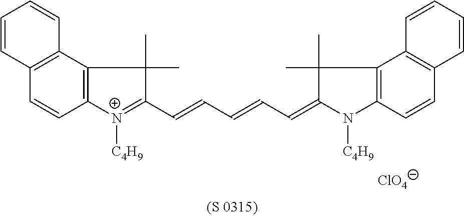 |
| 13 | 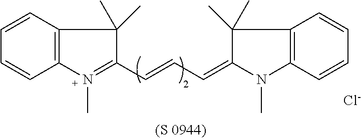 |
| 14 | 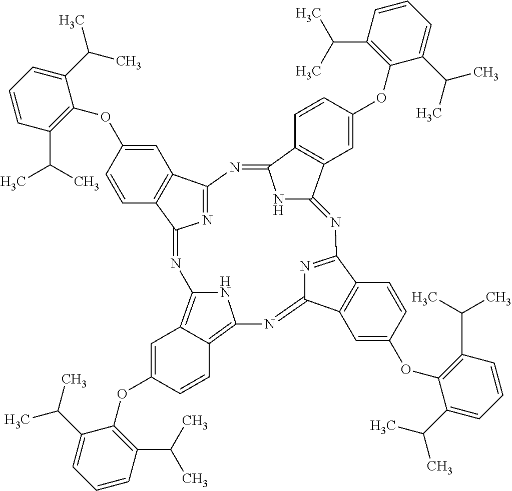 [SMILES: CC(C)c1cccc(C(C)C)c1Oc1ccc2c(c1)-c1nc-2nc2[nH]c(nc3nc(nc4[nH]c(n1)c1ccc(Oc5c(C(C)C)cccc5C(C)C)cc41)-c1ccc(Oc4c(C(C)C)cccc4C(C)C)cc1-3)c1ccc(Oc3c(C(C)C)cccc3C(C)C)cc21] |
| 15 | 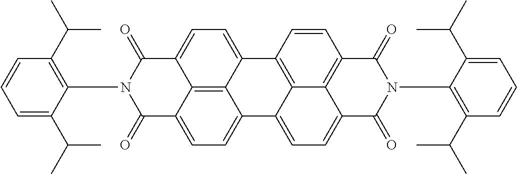 [SMILES: CC(C)c1cccc(C(C)C)c1N1C(=O)c2ccc3c4ccc5c6c(ccc(c7ccc(c2c37)C1=O)c64)C(=O)N(c1c(C(C)C)cccc1C(C)C)C5=O] |
| 16 | 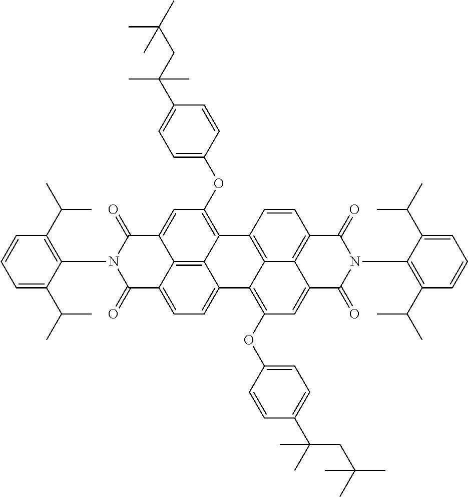 [SMILES: CC(C)c1cccc(C(C)C)c1N1C(=O)c2ccc3c4c(Oc5ccc(C(C)(C)CC(C)(C)C)cc5)cc5c6c(ccc(c7c(Oc8ccc(C(C)(C)CC(C)(C)C)cc8)cc(c2c37)C1=O)c64)C(=O)N(c1c(C(C)C)cccc1C(C)C)C5=O] |
| 17 | 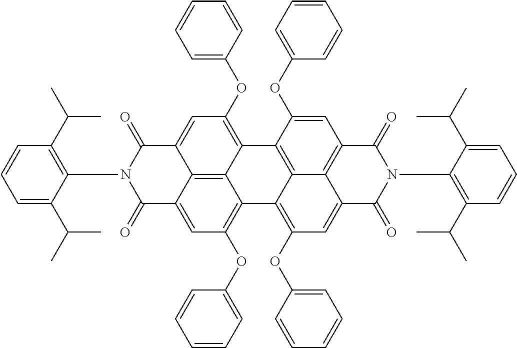 [SMILES: CC(C)c1cccc(C(C)C)c1N1C(=O)c2cc(Oc3ccccc3)c3c4c(Oc5ccccc5)cc5c6c(cc(Oc7ccccc7)c(c7c(Oc8ccccc8)cc(c2c37)C1=O)c64)C(=O)N(c1c(C(C)C)cccc1C(C)C)C5=O] |
| 18 | 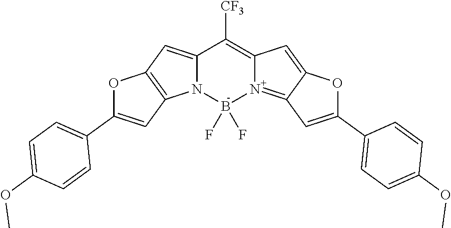 |
| 19 | 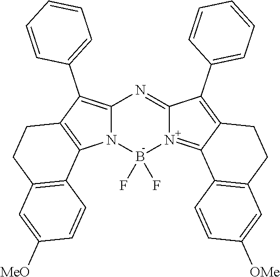 |
| 20 | 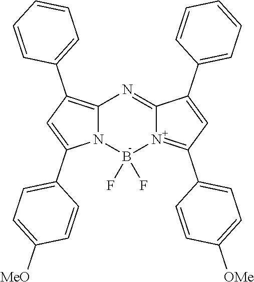 |

### EXEMPLARY EMBODIMENTS

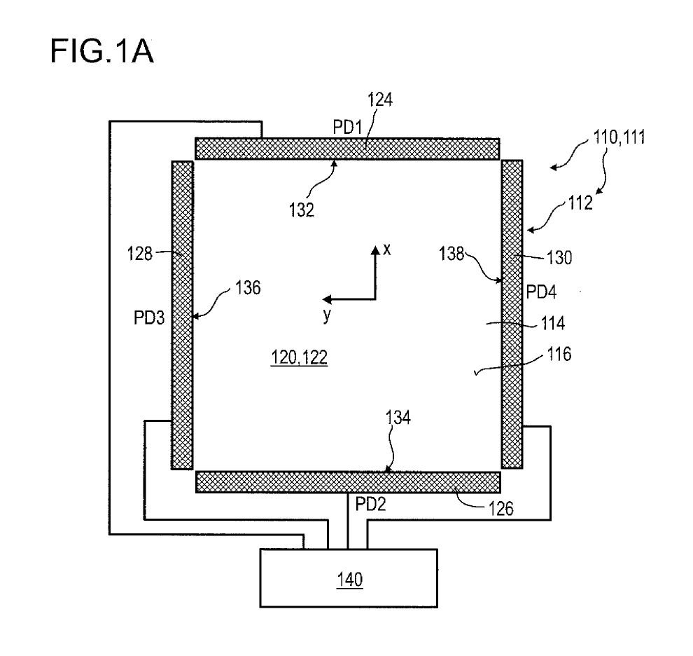

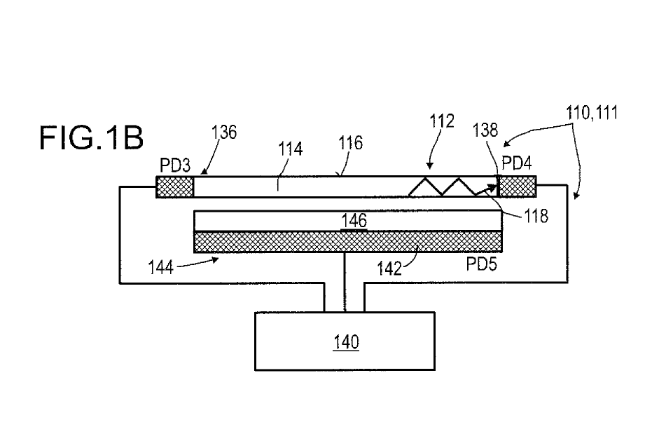

FIGS. 1A and 1B show, in a highly schematic illustration, an exemplary embodiment of a transversal partition 111 of a detector 110 according to the present invention. Therein, FIG. 1A shows a top view, and FIG. 1B shows a cross-sectional view. The detector 110 comprises a transversal optical sensor 112, having a fluorescent waveguiding sheet 114, wherein the fluorescent waveguiding sheet 114 forms a transversal sensitive area 116 facing towards an object which is not depicted in this figure. The fluorescent waveguiding sheet, in this exemplary embodiment, may be designed as a flat waveguiding sheet, in which, as symbolically depicted by the arrow 118, a waveguiding by internal reflection may take place, specifically by internal total reflection, specifically a waveguiding of fluorescence light generated within the fluorescent waveguiding sheet 114. The fluorescent waveguiding sheet 114, as an example, may have a lateral extension of at least 25 mm², such as at least 100 mm², more preferably of at least 400 mm². As an example, a 10 mm×10 mm square sheet, a 20 mm×20 mm square sheet, a 50 mm×50 mm square sheet or another dimension may be used. It shall be noted, however, that the non-square geometries or even nonrectangular geometries may be used, such as circular or oval geometries.

The fluorescent waveguiding sheet 114, as an example, may comprise a matrix material 120 and at least one fluorescent material 122 disposed therein, such as at least one fluorophore, e.g. a fluorescent dye. For exemplary embodiments, reference may be made to the above-mentioned materials, such as one or more materials listed in WO 2012/168395 A1. As an example, the following fluorescent material may be used:

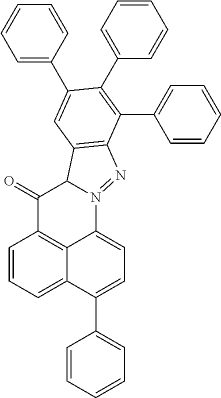

The fluorescent material is disclosed as substance 34.2 in WO 2012/168395 A1, including potential synthesis methods. The material may be immersed in polystyrene, such as at a concentration of 0.001-0.5 weight %. The fluorescent material 122 is designed to generate fluorescence light in response to an illumination by a light beam. Therein, the fluorescent material 122 is chosen to be a nonlinear material, i.e. a fluorescent material with a nonlinear response to excitation light, such that the total power of the fluorescence light generated in response to an excitation is a nonlinear function of the intensity of the illumination by the excitation light, i.e. by the light beam. As an example, saturation effects may be used. The nonlinearity, besides being a material property, may also be affected by the concentration of the fluorescent material 122 within the matrix material 120. Generally, as an example, concentrations of 0.001-0.5 weight % are preferred in this exemplary embodiment or in other embodiments of the present invention. Thus, generally, the term “being designed to” or “being adapted to”, referring to the nonlinear fluorescence properties of the fluorescent material 122, may both refer to an intrinsic property of the fluorescent material 122 itself and/or to a concentration of the fluorescent material 122 in the matrix material 120.

The transversal optical sensor 112 further has a plurality of photosensitive elements 124, 126, 128, 130, in FIGS. 1A and 1B referred to as PD1 -PD4, located at respective edges 132, 134, 136, 138 of the fluorescent waveguiding sheet 114. In this exemplary embodiment, the fluorescent waveguiding sheet 114 may have a rectangular shape, such that pairs of edges are opposing each other, such as the pair of edges 132, 134 and the pair of edges 136, 138. The sides of the rectangular shape of the waveguiding sheet 114 may define a Cartesian coordinate system, with an x-dimension defined by an interconnection between edges 132 and 134, and a y-dimension defined by an interconnection between edges 136 and 138. It shall be noted, however, that other coordinate systems are feasible.

The photosensitive elements 124, 126, 128, 130, as an example, may comprise photodiodes. In general, however, other photosensitive elements may be used. The photosensitive elements 124, 126, 128, 130, as an example, may be or may comprise strip-shaped photodiodes covering, preferably, the full length of the respective edges 132, 134, 136, 138, or, preferably, covering at least 50% or more preferably at least 70% of the length of these respective edges 132, 134, 136, 138. Other embodiments, however, are feasible, such as embodiments in which more than one photosensitive element is located at a respective edge.

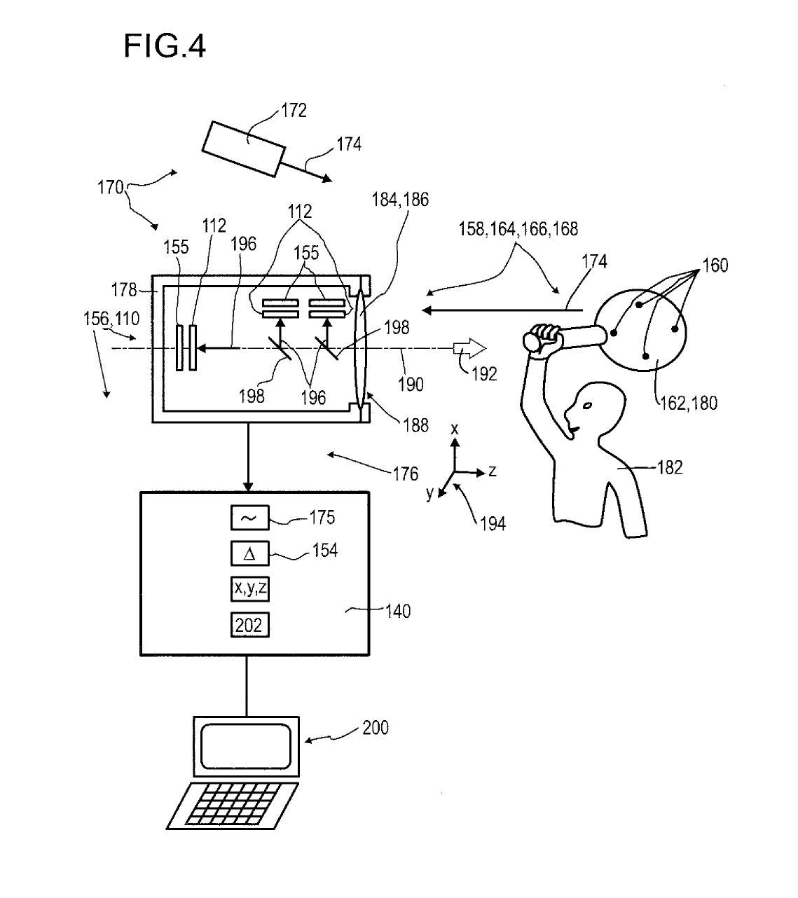

The photosensitive elements 124, 126, 128, 130 each produce at least one sensor signal, in response to the light, specifically the fluorescence light, detected by these photosensitive elements 124, 126, 128, 130. The photosensitive elements 124, 126, 128, 130 are connected to an evaluation device 140 of the detector 110, the function of which will be explained in further detail below. The sensor signals of the photosensitive elements 124, 126, 128, 130 are provided to the evaluation device 140. The evaluation device 140 is configured to determine at least one transversal coordinate x, y of the object which is not depicted in these figures and from which a light beam propagates towards the detector, by evaluating the sensor signals. Additionally, at least one longitudinal coordinate z is determined, as will be outlined in further detail below with reference to FIGS. 3 and 4.

The transversal optical sensor 112 further may comprise at least one reference photosensitive element 142, in FIG. 1B also referred to as PDS, which may be located on a reverse side 144 of the transversal optical sensor 112, facing away from the object and facing away from the sensitive area 116. Again, the reference photosensitive element 142 may be or may comprise at least one photodiode, such as at least one large area photodiode. As an example, the reference photosensitive element 142 may comprise a large area photodiode covering at least 50% of the reverse side 144, which may also be referred to as the back side, of the fluorescent waveguiding sheet 114. It shall be noted, however, that other embodiments are feasible, such as embodiments comprising a plurality of reference photosensitive elements 142. As an example, a plurality of reference photosensitive elements 142 may be located on the reverse side 144, the plurality, in total, covering the full reverse side 144. As a further example, a matrix of photosensitive elements 142 may be located on the reverse side 144, such as an image sensor or image chip, such as a one-dimensional or two-dimensional CCD or CMOS chip.

The transversal optical sensor 112 further may comprise at least one optical filter element 146. As an example, as visible in the cross-sectional view in FIG. 1B, at least one optical filter element 146 may be placed in front of the reference photosensitive element 142, such as in a beam path in between the fluorescent waveguiding sheet 114 and the reference photosensitive element 142. As an example, a layer setup may be used. Thus, the transversal optical sensor 112 generally, in this embodiment or in other embodiments of the present invention, may comprise a stack and/or a layer setup having the at least one fluorescent waveguiding sheet 114, the at least one optical filter element 146 and the at least one reference photosensitive element 142, preferably in the given order. As an example, the at least one optical filter element 146 may be designed to prevent fluorescence light from entering the reference photosensitive element 142 or, at least, may attenuate fluorescence light by at least 70% or preferably by at least 80%. Accreditation light, however, such as light from the light beam, may preferably pass the optical filter element 146, such as with an attenuation of preferably no more than 40%, more preferably of no more than 20%. Thus, as an example, in this exemplary embodiment or in other exemplary embodiments of the present invention, the at least one optical filter element 146 specifically may comprise a short-pass filter, such as a short pass filter having a threshold wavelength in the range of 400 nm to 600 nm, such as in the range of 500 to 550 nm. The short pass filter may ensure that the at least one reference photosensitive element 142 generally provides a measure for the total power of the light beam and/or the excitation light rather than measuring the fluorescence light.

However, it may be mentioned that despite the presentation of FIGS. 1A and 1B, no reference photosensitive element 142 may be necessary for the transversal optical sensor 112 according to the present invention. In this case, the sum signal itself may replace the function of the reference photosensitive element 142 such that this embodiment of the transversal optical sensor 112 may provide a fully functional and, optionally, transparent a transversal position-sensitive detector (PSD).

Further alternative embodiments (not depicted here) of the transversal optical sensor 112 may refer to various properties of the photosensitive elements 124, 126, 128, 130. Thus, besides the photosensitive elements 124, 126, 128, 130 located at the opposing edges 132, 134, 136, 138, additional photosensitive elements may be located at corners of the fluorescent waveguiding sheet 114, wherein the corners may also be part of the edges of the fluorescent waveguiding sheet 114. The additional photosensitive elements located at the corners may, thus, provide additional sensor signals which can be evaluated in a similar fashion as schematically depicted in FIG. 3. They may be capable of providing an increased accuracy of a determination of the x- and/or y-coordinates. Thus, as an example, these additional sensor signals may be included in the sum signal, such as formed by using formula (1) above. As an example, difference signals between two photosensitive elements located at opposing corners may be formed and/or difference signals between one photosensitive element located at a corner and one photosensitive element located at a straight edge may be formed.

Further, alternatively or in addition, the photosensitive elements 124, 126, 128, 130 and/or the additional photosensitive elements may exhibit a variation of their placement with respect to the fluorescent waveguiding sheet 114. In contrast to FIGS. 1A and 1B, where the photosensitive elements 124, 126, 128, 130 are located within the plane of the fluorescent waveguiding sheet 114, any or all of the photosensitive elements 124, 126, 128, 130 and/or the additional photosensitive elements may, alternatively or in addition, be located outside the plane of the fluorescent waveguiding sheet 114. Specifically, the photosensitive elements 124, 126, 128, 130 and/or the additional photosensitive elements may be optically coupled to the fluorescent waveguiding sheet 114 by optical coupling elements. For this purpose, the photosensitive elements 124, 126, 128, 130 and/or the additional photosensitive elements may be glued to the fluorescent waveguiding sheet 114 by using one or more transparent adhesives, such as an epoxy adhesive, which may act as the optical coupling elements. However, other kinds of known optical coupling elements may also be employed. Further, alternatively or in addition, the photosensitive elements 124, 126, 128, 130 and/or the additional photosensitive elements may vary in size and/or shape. Thus, the photosensitive elements 124, 126, 128, 130 and/or the additional photosensitive elements do not necessarily have to be strip-shaped photosensitive elements as schematically depicted in FIGS. 1A and 1B. As an example, very small photodiodes may be used, such as rectangular photodiodes, spot-like photodiodes, or even point-like photodiodes. As outlined above, a small size of the photodiodes generally may involve a lower electrical capacitance and, thus, may lead to a faster response of the transversal optical sensor 112.

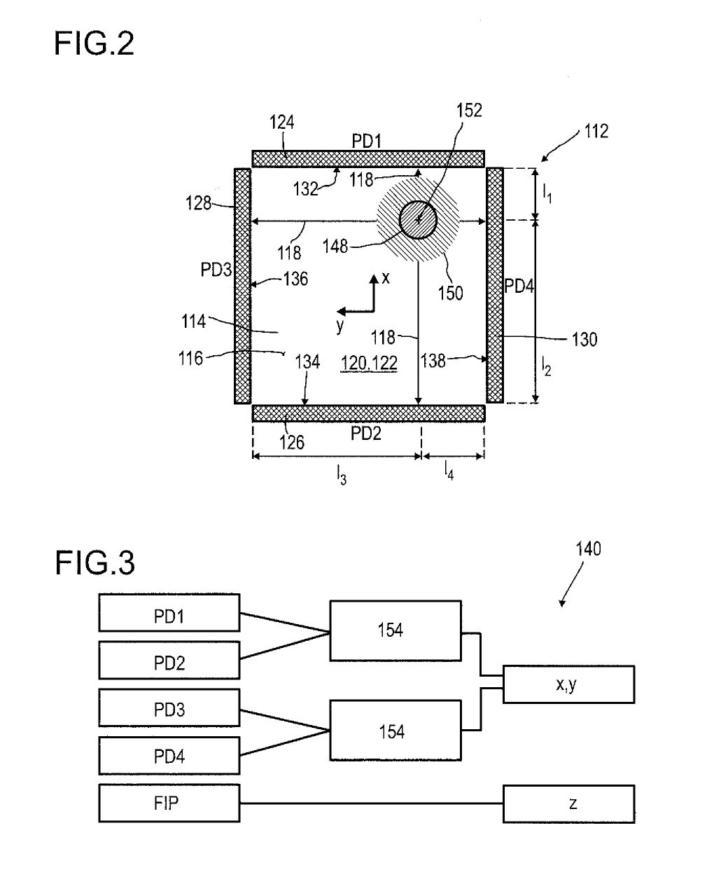

In FIG. 2, an illumination of the transversal sensitive area 116 of the fluorescent waveguiding sheet 114 by a light beam is shown. Therein, two different situations are depicted, representing different distances between the object, from which the light beam propagates towards the detector 110, and the detector 110 itself, resulting in two different spot sizes of light spots generated by the light beam in the fluorescent waveguiding sheet 114, firstly, a small light spot 148 and, secondly, a large light spot 150. In both cases, the overall power of the light beam remains the same over the light spots 148, 150. Consequently, the average intensity in the small light spot 148 is significantly higher than in the large light spot 150. Further, in both cases a position of a center 152 of the light spots 148, 150 remains unaltered, irrespective of a size of the light spots 148, 150. This feature demonstrates the capability of the photosensitive elements 124, 126, 128, 130 of the transversal optical sensor 112 as illustrated here to provide transversal sensor signals to the evaluation device 140, which are configured to allow the evaluation device 140 unambiguously determining the at least one transversal coordinate x, y of the object.

The illumination by the light beam induces fluorescence which, as depicted in FIG. 1B above, is fully or partially transported by waveguiding towards the photosensitive elements 124, 126, 128, 130. As indicated above, corresponding sensor signals are generated by these photosensitive elements 124, 126, 128, 130 and provided to the evaluation device 140, in conjunction with at least one reference sensor signal generated by the at least one reference photosensitive element 142.

The evaluation device 140, as schematically and symbolically depicted in FIG. 3, is designed to evaluate the transversal sensor signals which, therein, are represented by the symbols PD1-PD4 for the transversal sensor signals of the photosensitive elements 124, 126, 128, 130 and FIP for a longitudinal sensor signal. The sensor signals may be evaluated by the evaluation device in various ways in order to derive a location information and/or a geometrical information on the object.

Thus, as outlined above, at least one transversal coordinate x, y may be derived. This is mainly due to the fact that the distances between a center 152 of the light spot 148, 150 and the photosensitive elements 124, 126, 128 and 130 are non-equal. Thus, the center 152 of the light spot 148, 150 has a distance from the photosensitive element 124 of I₁, a distance from the photosensitive element 126 of I₂, a distance from the photosensitive element 128 of I₃, and a distance from the photosensitive element 130 of I₄. Due to these differences in the distances between the location of the generation of the fluorescence light and the photosensitive elements 124, 126, 128, 130 detecting the fluorescence light, the transversal sensor signals will differ. This is due to various effects. Firstly, again, internal losses will occur during waveguiding, since each internal total reflection implies a certain loss, such that the fluorescence light will be attenuated on its way, depending on the length of the path. The longer the distance of travel, the higher the attenuation and the higher the losses. Further, absorption effects will occur. Thirdly, a spreading of the light will have to be considered. The longer the distance between the light spot 148, 150 to the respective photosensitive element 124, 126, 128, 130, the higher the probability that a photon will be directed into a direction other than the photosensitive element 124, 126, 128, 130. Consequently, by comparing the sensor signals of the photosensitive element 124, 126, 128, 130, a transversal location information is generated.

The comparison of the sensor signals may take place in various ways. Thus, generally, the evaluation device 140 may be designed to compare the transversal sensor signals in order to derive the at least one transversal coordinate of the object or of the light spot. As an example, the evaluation device 140 may comprise at least one subtracting device 154 and/or any other device which provides a function which is dependent on at least one transversal coordinate, such as on the coordinates x, y. For exemplary embodiments, the subtracting device 154 may be designed to generate at least one difference signal, such as a signal according to formula (1) above, for one or each of dimensions x, y in FIG. 2. As an example, a simple difference between PD1 and PD2, such as (PD1−PD2)/(PD1+PD2), may be used as a measure for the x-coordinate, and a difference between PD3 and PD4, such as (PD3−PD4)/(PD3+PD4), may be used as a measure for the y-coordinate. A transformation of the transversal coordinates of the light spot 148, 150 in the plane of the sensitive area 116, as an example, into transversal coordinates of the object from which the light beam propagates towards the detector 110 may be made by using the well-known lens equation. For further details, as an example, reference may be made to one or more of the above-mentioned prior art documents, such as to WO 2014/097181 A1.

As outlined above, the longitudinal coordinate z may be also derived, in particular by implementing the FiP effect explained in further detail in WO 2012/110924 A1 and/or in WO 2014/097181 A1. For this purpose, the at least one longitudinal sensor signal as provided by the FIP sensor is evaluated by using the evaluation device 140 and determining, therefrom, at least one longitudinal coordinate z of the object.

It shall be noted, however, that other transformations or other algorithms for processing the sensor signals by the evaluation device 140 are feasible. Thus, besides subtractions or the near combinations with positive or negative coefficients, nonlinear transformations are generally feasible. As an example, for transforming the sensor signals into z-coordinates and/or x,y-coordinates, one or more known or determinable relationships may be used, which, as an example, may be derived empirically, such as by calibrating experiments with the object placed at various distances from the detector 110 and/or by calibrating experiments with the object placed at various transversal positions or three-dimensional positions, and by recording the respective sensor signals.

FIG. 4 shows, in a highly schematic illustration, an exemplary embodiment of a detector 110, having a plurality of transversal optical sensors 112 and of longitudinal optical sensors 155, wherein the longitudinal optical sensors 155 are FiP sensors which function according to the above-described FiP effect. The detector 110 specifically may be embodied as a camera 156 or may be part of a camera 156. The camera 156 may be made for imaging, specifically for 3D imaging, and may be made for acquiring standstill images and/or image sequences such as digital video clips. Other embodiments are feasible.

FIG. 4 further shows an embodiment of a detector system 158, which, besides the at least one detector 110, comprises one or more beacon devices 160, which, in this exemplary embodiment, are attached and/or integrated into an object 162, the position of which shall be detected by using the detector 110. FIG. 4 further shows an exemplary embodiment of a human-machine interface 164, which comprises the at least one detector system 158, and, further, an entertainment device 166, which comprises the human-machine interface 164. The figure further shows an embodiment of a tracking system 168 for tracking a position of the object 162, which comprises the detector system 158. The components of the devices and systems shall be explained in further detail in the following.

FIG. 4 further shows an exemplary embodiment of a scanning system 170 for determining at least one position of the at least one object 162. The scanning system 170 comprises the at least one detector 110 and, further, at least one illumination source 172 adapted to emit at least one light beam 174 configured for an illumination of at least one dot (e.g. a dot located on one or more of the positions of the beacon devices 160) located at at least one surface of the at least one object 162. The scanning system 170 is designed to generate at least one item of information about the distance between the at least one dot and the scanning system 170, specifically the detector 110, by using the at least one detector 110.

As outlined above, an exemplary embodiment of the transversal partition 111 of the detector 110 as shown in FIGS. 1-3 may be used in the setup of FIG. 4. Thus, the detector 110, besides the one or more transversal optical sensors 112, comprises one or more longitudinal optical sensors 155, at least one evaluation device 140, having e.g. optionally the at least one subtracting device 154 and at least one modulation device 175, as symbolically depicted in FIG. 4. Herein, the modulation device 175 may be employed for modulating the illumination, such as that the longitudinal sensor signal and/or the transversal sensor signal is dependent on a modulation frequency of a modulation of the illumination. The components of the evaluation device 140 may fully or partially be integrated into one or all of or even each of the optical sensors 112, 155 or may fully or partially be embodied as separate components independent from the optical sensors 112, 155.

Besides the above-mentioned possibility of fully or partially combining two or more components, one or more of one or more optical sensors 112, 155 and one or more of the components of the evaluation device 140 may be interconnected by one or more connectors 176 and/or one or more interfaces, as symbolically depicted in FIG. 4. Further, the optional at least one connector 176 may comprise one or more drivers and/or one or more devices for modifying or preprocessing sensor signals. Further, instead of using the at least one optional connector 176, the evaluation device 140 may fully or partially be integrated into the optical sensors 112, 155 and/or into a housing 178 of the detector 110. Additionally or alternatively, the evaluation device 140 may fully or partially be designed as a separate device.

In this exemplary embodiment, the object 162, the position of which may be detected, may be designed as an article of sports equipment and/or may form a control element or a control device 180, the position of which may be manipulated by a user 182. As an example, the object 162 may be or may comprise a bat, a racket, a club or any other article of sports equipment and/or fake sports equipment. Other types of objects 162 are possible. Further, the user 182 himself or herself may be considered as the object 182, the position of which shall be detected.

As outlined above, the detector 110 comprises one or more optical sensors 112, 155. The optical sensors 112, 155 may be located inside the housing 178 of the detector 110. Further, at least one transfer device 184 may be comprised, such as one or more optical systems, preferably comprising one or more lenses 186.

An opening 188 inside the housing 178, which, preferably, is located concentrically with regard to an optical axis 190 of the detector 110, preferably defines a direction of view 192 of the detector 110. A coordinate system 194 may be defined, in which a direction parallel or antiparallel to the optical axis 190 is defined as a longitudinal direction, whereas directions perpendicular to the optical axis 190 may be defined as transversal directions. In the coordinate system 194, symbolically depicted in FIG. 4, a longitudinal direction is denoted by z, and transversal directions are denoted by x and y, respectively. Other types of coordinate systems 194 are feasible.

The detector 110 may comprise one or more of the optical sensors 112, 155. Preferably, as depicted in FIG. 4, a plurality of optical sensors 112, 155 is comprised, which, as an example, may be located in different partial beam paths 196, as depicted in FIG. 4, which may be split by one or more beam splitting devices 198. As further illustrated in FIG. 4, each of the optical sensors 112, 155 may, preferably, be located in a manner that at least one incident light beam 174 may first impinge on the transversal optical sensor 112 before it impinges on the longitudinal optical sensor 155. In this case, the transversal optical sensor 112 may, in particular exhibit transparent or at least semitransparent properties in order to actually allow the incident light beam 174 reaching both kinds of optical sensors 112, 155 with sufficient intensity. Within this regard it may be mentioned that the transversal optical sensor 112 as presented in FIG. 1 comprises an arrangement which is particularly suited for this purpose. It shall be noted, however, that other options are feasible, such as stacked configurations of two or more transversal optical sensors 112 or of two or more longitudinal optical sensors 155. Further, embodiments having a different number of optical sensors 112, 155 are feasible.

The one or more light beams 174 are propagating from the object 162 and/or from and/or one or more of the beacon devices 160 towards the detector 110. The detector 110 is adapted for determining a position of the at least one object 162. For this purpose, as explained above in the context of FIGS. 1-3, the evaluation device 140 is configured to evaluate sensor signals provided by the one or more optical sensors 112, 155. The detector 110 is adapted to determine a position of the object 162, and the optical sensors 112, 155 are adapted to detect the light beam 174 propagating from the object 162 towards the detector 110, specifically from one or more of the beacon devices 160. The light beam 174, directly and/or after being modified by the transfer device 184, such as being focused by the lens 186, creates the light spot 148, 150 on the transversal sensitive area 116 of the transversal optical sensor 112 or of each of the transversal optical sensors 112 and on the longitudinal sensitive area (not depicted here) of the longitudinal optical sensor 155 or of each of the longitudinal optical sensors 155.

As outlined above, the determination of a position of the object 162 and/or a part thereof by using the detector 110 may be used for providing a human-machine interface 164, in order to provide at least one item of information to a machine 200. In the embodiment schematically depicted in FIG. 4, the machine 200 may be a computer and/or may comprise a computer. Other embodiments are feasible. The evaluation device 140 even may fully or partially be integrated into the machine 200, such as into the computer.

As outlined above, FIG. 4 also depicts an example of a tracking system 168, configured for tracking the position of the at least one object 162. The tracking system 168 comprises the detector 110 and at least one track controller 202. The track controller 202 may be adapted to track a series of positions of the object 162 at specific points in time. The track controller 202 may be an independent device and/or may fully or partially form part of the computer of the machine 200.

Similarly, as outlined above, the human-machine interface 164 may form part of an entertainment device 166. The machine 200, specifically the computer, may also form part of the entertainment device 166. Thus, by means of the user 182 functioning as the object 162 and/or by means of the user 182 handling a control device 180 functioning as the object 162, the user 182 may input at least one item of information, such as at least one control command, into the computer, thereby varying the entertainment function, such as controlling the course of a computer game.

### WORKING EXAMPLES

I. Production of the Colored Samples

I.1 PMMA as matrix

1000.00 g of polymethyl methacrylate (PMMA 6N clear, available from Röhm GmbH, Germany) were predried at a maximum temperature of 90° C. for 4 hours and then mixed with 0.02 weight % of a Fluorescent colorant X (see Table 2) in a Turbula Fuchs mixer for 20 min. The homogenous mixture was extruded on a Twin Screw 25 mm extruder from Collin, Germany, six heating zones (cold, 150° C., 195° C., 200° C., 200° C., 200° C., 200° C.) at a maximum temperature of 200° C. The extrudate was granulated in a granulator (Scheer, Stuttgart). The granulate was dried at a maximum temperature of 90° C. for 4 hours and then processed to colored samples (30 mm×55 mm×approx. 1.2 mm) using a Boy Injection Molding Machine (Boy 30A from Dr. Boy GmbH, Neustadt, Germany) or a Klöckner Ferromatik FM 40 (from Klöckner, Germany). The mouldings obtained were packed up in an oxygen free plastic bag with a vacuum pack machine after drying.

TABLE 2

| Experimente No | Fluorescent colorant X | Geometry |
|---|---|---|
| 1.1 | Compound 4 of Table 1 | Foil** |
| 1.2 | Compound 11 of Table 1 | Slab* |
| 1.3 | Compound 7 of Table 1 | Slab* |
| 1.4 | Compound 6 of Table 1 | Slab* |
| 1.5 | Compound 5 of Table 1 | Slab* |
| 1.6 | Compound 8 of Table 1 | Slab* |
| 1.7 | Compound 12 of Table 1 | Slab* |
| 1.8 | Compound 14 of Table 1 | Slab* |
| 1.9 | Compound 10 of Table 1 | Slab* |
| 1.10 | Compound 9 of Table 1 | Slab* |

*(30 mm × 55 mm × approx. 1.2 mm)
**200 μm thick

1.2 Macrolon (Polycarbonat) as Matrix

1000.00 g of Polycarbonate (MACROLON 2805, Bayer) were predried at a maximum temperature of 120° C. for 4 hours and then mixed with 0.2 g of a Fluorescent colorant X (see Table 3) in a Turbula Fuchs mixer for 20 min. The homogenous mixture was extruded on a Twin Screw 25 mm extruder from Collin, Germany, six heating zones (cold, 150°, 265°, 275°, 280°, 280°, 280° C.) at a maximum temperature of 280° C. The extrudate was granulated in a granulator (Scheer, Stuttgart). The granulate was dried at a maximum temperature of 120° C. for 4 hours and then processed to colored samples using a Boy Injection Molding Machine (Boy 30A from Dr. Boy GmbH, Neustadt, Germany) or a Klöckner Ferromatik FM 40 (from Klöckner, Germany). The mouldings obtained were packed up in an oxygen free plastic bag with a vacuum pack machine after drying.

TABLE 3

| Experiment No | Fluorescent colorant X | Geometry |
|---|---|---|
| 2.1 | Compound 1 of Table 1 | Foil** |
| 2.2 | Compound 2 of Table 1 | Foil** |
| 2.3 | Compound 3 of Table 1 | Foil** |

**200 μm thick

II. Determination of the Absorption of Plastic Sheets with 0.02% Fluorescent Colorants

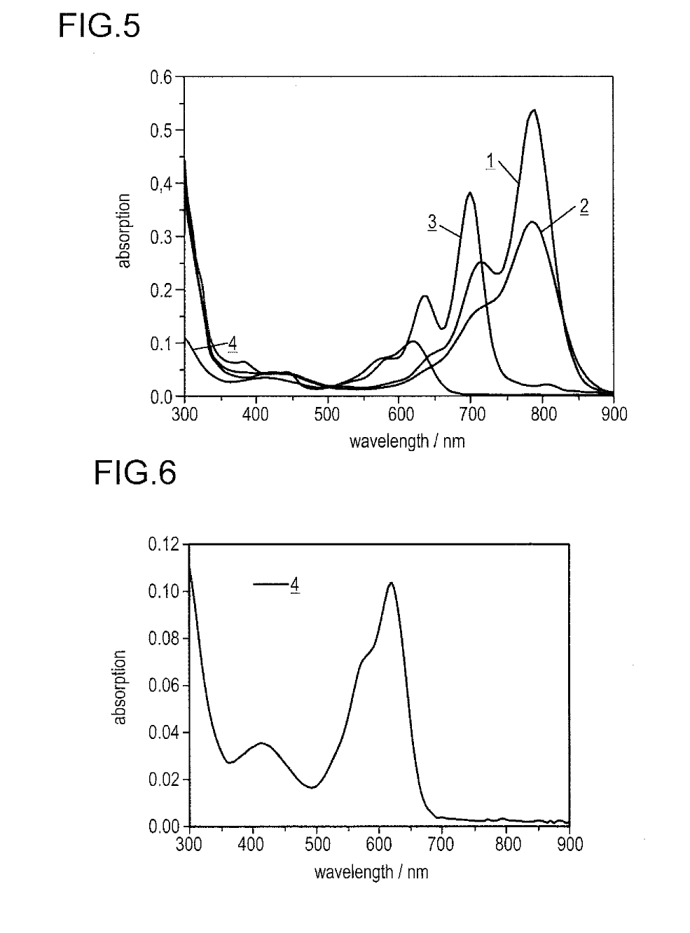

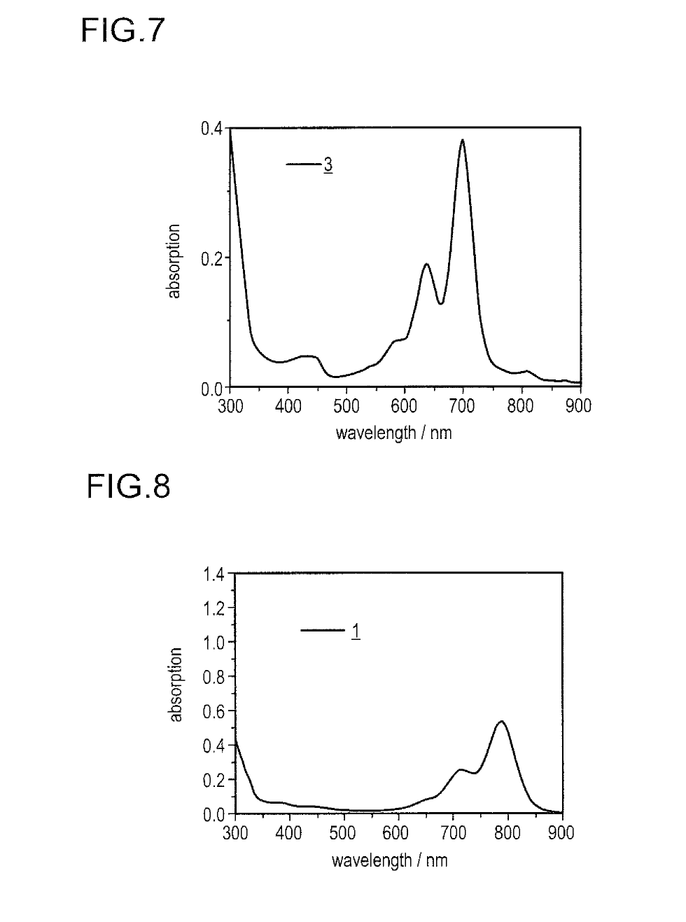

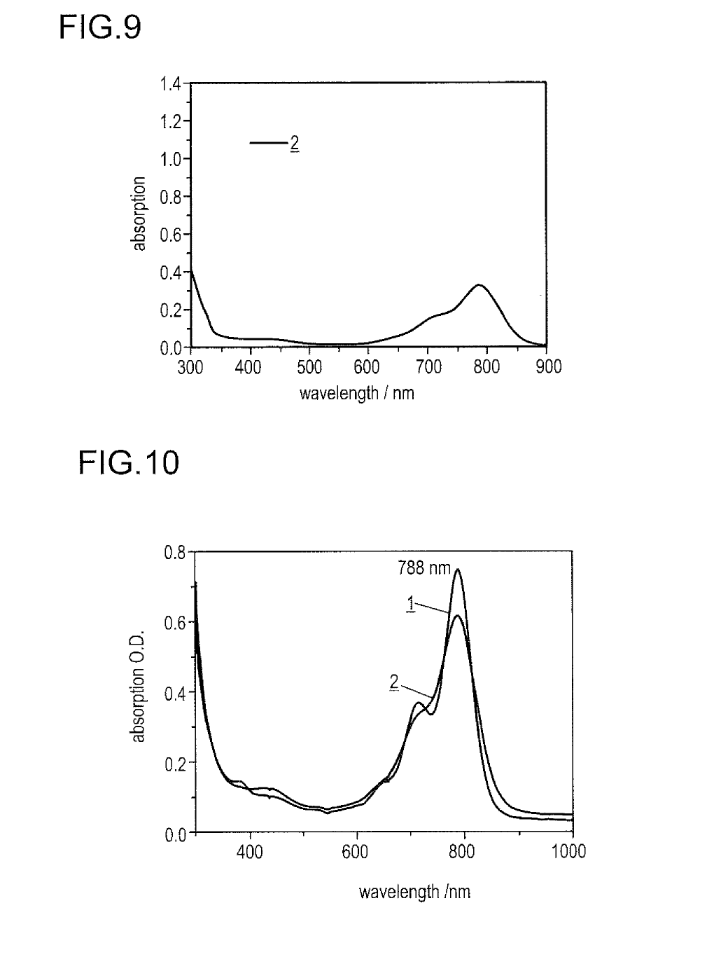

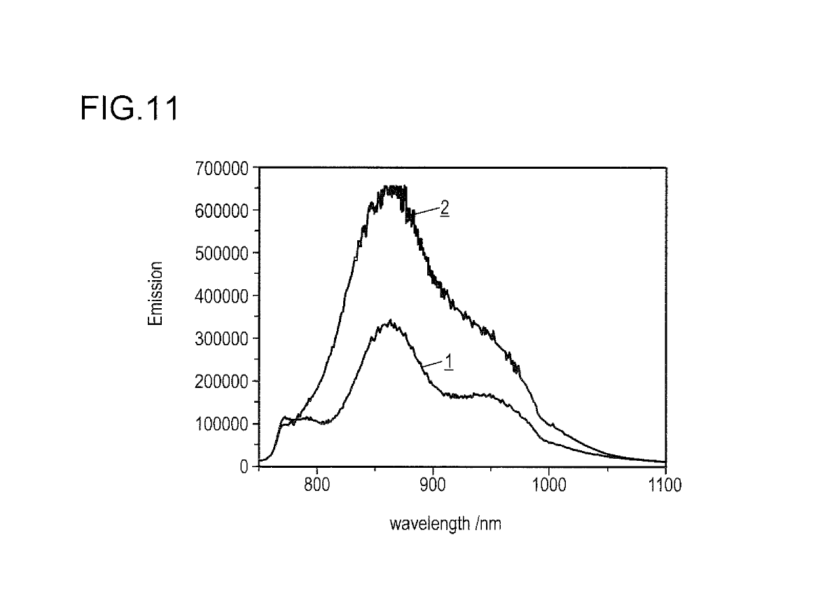

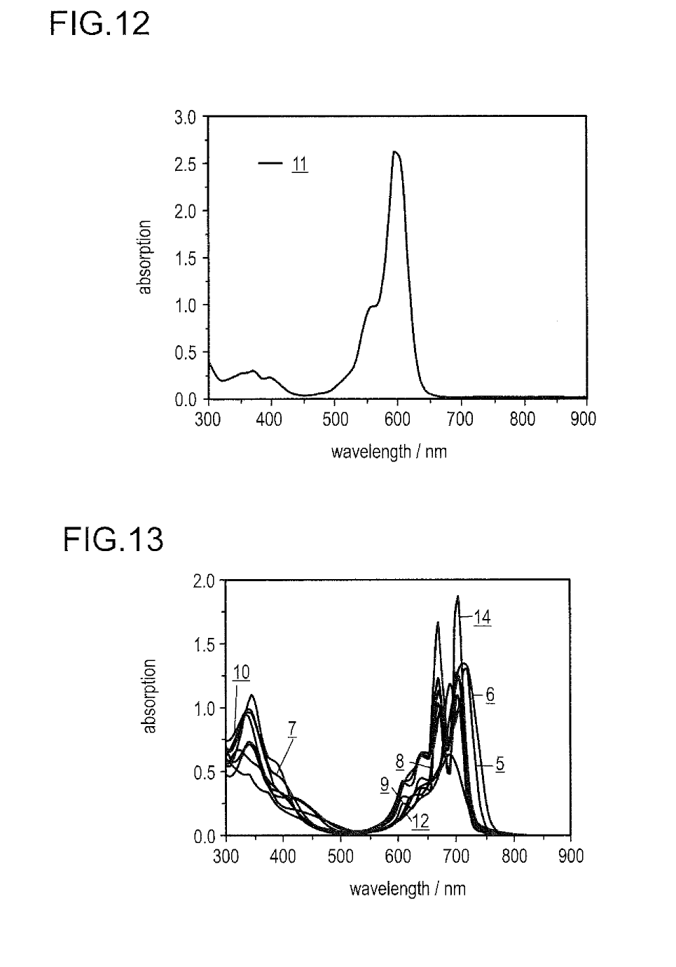

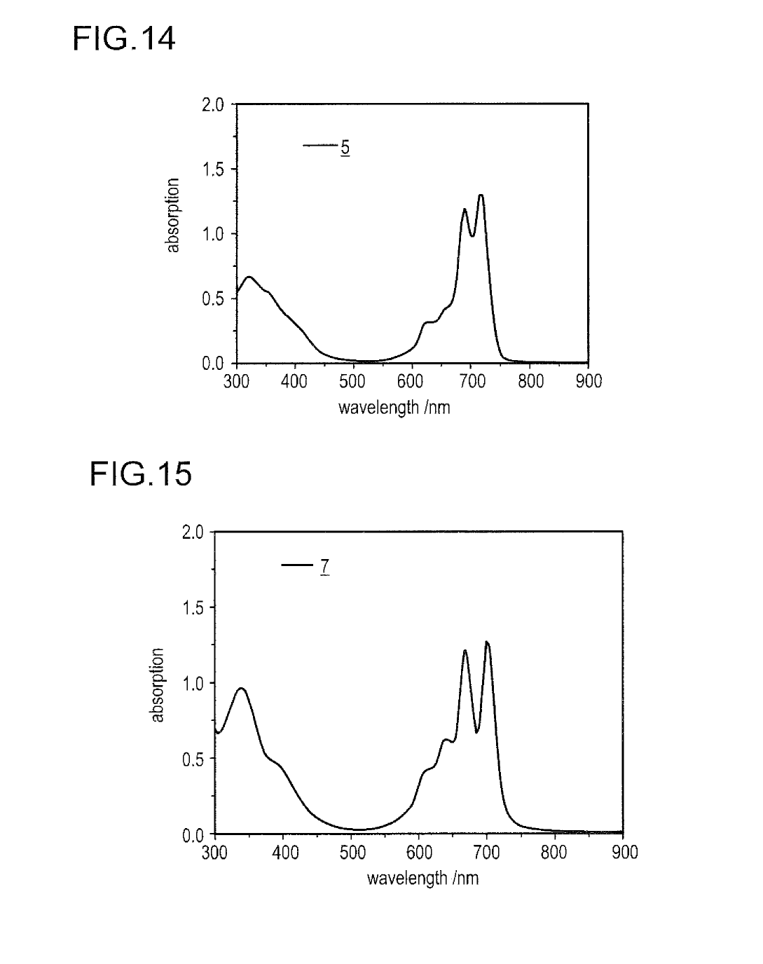

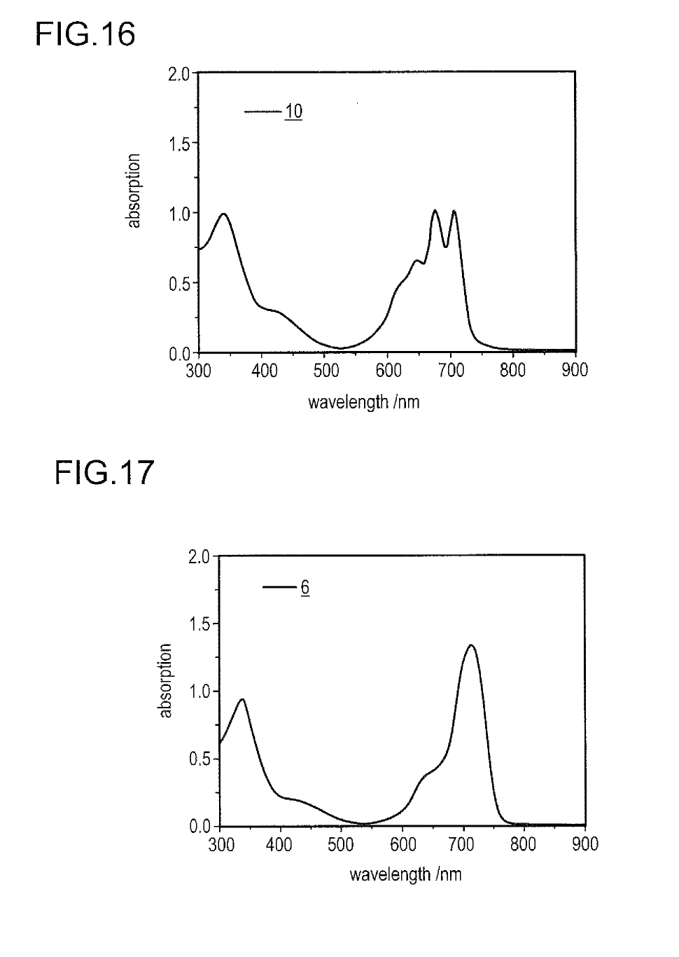

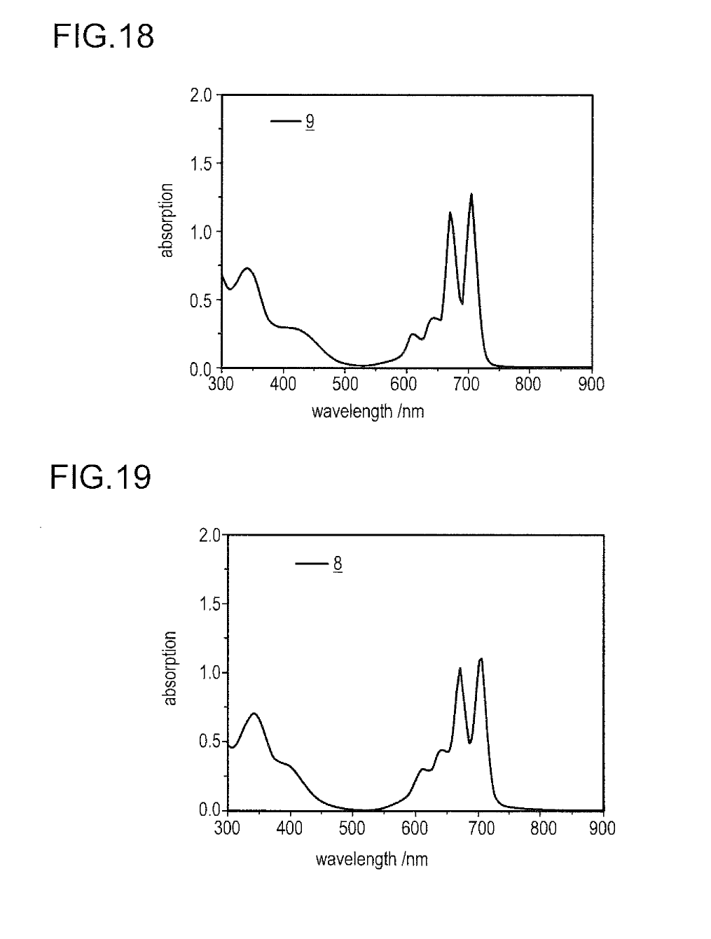

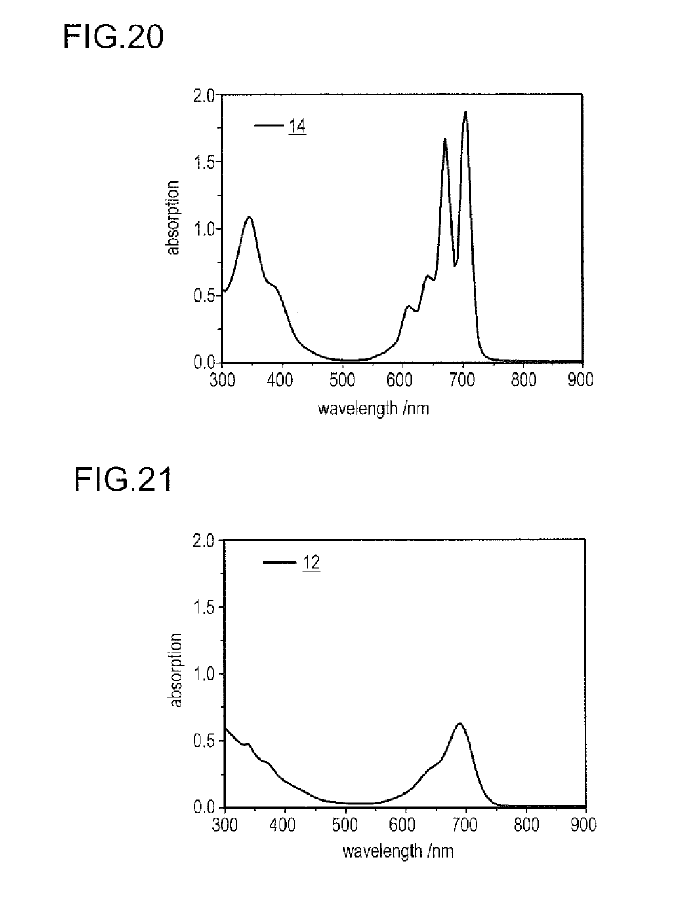

The absorption properties of plastic sheets prepared according to working example I.1 and I.2 were measured. The results are shown in FIG. 5 to FIG. 21.

III. Determination of the Absorption of Plastic Sheets with 0.02% Lumogen F Violet 570

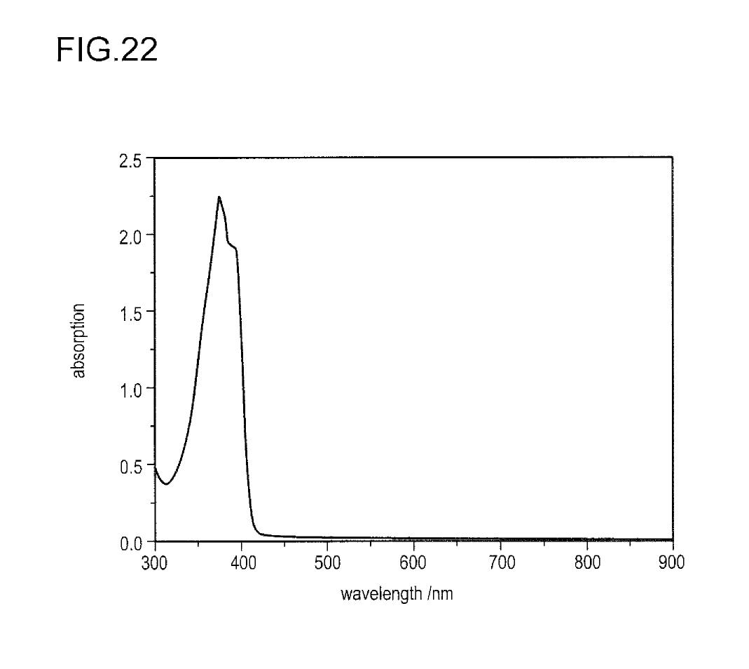

The absorption properties of a plastic sheet (2 mm thick, PMMA 7N) with 0.02% Lumogen F Violet 570 (BASF) as colorant were measured. The result is given in FIG. 22.

IV. Evaluation of the Properties of Plastic Sheets Incorporating 0.02% of Various Fluorescent Colorant

The properties of plastic sheets incorporating 0.02% of various fluorescent colorant samples were evaluated. The films were produced using various methods and matrix polymers and in accordance with examples I.1 and I2.

A photodiode was glued onto the foil and the photoresponse was recorded at various distances to an incident light spot (70 mW light power at 405 nm).

The absolute response at short distances is large, when the colorant is strongly absorbing, the fluorescence quantum yield is large, and the reabsorption of fluorescence light is small.

Weighting the photoresponse by the absorption is hence considered a meaningful way to evaluate. This is achieved by dividing the photoresponse by the optical density of the foil at 405 nm. As generally known, the optical density may be determined by measuring a fraction of light passing through a sample at a given wavelength. The wavelength of 405 nm was chosen here because all the studied colorants show an absorption band around this wavelength.

The decay of the photoresponse with the distance over which the fluorescence light has to travel inside the plastic sheet is a measure of the waveguiding properties of the sample. A less preferred film and surface quality will cause a fast decline with distance, hence yielding a large slope in the graphs below.

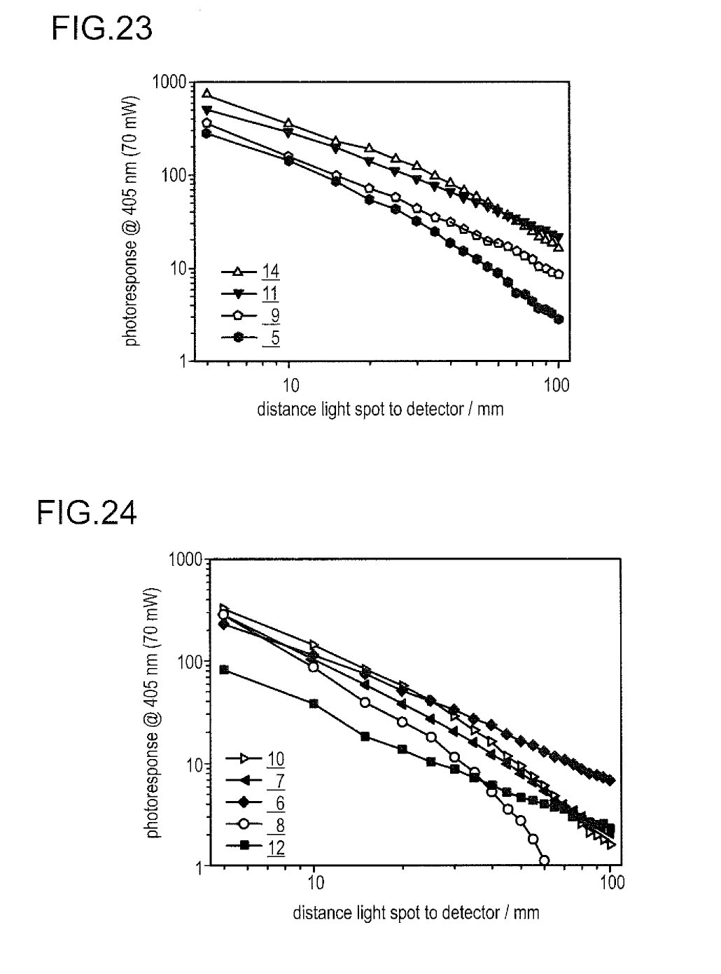

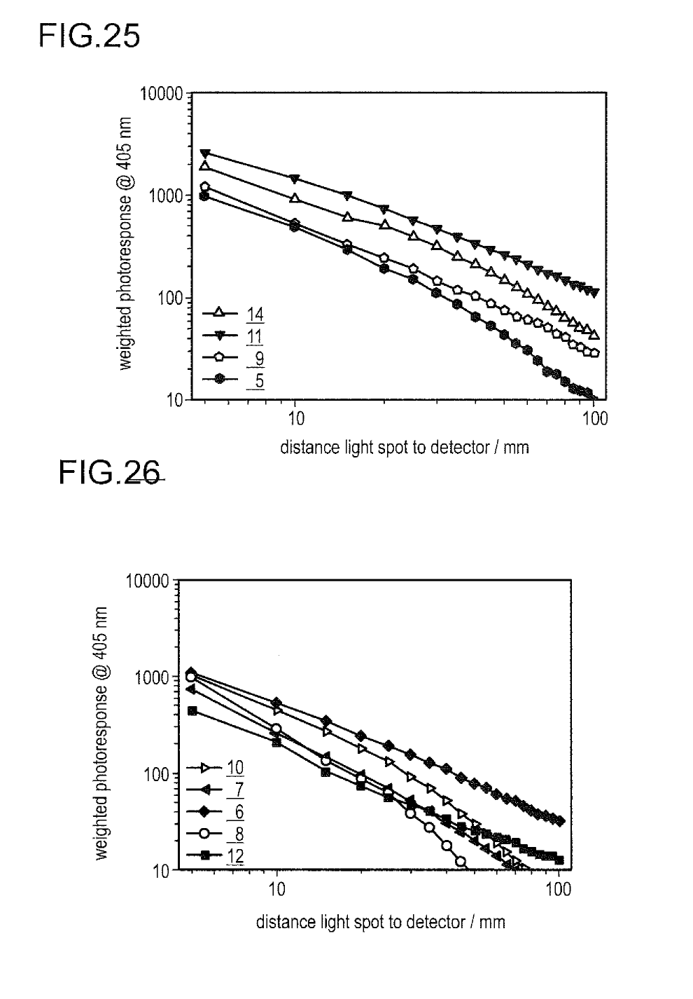

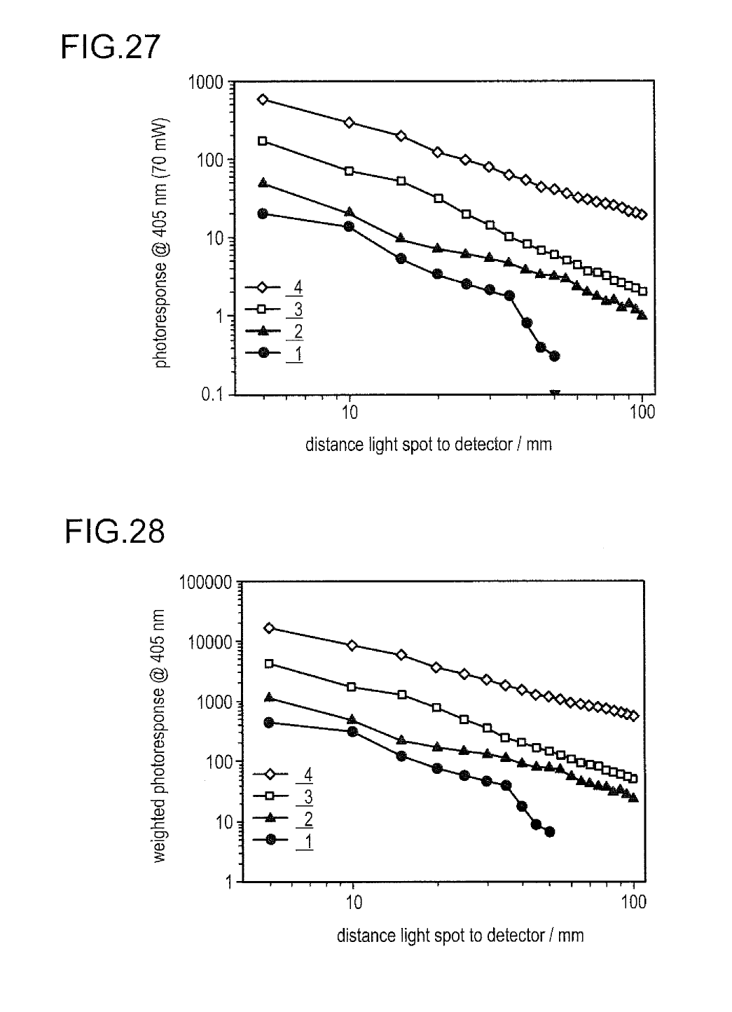

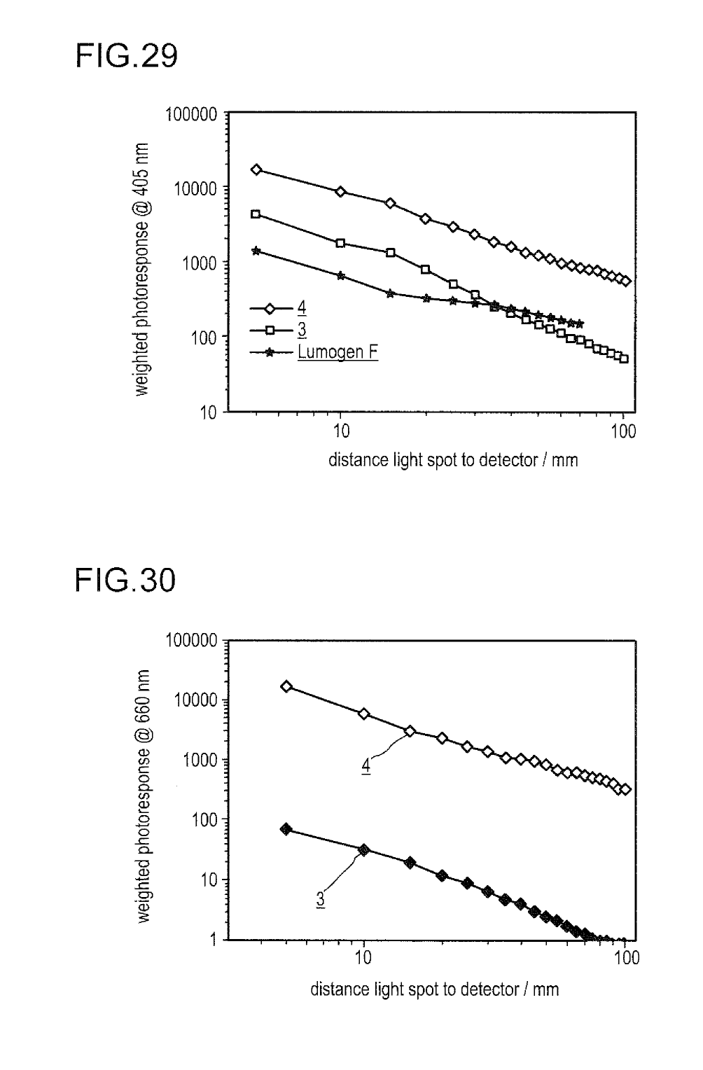

The results are given in FIGS. 23 to 30.

The highest weighted photoresponse values at 5 mm distance between light spot and photodiode (>2000) were achieved with the rylene colorants Compound 3 and Compound 4, as well as the phthalocyanine colorant Compound 14 and the rhodamine colorant Compound 11. In particular, the supreme performance of compound 4, displaying a high absolute photoresponse as well as a low absorption at 405 nm as well as 660 nm, is surprising.

### LIST OF REFERENCE NUMBERS

110 detector

111 transversal partition

112 transversal optical sensor

114 fluorescent waveguiding sheet

116 transversal sensitive area

118 waveguiding

120 matrix material

122 fluorescent material

124 photosensitive element

126 photosensitive element

128 photosensitive element

130 photosensitive element

132 edge

134 edge

136 edge

138 edge

140 evaluation device

142 reference photosensitive element

144 reverse side

146 optical filter element

148 (small) light spot

150 (large) light spot

152 center of the light spot

154 subtracting device

155 longitudinal optical sensor

156 camera

158 detector system

160 beacon device

162 object

164 human-machine interface

166 entertainment device

168 tracking system

170 scanning system

172 illumination source

174 light beam

175 modulation device

176 connector

178 housing

180 control device

182 user

184 transfer device

186 lens

188 opening

190 optical axis

192 direction of view

194 coordinate system

196 partial beam path

198 beam-splitting device

200 machine

202 track controller

1-15. (canceled)

16. A detector for determining a position of at least one object, the detector comprising:
at least one longitudinal optical sensor for determining a longitudinal position of at least one light beam traveling from the object to the detector, wherein the longitudinal optical sensor includes at least one longitudinal sensor region forming a longitudinal sensitive area, wherein the longitudinal optical sensor is configured to generate at least one longitudinal sensor signal in a manner dependent on an illumination of the longitudinal sensitive area by the light beam, wherein the longitudinal sensor signal, given a same total power of the illumination, is dependent on a beam cross-section of the light beam in the longitudinal sensitive area;
at least one transversal optical sensor for determining at least one transversal position of the at least one light beam traveling from the object to the detector, comprising:
at least one fluorescent waveguiding sheet forming a transversal sensitive area, wherein the fluorescent waveguiding sheet is oriented towards the object such that the at least one light beam propagating from the object towards the detector generates at least one light spot in the transversal sensitive area, wherein the fluorescent waveguiding sheet contains at least one fluorescent material, wherein the fluorescent material is adapted to generate fluorescence light in response to the illumination by the light beam,
at least two photosensitive elements located at at least two edges of the fluorescent waveguiding sheet configured to detect fluorescence light guided from the light spot towards the photosensitive elements by the fluorescent waveguiding sheet and configured to generate transversal sensor signals; and
at least one evaluation device configured to determine at least one longitudinal coordinate of the object by evaluating the longitudinal sensor signal, and wherein the evaluation device is further configured to determine at least one transversal coordinate of the object by evaluating the transversal sensor signals of the photosensitive elements.

17. The detector according to claim 16, wherein the evaluation device comprises at least one subtracting device configured to form at least one difference signal between the transversal sensor signals generated by at least two of the photo-sensitive elements.

18. The detector according to claim 16, wherein the transversal optical sensor further comprises at least one reference photosensitive element, wherein the reference photosensitive element is configured to detect light of the light beam after passing the fluorescent waveguiding sheet and to generate at least one reference sensor signal, wherein the evaluation device is configured to take into account the reference sensor signal for determining the transversal position of the object.

19. The detector according to claim 16, wherein the fluorescent waveguiding sheet comprises at least one matrix material, wherein the at least one fluorescent material is one or more of mixed into the matrix material, dispersed into the matrix material, chemically bound to the matrix material or dissolved in the matrix material.

20. The detector according to claim 16, wherein the detector is further configured such that the longitudinal sensor signal and/or the transversal sensor signals exhibit a dependency on a modulation frequency of a modulation of the illumination.

21. The detector according to claim 20, wherein the evaluation device is further configured to distinguish between at least two individual light beams illuminating the longitudinal sensitive area and/or the transversal sensitive area by evaluating dependency on the modulation frequency of the longitudinal sensor signal and/or of the transversal sensor signals.

22. A detector system for determining a position of at least one object, the detector system comprising:
at least one detector according to claim 16; and
at least one beacon device adapted to direct at least one light beam towards the detector, wherein the beacon device is at least one of attachable to the object, holdable by the object, or integratable into the object.

23. A human-machine interface for exchanging at least one item of information between a user and a machine, wherein the human-machine interface comprises at least one detector system according to claim 22, wherein the at least one beacon device is configured to be at least one of directly or indirectly attached to the user and held by the user, wherein the human-machine interface is configured to determine at least one position of the user by the detector system, wherein the human-machine interface is configured to assign to the position at least one item of information.

24. An entertainment device for carrying out at least one entertainment function, wherein the entertainment device comprises at least one human-machine interface according to claim 23, wherein the entertainment device is configured to enable at least one item of information to be input by a player by means of the human-machine interface, wherein the entertainment device is configured to vary the entertainment function in accordance with the information.

25. A tracking system for tracking a position of at least one movable object, the tracking system comprising:
at least one detector system according to claim 16; and
at least one track controller, wherein the track controller is configured to track a series of positions of the object at specific points in time.

26. A scanning system for determining at least one position of at least one object, the scanning system comprising:
at least one detector according to claim 16;
at least one illumination source configured to emit at least one light beam configured for an illumination of at least one dot located at at least one surface of the at least one object,
wherein the scanning system is configured to generate at least one item of information about the distance between the at least one dot and the scanning system by using the at least one detector.

27. A camera for imaging at least one object, the camera comprising at least one detector according to claim 16.

28. A method for determining a position of at least one object by using at least one detector, the method comprising:
illuminating at least one longitudinal sensitive area in at least one longitudinal sensor region of at least one longitudinal optical sensor in a manner that at least one longitudinal sensor signal being dependent on an illumination of the longitudinal sensitive area by the light beam is generated, wherein the longitudinal sensor signal, given a same total power of the illumination, is dependent on a beam cross-section of the light beam in the longitudinal sensitive area;
illuminating at least one transversal sensitive area of at least one fluorescent waveguiding sheet of at least one transversal optical sensor of the detector with the at least one light beam propagating from the object towards the detector, wherein the light beam generates at least one light spot in the transversal sensitive area, wherein the fluorescent wave-guiding sheet contains at least one fluorescent material;
generating fluorescence light in response to the illumination by the light beam by the fluorescent waveguiding sheet;
guiding the fluorescence light from the light spot towards at least two photosensitive elements located at at least two edges of the fluorescent waveguiding sheet;
detecting the fluorescence light by using the photosensitive elements and generating transversal sensor signals;
evaluating the longitudinal sensor signal by using at least one evaluation device and determining at least one longitudinal coordinate of the object; and
evaluating the transversal sensor signals of the photosensitive elements by using the at least one evaluation device and determining at least one transversal coordinate of the object thereof.

29. The method according to claim 28, wherein the method further comprises distinguishing between at least two individual light beams illuminating the longitudinal sensitive area and/or the transversal sensitive area by evaluating the dependency on the modulation frequency of the longitudinal sensor signal and/or of the transversal sensor signals by using the evaluation device.

30. A use of the detector according to claim 16, for a purpose of use, selected from the group consisting of: a position measurement in traffic technology; an entertainment application; a security application; a surveillance application; a safety application; a human-machine interface application; a tracking application; a photography application; a use in combination with at least one time-of-flight detector; a use in combination with a structured light source; a use in combination with a stereo camera; a machine vision application; a robotics application; a quality control application; a manufacturing application; a use in combination with a structured illumination source; a use in combination with a stereo camera.
